(19) United States
(12) Patent Application Publication
(10) Pub. No.: US 2007/0234014 A1
(43) Pub. Date: Oct. 4, 2007

(54) Processor apparatus for executing instructions with local slack prediction of instructions and processing method therefor

(76) Inventors: Ryotaro Kobayashi, Nagoya-shi (JP); Hisahiro Hayashi, Nagoya-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/717,063

(22) Filed: Mar. 13, 2007

(30) Foreign Application Priority Data
Mar. 28, 2006 (JP) 2006-88454
Feb. 8, 2007 (JP) 2007-29487
Feb. 8, 2007 (JP) 2007-29488
Feb. 8, 2007 (JP) 2007-29489

(51) Int. Cl. G06F 15/00

(52) U.S. Cl. 712/220

(57) ABSTRACT

A processor predicts predicted slack which is a predicted value of local slack of an instruction to be executed and executes the instruction using the predicted slack. A slack table is referred to upon execution of an instruction to obtain predicted slack of the instruction and execution latency is increased by an amount equivalent to the obtained predicted slack. Then, it is estimated, based on behavior exhibited upon execution of the instruction, whether or not the predicted slack has reached target slack which is an appropriate value of current local slack of the instruction. The predicted slack is gradually increased each time the instruction is executed, until it is estimated that the predicted slack has reached the target slack.

### BACKGROUND OF THE INVENTION

1. Field of the Invention

The present invention relates to a processor apparatus that predicts local slack of instructions to be executed by a processor and executes the instructions, and a processing method for use in the processor apparatus. In addition, the present invention relates to a processor apparatus that removes memory ambiguity by using slack prediction, and a processing method for use in the processor apparatus. Furthermore, the present invention relates to a processor apparatus that executes instructions using slack prediction while local slack is shared based on a dependency relationship between the instructions, and a processing method for use in the processor apparatus.

2. Description of the Prior Art

In recent years, a number of studies have been conducted on an increase in the speed of a microprocessor and a reduction in power consumption using information on a critical path (See Non-Patent Documents 2, 3, 8, 11, and 13, for example). A critical path is a path composed of a sequence of dynamic instructions that determines the overall execution time of a program. If the execution latency of instructions on a critical path is increased by just 1 cycle, the total number of execution cycles of a program is increased. However, critical path information has only two states, whether or not there are instructions on a critical path, and thus instructions can only be classified into two types. In addition, the number of instructions on a critical path is significantly smaller than the number of instructions on a non-critical path, and thus, when instruction processes are divided on a category-by-category basis, load balance is poor. By these facts, the scope of application of critical path information is narrow.

On the other hand, a technique for using slack of instructions instead of a critical path is proposed (See Non-Patent Documents 4 and 5, for example). The slack of instructions is the number of cycles the execution latency of the instruction can be increased without increasing the total number of execution cycles of a program. If slack of instructions has been known, it can be found not only whether or not the instructions are present on a critical path but also how much the execution latency of instructions that is not present on the critical path can be increased within a range where there is no influence on the execution of a program. Thus, the use of slack enables dividing instructions into three or more types of categories and furthermore enables relieving an imbalance in the number of instructions belonging to the categories.

The slack of each dynamic instruction is a value having a certain range. The minimum value of slack is always zero. On the other hand, the maximum value of slack (global slack (See Non-Patent Document 5, for example)) is dynamically determined. In order to make the most of slack, global slack needs to be determined. However, in order to determine global slack of a particular instruction, there is a need to examine, during the execution of a program, the influence of an increase in execution latency on the total number of execution cycles of the program. Therefore, it is very difficult to determine global slack.

In view of this, a technique for predicting local slack (See Non-Patent Document 5, for example) instead of global slack is proposed (See Non-Patent Documents 6 and 10, for example). Local slack of instructions is the maximum value of slack that does not have an influence on either the total number of execution cycles of a program or the execution of subsequent instructions. Local slack of a particular instruction can be easily determined by only focusing attention on subsequent instructions having a dependency relationship with the instruction. In a conventional technique, local slack of a particular instruction is determined from a difference between the time at which the instruction defines register data or memory data and the time at which the data is first referred to, and based on the local slack, future local slack is predicted.

In the conventional technique, however, there is a need to prepare a table for holding times at which data is defined and a computing unit for determining a difference between times. In addition, reference/update to the table holding defined times and subtraction of times need to be performed in parallel with the execution of a program. A cause for the occurrence of the costs is that local slack is directly calculated using data definition/reference times.

Now, slack will be described below.

FIG. 1(A) is a diagram showing an example of a program including a plurality of instructions used to describe slack according to prior art and FIG. 1(B) is a timing chart showing a process of executing each instruction of the program on a processor apparatus. In FIG. 1(A) and FIG. 1(B), nodes represent instructions and edges represent data dependency relationships between instructions. The vertical axis represents a cycle for which an instruction is executed. The length of a node represents the execution latency (referred to as an execution delay time) of an instruction. Instructions i1 and i4 have an execution latency of 2 cycles and other instructions have an execution latency of 1 cycle.

Now, the slack of an instruction i0 will be considered. When the execution latency of the instruction i0 is increased by 3 cycles, the execution of instructions i3 and i5 which directly or indirectly depend on the instruction i0 is delayed. As a result, the instruction i5 is executed at the same time as an instruction i6 which is the last one to be executed in the program. Hence, if the execution latency of the instruction i0 is further increased, the total number of execution cycles of the program increases. That is, the global slack of the instruction i0 is 3. As such, in order to determine the global slack of a particular instruction, there is a need to examine the influence of an increase in the execution latency of the instruction on the execution of the entire program. Thus, determination of global slack is very difficult.

On the other hand, when the execution of the instruction i0 is increased by 2 cycles, no influence is exerted on the execution of subsequent instructions. However, if the execution latency is further increased, the execution of the instructions i3 and i5 having direct and indirect dependency relationships with the instruction i0 is delayed. That is, the local slack of the instruction i0 is 2. As such, in order to determine the local slack of a particular instruction, attention should be focused only on the influence on instructions that depend on that instruction. Thus, local slack can be relatively easily determined.

Next, a slack prediction method according to prior art will be described below. For example, by subtracting 1 from a difference between time 0 at which the instruction i0 in FIG. 1(B) defines data and time 3 at which the data is first referred to by the instruction i3, the local slack of the instruction i0 is calculated to be 2. Based on the calculated local slack, local slack to be used when the instruction i0 is executed next is predicted to be 2.

FIG. 2 is a block diagram showing the configuration of a processor apparatus having a local slack prediction mechanism according to prior art. In FIG. 2, a processor 10 is configured to include a fetch unit 11 that fetches an instruction from a main storage apparatus 9, a decode unit 12, an instruction window (I-win) 13, a register file (RF) 14, a plurality of execution units (EU) 15, and a reorder buffer (ROB) 16. On the right side of the processor 10, there is shown a local slack prediction mechanism according to prior art. The local slack prediction mechanism includes: a register definition table 2 for holding times at which register data is defined; a memory definition table 3 for holding times at which memory data is defined; a multiplexer 4 that selectively switches between outputs from the two definition tables 2 and 3 and outputs a defined time; and a subtractor 5 which is a computing unit for determining a difference between a defined time and a current time. The local slack prediction mechanism further includes a slack table 6 for holding local slack of each instruction. The register definition table 2, the memory definition table 3, and the slack table 6 are composed by a storage apparatus for storing each table.

The operation of a conventional mechanism will be briefly described using the local slack of the instruction i0 in FIG. 1(B) as an example. When the instruction i0 defines data, the instruction i0 stores the instruction i0 itself and a current time 0 in definition tables. When i3 uses the data, i3 obtains the instruction i0 having defined the data and the time (defined time) 0 at which the data is defined, from the definition tables 2 and 3. Then, by subtracting 1 from a difference between the current time 3 and the defined time 0, a local slack of the instruction i0 is determined to be 2. The determined slack is stored in an entry corresponding to the instruction i0 of the slack table 6. When the instruction i0 is fetched next by the fetch unit 11, the slack table 6 is referred to and based on obtained slack the local slack of the instruction i0 is predicted to be 2.

As described above, in the conventional technique, the definition tables 2 and 3 and the subtractor 5 need to be prepared, increasing hardware costs. In addition, since reference and update to the definition tables 2 and 3 and subtraction of times need to be performed in parallel with the execution of a program, a high-speed operation is required, which may have a great influence on power consumption. A cause for the occurrence of such a problem is that local slack is directly calculated focusing attention on data definition and reference times.

Patent Documents and Non-Patent Documents related to the present invention are shown below.

(a) Patent Document 1: Japanese Patent Laid-Open Publication No. 2000-353099

(b) Patent Document 2: Japanese Patent Laid-Open Publication No. 2004-286381

(c) Non-Patent Document 1: D. Burger et al., “The Simplescalar Tool Set Version 2.0”, Technical Report 1342, Department of Computer Sciences, University of Wisconsin-Madison, June 1997.

(d) Non-Patent Document 2: Akihiro Chiyonobu et al., “Proposal on Critical Path Predictor for Low Power Consumption Processor Architecture”, Technical Report of Information Processing Society of Japan, 2002-ARC-149, issued by the Information Processing Society of Japan, August 2002.

(e) Non-Patent Document 3: B. Fields et al., “Focusing Processor Policies via Critical-Path Prediction”, In Proceedings of ISCA-28, June 2001.

(f) Non-Patent Document 4: B. Fields et al., “Using Interaction Costs for Microarchitectural Bottleneck Analysis”, In Proceedings of MICRO-36, December 2003.

(g) Non-Patent Document 5: B. Fields et al., “Slack: Maximizing Performance under Technological Constraints”, In Proceedings of ISCA-29, May 2002.

(h) Non-Patent Document 6: Tomohisa Fukuyama et al., “Instruction Scheduling for Low-Power Architecture with Slack Prediction”, Symposium on Advanced Computing Systems and Infrastructures, ACSIS2005, May 2005.

(i) Non-Patent Document 7: J. L. Hennessy et al., “Computer Architecture: A Quantitative Approach”, 2nd Edition, Morgan Kaufmann Publishing Incorporated, San Francisco, Calif., U.S.A., 1996.

(j) Non-Patent Document 8: Ryotaro Kobayashi et al., “Instruction Issuing Mechanism in Clustered Superscalar Processor Focusing on Longest Path of Data Flow Graph”, Joint Symposium on Parallel Processing 2001, JSPP2001, June 2001.

(k) Non-Patent Document 9: M. Levy, “Samsung Twists ARM Past 1 GHz”, Microprocessor Report 2002-10-16, October 2002.

(l) Non-Patent Document 10: Xaiolu Liu et al., “Slack Prediction for Criticality Prediction”, Symposium on Advanced Computing Systems and Infrastructures, SACSIS2004, May 2004.

(m) Non-Patent Document 11: J. S. Seng et al., “Reducing Power with Dynamic Critical Path Information”, In Proceedings of MICRO-34, December 2001.

(n) Non-Patent Document 12: P. Shivakumar et al., “CACTI 3.0: An Integrated Cache Timing and Power, and Area Model”, Compaq WRL Report 2001/2, August 2001.

(o) Non-Patent Document 13: E. Tune et al., “Dynamic Prediction of Critical Path Instructions”, In Proceedings of HPCA-7, January 2001.

According to prediction techniques according to the above-described prior art, it is certainly possible to make a prediction of local slack with a certain degree of accuracy; however, two definition tables and a computing unit are required in addition to a slack table and accordingly the hardware costs of a prediction mechanism are extremely high. In addition, in parallel with the execution of a program, reference/update to the definition tables and subtraction of times need to be performed at higher speed and accordingly an increase in power consumption by the operation of the prediction mechanism may become non-negligible.

In addition, the actual local slack (actual slack) dynamically changes. Hence, a technique for coping with the change is proposed (See Non-Patent Document 6, for example). However, there is a problem that the change in actual slack cannot be sufficiently followed, which may cause a degradation in the performance.

Moreover, as described above, since memory ambiguity is present between load/store instructions, when slack of a store instruction is used based on prediction, the execution of a subsequent load is delayed, causing a problem that an adverse influence is exerted on the performance of a processor. As used herein, the memory ambiguity means that the dependency relationship between load/store instructions is not known until a memory address of a main storage apparatus to access is found out.

Furthermore, as described above, in the techniques according to the prior art, the number of instructions (the number of slack instructions) whose local slack can be predicted to be 1 or more is small and thus the chance of being able to use slack cannot be sufficiently secured.

### SUMMARY OF THE INVENTION

An object of the present invention is to solve the above-described problems and provide a processor apparatus capable of predicting local slack and executing program instructions at higher speed, with a simpler configuration over the prior art, and a processing method for use in the processor apparatus.

According to the first aspect of the present invention, there is provided a processor apparatus for predicting predicted slack which is a predicted value of local slack of an instruction to be executed by the processor apparatus and executing the instruction using the predicted slack. The processor apparatus includes a storage unit, a setting unit, an estimation unit, and an update unit. The storage unit stores a slack table including the predicted slack. The setting unit refers to the slack table upon execution of an instruction to obtain predicted slack of the instruction and increasing execution latency by an amount equivalent to the obtained predicted slack. The estimation unit estimates, based on behavior exhibited upon execution of the instruction, whether or not the predicted slack has reached target slack which is an appropriate value of current local slack of the instruction. The update unit gradually increases the predicted slack each time the instruction is executed until it is estimated by the estimation unit that the predicted slack has reached the target slack.

In the above-mentioned processor apparatus, the update unit changes a parameter to be used to update the slack, according to a value of the predicted slack such that a degradation in performance of the processor apparatus is suppressed while a number of slack instructions is maintained.

In addition, in the above-mentioned processor apparatus, the update unit changes the parameter to be used to update the slack, according to whether the predicted slack is larger than or equal to a predetermined threshold value.

Further, in the above-mentioned processor apparatus, the estimation unit estimates that the predicted slack has reached the target slack, using, as an establishment condition for the estimation, at least one of the following facts:

(A) a branch prediction miss occurs upon execution of the instruction;

(B) a cache miss occurs upon execution of the instruction;

(C) operand forwarding to a subsequent instruction occurs;

(D) store data forwarding to a subsequent instruction occurs;

(E) the instruction is the oldest one of instructions present in an instruction window;

(F) the instruction is the oldest one of instructions present in a reorder buffer;

(G) the instruction is an instruction that passes an execution result to the oldest one of the instructions present in the instruction window;

(H) the instruction is an instruction that passes an execution result to a largest number of subsequent instructions among instructions executed in a same cycle; and

(I) a number of subsequent instructions that are brought into an executable state by passing an execution result of the instruction is larger than or equal to a predetermined determination value.

Furthermore, the processor apparatus further includes a reliability counter in which when an establishment condition for an estimation that the predicted slack has reached the target slack is established, a counter value of the reliability counter is increased or decreased, and when the establishment condition for the estimation is not established, the counter value is decreased or increased. The update unit increases the predicted slack on a condition that the counter value of the reliability counter is an increase determination value and decreases the predicted slack on a condition that the counter value of the reliability counter is a decrease determination value.

In addition, in the above-mentioned processor apparatus, an amount of increase or decrease in the counter value upon establishment of the establishment condition for the estimation in the reliability counter is set to a value larger than that of an amount of decrease or increase in the counter value upon non-establishment of the establishment condition for the estimation.

Further, in the above-mentioned processor apparatus, amounts of increase and decrease in the counter value are set to be different for different types of instructions.

Furthermore, in the above-mentioned processor apparatus, an amount of update of the predicted slack of each instruction at a time by the update unit is set to be different for different types of each instruction.

In addition, in the above-mentioned processor apparatus, an upper limit value is set to the predicted slack of each instruction to be updated by the update unit and the upper limit value is set to be different for different types of instructions.

Further, the above-mentioned processor apparatus further includes a branch history register in which a branch history of a program is kept, and the slack table individually stores the predicted slack of the instruction for different branch patterns obtained by referring to the branch history register.

According to the second aspect of the present invention, there is provided a processing method for use in a processor apparatus that predicts predicted slack which is a predicted value of local slack of an instruction to be executed by the processor apparatus and executes the instruction using the predicted slack. The processing method includes a control step. The control step includes a step of executing an instruction to be executed by the processor apparatus such that execution latency of the instruction is increased by an amount equivalent to a value of the predicted slack, estimating, based on behavior exhibited upon execution of the instruction, whether or not the predicted slack has reached target slack which is an appropriate value of current local slack, and updating the predicted slack each time the instruction is executed so as to gradually increase the predicted slack, until it is estimated that the predicted slack has reached the target slack.

In the above-mentioned processing method for use in the processor apparatus, in the control step, a parameter to be used to update the slack is changed according to the value of the predicted slack such that a degradation in performance of the processor apparatus is suppressed while a number of slack instructions is maintained.

In addition, in the above-mentioned processing method for use in the processor apparatus, in the control step, the parameter to be used to update the slack is changed according to whether the predicted slack is larger than or equal to a predetermined threshold value.

Further, in the above-mentioned processing method for use in the processor apparatus, an establishment condition for an estimation that the predicted slack has reached the target slack includes at least one of the following facts:

(A) a branch prediction miss occurs upon execution of the instruction;

(B) a cache miss occurs upon execution of the instruction;

(C) operand forwarding to a subsequent instruction occurs;

(D) store data forwarding to a subsequent instruction occurs;

(E) the instruction is the oldest one of instructions present in an instruction window;

(F) the instruction is the oldest one of instructions present in a reorder buffer;

(G) the instruction is an instruction that passes an execution result to the oldest one of the instructions present in the instruction window;

(H) the instruction is an instruction that passes an execution result to a largest number of subsequent instructions among instructions executed in a same cycle; and

(I) a number of subsequent instructions that are brought into an executable state by passing an execution result of the instruction is larger than or equal to a predetermined determination value.

Furthermore, in the above-mentioned processing method for use in the processor apparatus, the predicted slack is decreased when it is estimated that the predicted slack has reached the target slack.

In addition, in the above-mentioned processing method for use in the processor apparatus, an increase of the predicted slack is performed on a condition that a number of non-establishments for an establishment condition for an estimation that the predicted slack has reached the target slack reaches a specified number of times, and a decrease of the predicted slack is performed on a condition that a number of establishments for the establishment condition reaches a specified number of times.

Further, in the above-mentioned processing method for use in the processor apparatus, the number of non-establishments for the establishment condition required to increase the predicted slack is set to a value larger than that of the number of establishments for the establishment condition required to decrease the predicted slack.

Furthermore, in the above-mentioned processing method for use in the processor apparatus, an increase of the predicted slack is performed on a condition that a number of non-establishments for an establishment condition for an estimation that the predicted slack has reached the target slack reaches a specified number of times, and a decrease of the predicted slack is performed on a condition that the establishment condition is established.

In addition, in the above-mentioned processing method for use in the processor apparatus, the specified number of times is set to be different for different types of the instructions.

Further, in the above-mentioned processing method for use in the processor apparatus, an amount of update of predicted slack at a time is set to be different for different types of the instructions.

Furthermore, in the above-mentioned processing method for use in the processor apparatus, an upper limit value of the predicted slack is set to be different for different types of the instructions.

According to the processor apparatus of the present invention and the processing method therefor, the slack table is referred to upon execution of an instruction to obtain predicted slack of the instruction and execution latency is increased by an amount equivalent to the obtained predicted slack. Then, it is estimated, based on behavior exhibited upon the execution of the instruction, whether or not the predicted slack has reached target slack which is an appropriate value of current local slack of the instruction. The predicted slack is gradually increased each time the instruction is executed, until it is estimated that the predicted slack has reached the target slack. Accordingly, since a predicted value of local slack (predicted slack) of an instruction is not directly determined by calculation but is determined by gradually increasing the predicted slack until the predicted slack reaches an appropriate value, while behavior exhibited upon execution of the instruction is observed, a complex mechanism required to directly compute predicted slack is not required, making it possible to predict local slack with a simpler configuration.

In addition, since parameters used to update slack are changed according to a value of local slack, a degradation in performance can be suppressed while the number of slack instructions is maintained. Therefore, with a simpler configuration over prior art, a local slack prediction can be made and the execution of program instructions can be performed at higher speed.

According to the third aspect of the present invention, there is provided a processor apparatus for predicting predicted slack which is a predicted value of local slack of an instruction to be stored at a memory address of a main storage apparatus and executed by the processor apparatus, and executing the instruction using the predicted slack. The processor apparatus includes a control unit. The control unit predicts and determines that a store instruction having predicted slack larger than or equal to a predetermined threshold value has no data dependency relationship with a subsequent load instruction to the store instruction and speculatively executing the subsequent load instruction even if a memory address of the store instruction is not known.

In the above-mentioned processor apparatus, when a memory address of a load instruction is known and a preceding store instruction to the load instruction is such one case of the following:

(1) a memory address is known; and

(2) though the memory address is not known, predicted slack of the store instruction is larger than or equal to the threshold value,

the control unit makes an address comparison between the load instruction and a store instruction which is preceding to the load instruction and whose memory address is known, and executes memory access when it is determined that there is no dependency relationship between the load instruction and a store instruction whose memory address is not known and which has predicted slack larger than or equal to the threshold value; otherwise, the control unit obtains data from a dependent store instruction by forwarding, thereby predicting a memory dependency relationship and speculatively executes the load instruction.

In addition, in the above-mentioned processor apparatus, the control unit compares, after a memory address of a store instruction having predicted slack larger than or equal to the threshold value is found out, the memory address of the store instruction with a memory address of a subsequent load instruction whose execution has been completed and determines, if the memory addresses are not matched, that memory dependence prediction is successful and thus executes memory access; on the other hand, if the memory addresses are matched, the control unit determines that the memory dependence prediction is failed and thus flushes the load instruction having a matched memory address and an instruction subsequent thereto from the processor apparatus and redoes execution of the instructions.

According to the fourth aspect of the present invention, there is provided a processing method for use in a processor apparatus for predicting predicted slack which is a predicted value of local slack of an instruction to be stored at a memory address of a main storage apparatus and executed by the processor apparatus, and executing the instruction using the predicted slack. The processing method includes a control step. The control step includes a step of predicting and determining that a store instruction having predicted slack larger than or equal to a predetermined threshold value has no data dependency relationship with a subsequent load instruction to the store instruction and speculatively executing the subsequent load instruction even if a memory address of the store instruction is not known.

In the processing method for use in the processor apparatus, when a memory address of a load instruction is known and a preceding store instruction to the load instruction is such one case of the following:

(1) a memory address is known; and

(2) though the memory address is not known, predicted slack of the store instruction is larger than or equal to the threshold value,

in the control step, an address comparison between the load instruction and a store instruction which is preceding to the load instruction and whose memory address is known is made and memory access is executed when it is determined that there is no dependency relationship between the load instruction and a store instruction whose memory address is not known and which has predicted slack larger than or equal to the threshold value; otherwise, by obtaining data from a dependent store instruction by forwarding, a memory dependency relationship is predicted and the load instruction is speculatively executed.

In addition, in the above-mentioned processing method for use in the processor apparatus, in the control step, after a memory address of a store instruction having predicted slack larger than or equal to the threshold value is found out, the memory address of the store instruction is compared with a memory address of a subsequent load instruction whose execution has been completed and it is determined, if the memory addresses are not matched, that memory dependence prediction is successful and thus memory access is executed; on the other hand, if the memory addresses are matched, it is determined that the memory dependence prediction is failed and thus the load instruction having a matched memory address and an instruction subsequent thereto are flushed from the processor apparatus and execution of the instructions is redone.

According to the processor apparatus of the present invention and the processing method therefor, a store instruction having predicted slack larger than or equal to a predetermined threshold value is predicted and determined to have no data dependency relationship with load instructions subsequent to the store instruction, and thus, even if a memory address of the store instruction is not known, the subsequent load instructions are speculatively executed. Therefore, if prediction is correct, a delay due to the use of slack of a store instruction does not occur in execution of load instructions having no data dependency relationship with the store instruction and thus an adverse influence on the performance of the processor apparatus can be suppressed. In addition, since output results of the slack prediction mechanism are used, there is no need to newly prepare hardware for predicting a dependency relationship between a store instruction and a load instruction. Accordingly, with a simpler configuration over prior art, a local slack prediction can be made and the execution of program instructions can be performed at higher speed.

According to the fifth aspect of the present invention, there is provided a processor apparatus for predicting, using a predetermined first prediction method, predicted slack which is a predicted value of local slack of an instruction to be stored at a memory address of a main storage apparatus and executed by the processor apparatus, and executing the instruction using the predicted slack. The processor apparatus includes a control unit. The control unit propagates, using a second prediction method which is a slack prediction method based on shared information and based on an instruction having local slack, shared information indicating that there is sharable slack, from a dependent destination to a dependent source between instructions that do not have local slack, and determines an amount of local slack used by each instruction based on the shared information and using a predetermined heuristic technique, thereby performing control to enable the instructions that do not have local slack to use local slack.

In the above-mentioned processor apparatus, the control unit propagates the shared information when predicted slack of an instruction is larger than or equal to a predetermined threshold value.

In addition, in the above-mentioned processor apparatus, the control unit calculates and updates, based on behavior exhibited upon execution of an instruction and the shared information, predicted slack of the instruction and reliability indicating a degree of whether or not the predicted slack can be used.

Further, in the above-mentioned processor apparatus, the control unit performs an update such that when the control unit receives shared information upon execution of an instruction, the control unit determines that the predicted slack has not yet reached usable slack and thus increases the reliability; otherwise, the control unit determines that the predicted slack has reached the usable slack and thus decreases the reliability and when the reliability is decreased to a predetermined value, the control unit decreases the predicted slack and when the reliability is larger than or equal to a predetermined threshold value, the control unit increases the predicted slack.

Furthermore, in the above-mentioned processor apparatus, the control unit includes a first storage unit, a second storage unit, and an update unit. The first storage unit stores a slack table, and the second storage unit stores a slack propagation table. The update unit updates the slack table and the slack propagation table. The slack table includes for each of all instructions:

(a) a propagation flag (Pflag) indicating whether a local slack prediction is made using the first prediction method or the second prediction method;

(b) the predicted slack; and

(c) reliability indicating a degree of whether or not the predicted slack can be used. The slack propagation table includes for each of instructions that do not have local slack:

(a) memory addresses of the instructions that do not have the local slack;

(b) a predicted slack of the instructions that do not have the local slack; and

(c) reliability indicating a degree of whether or not the predicted slack of the instructions that do not have the local slack can be used.

When a propagation flag of a received instruction indicates that a local slack prediction is made using the second prediction method, the update unit updates the slack table and the slack propagation table based on predicted slack and reliability of the received instruction and using the second prediction method; on the other hand, when the propagation flag of the received instruction indicates that a local slack prediction is made using the first prediction method, the update unit updates the slack table based on the predicted slack and the reliability of the received instruction and using the first prediction method.

According to the sixth aspect of the present invention, there is provided a processing method for use in a processor apparatus for predicting, using a predetermined first prediction method, predicted slack which is a predicted value of local slack of an instruction to be stored at a memory address of a main storage apparatus and executed by the processor apparatus, and executing the instruction using the predicted slack. The processing method includes a control step. The control step includes a step of propagating, using a second prediction method which is a slack prediction method based on shared information and based on an instruction having local slack, shared information indicating that there is sharable slack, from a dependent destination to a dependent source between instructions that do not have local slack, and determining an amount of local slack used by each instruction based on the shared information and using a predetermined heuristic technique, thereby performing control to enable the instructions that do not have local slack to use local slack.

In the above-mentioned processing method for use in the processor apparatus, in the control step, when predicted slack of an instruction is larger than or equal to a predetermined threshold value, the shared information is propagated.

In addition, in the above-mentioned processing method for use in the processor apparatus, in the control step, based on behavior exhibited upon execution of an instruction and the shared information, predicted slack of the instruction and reliability indicating a degree of whether or not the predicted slack can be used are calculated and updated.

Further, in the above-mentioned processing method for use in the processor apparatus, in the control step, an update is performed such that it is determined, when shared information is received upon execution of an instruction, that the predicted slack has not yet reached usable slack and thus the reliability is increased; otherwise, it is determined that the predicted slack has reached the usable slack and thus the reliability is decreased and when the reliability is decreased to a predetermined value, the predicted slack is decreased and when the reliability is larger than or equal to a predetermined threshold value, the predicted slack is increased.

According to the processor apparatus of the present invention and the processing method therefor, by using a second prediction method which is a slack prediction method based on shared information, based on an instruction having local slack, shared information indicating that there is sharable slack is propagated from a dependent destination to a dependent source between instructions that do not have local slack and the amount of local slack used by each instruction is determined based on the shared information and using a predetermined heuristic technique, and this leads to that control is performed to enable the instructions that do not have local slack to use local slack. Accordingly, it becomes possible for instructions that do not have local slack to use local slack, and thus, with a simpler configuration over prior art, a local slack prediction is made by effectively and sufficiently using local slack and the execution of program instructions can be performed at higher speed.

### BRIEF DESCRIPTION OF THE DRAWINGS

Various objects, features, and advantages of the present invention will become apparent from the following preferred embodiments described in conjunction with the accompanying drawings.

FIG. 1(A) is a diagram showing an example of a program including a plurality of instructions used to describe slack according to prior art;

FIG. 1(B) is a timing chart showing a process of executing each instruction of the program on a processor apparatus;

FIG. 2 is a block diagram showing the configuration of a processor apparatus having a local slack prediction mechanism according to prior art;

FIG. 3(A) is a timing chart showing a basic operation of a processor apparatus using a technique for heuristically predicting local slack according to a first preferred embodiment of the present invention, and showing a first execution operation;

FIG. 3(B) is a timing chart showing the basic operation of the processor apparatus and showing a second execution operation;

FIG. 3(C) is a timing chart showing the basic operation of the processor apparatus and showing a third execution operation;

FIG. 4(A) is a graph showing cycle-slack characteristics for describing a problem of the basic operation of FIG. 3;

FIG. 4(B) is a graph showing cycle-slack characteristics for describing a solution technique for the problem;

FIG. 5(A) is a graph showing cycle-slack characteristics for describing a problem of the solution technique of FIG. 4;

FIG. 5(B) is a graph showing cycle-slack characteristics for describing a solution technique for the problem;

FIG. 6 is a block diagram showing the configuration of a processor 10 having a slack table 20, according to the first preferred embodiment of the present invention;

FIG. 7 is a graph showing simulation results for an implemental example of a proposed mechanism of FIG. 6 and showing a percentage of the number of executed instructions relative to actual slack in each program;

FIG. 8 is a graph showing simulation results for the implemental example of the proposed mechanism of FIG. 6 and showing a percentage (slack prediction accuracy) of the number of executed instructions relative to each model for the case in which the maximum value Vmax of predicted slack=1;

FIG. 9 is a graph showing simulation results for the implemental example of the proposed mechanism of FIG. 6 and showing a percentage (slack prediction accuracy) of the number of executed instructions relative to each model for the case in which the maximum value Vmax of predicted slack=5;

FIG. 10 is a graph showing simulation results for the implemental example of the proposed mechanism of FIG. 6 and showing a percentage (slack prediction accuracy) of the number of executed instructions relative to each model for the case in which the maximum value Vmax of predicted slack=15;

FIG. 11 is a graph showing simulation results for the implemental example of the proposed mechanism of FIG. 6 and showing a percentage of the number of executed instructions relative to a difference between actual slack and predicted slack in each model for the case in which the maximum value Vmax of predicted slack=1;

FIG. 12 is a graph showing simulation results for the implemental example of the proposed mechanism of FIG. 6 and showing a percentage of the number of executed instructions relative to a difference between actual slack and predicted slack in each model for the case in which the maximum value Vmax of predicted slack=5;

FIG. 13 is a graph showing simulation results for the implemental example of the proposed mechanism of FIG. 6 and showing a percentage of the number of executed instructions relative to a difference between actual slack and predicted slack in each model for the case in which the maximum value Vmax of predicted slack=15;

FIG. 14 is a graph showing simulation results for the implemental example of the proposed mechanism of FIG. 6 and showing normalized IPC (Instructions Per Clock cycle: the average number of instructions that can be processed per clock) in each model;

FIG. 15 is a graph showing simulation results for the implemental example of the proposed mechanism of FIG. 6 and showing a percentage of the number of slack instructions in each model;

FIG. 16 is a graph showing simulation results for the implemental example of the proposed mechanism of FIG. 6 and showing an average predicted slack in each model;

FIG. 17 is a graph showing simulation results for another implemental example of the proposed mechanism of FIG. 6 and showing a relationship between the number of slack instructions and IPC relative to each maximum value Vmax of predicted slack;

FIG. 18 is a graph showing simulation results for another implemental example of the proposed mechanism of FIG. 6 and showing the total integrated value of predicted slack relative to IPC;

FIG. 19 is a block diagram showing the configuration of an update unit 30 according to the first preferred embodiment of the present invention;

FIG. 20 is a graph showing simulation results for a conventional mechanism according to prior art and showing an access time of a slack table relative to line size;

FIG. 21 is a graph showing simulation results for a proposed mechanism having the update unit 30 of FIG. 19 and showing the access time of a slack table relative to line size;

FIG. 22 is a graph showing simulation results for the proposed mechanism having the update unit 30 of FIG. 19 and showing the access time of a memory definition table relative to line size;

FIG. 23 is a block diagram showing the configuration of a processor 10A having a slack table 20, according to a first modified preferred embodiment of the first preferred embodiment of the present invention;

FIG. 24 is a graph showing simulation results for an implemental example of the processor 10A of FIG. 23 and showing normalized IPC relative to each program;

FIG. 25 is a graph showing simulation results for the implemental example of the processor 10A of FIG. 23 and showing normalized EDP (Energy Delay Product: the product of energy consumption and the execution time of the processor 10A) relative to each program;

FIG. 26 is a graph showing simulation results for another implemental example of the processor 10A of FIG. 23 and showing normalized IPC relative to each program;

FIG. 27 is a graph showing simulation results for another implemental example of the processor 10A of FIG. 23 and showing normalized EDP (Energy Delay Product: the product of energy consumption and the execution time of the processor) relative to each program;

FIG. 28 is a block diagram showing the configuration of a processor 10 having a slack table 20 and two index generation circuits 22A and 22B, according to a second modified preferred embodiment of the first preferred embodiment of the present invention;

FIG. 29 is a diagram showing an exemplary operation to be performed when a slack prediction is made in a slack prediction mechanism according to the first preferred embodiment, without taking into account a control flow;

FIG. 30 is a diagram showing a first exemplary operation to be performed when a slack prediction is made in a slack prediction mechanism of FIG. 28, taking into account a control flow;

FIG. 31 is a diagram showing a second exemplary operation to be performed when a slack prediction is made in the slack prediction mechanism of FIG. 28, taking into account a control flow;

FIG. 32(A) is a diagram for describing a problem that arises in prior art due to memory ambiguity when slack of a store instruction is used, and showing a program before decoding;

FIG. 32(B) is a diagram for describing a problem that arises in prior art due to memory ambiguity when slack of a store instruction is used, and showing a program after decoding;

FIG. 33(A) is a diagram used to describe the influence of memory ambiguity on the use of slack in a process by the processor, and is a timing chart showing a process of executing a program for the case of no use of any slack;

FIG. 33(B) is a diagram used to describe the influence of memory ambiguity on the use of slack in a process by the processor, and is a timing chart showing a process of executing a program for the case of use of slack;

FIG. 34 is a timing chart showing speculative removal of memory ambiguity according to a second preferred embodiment of the present invention;

FIG. 35 is a block diagram showing the configuration of a processor 10B having a speculative removal mechanism for memory ambiguity of FIG. 34;

FIG. 36 is a diagram showing a format of data to be entered into a load/store queue (LSQ) 62 of FIG. 35;

FIG. 37 is a flowchart showing a process by the LSQ 62 of FIG. 35 performed on a load instruction;

FIG. 38 is a flowchart showing a process by the LSQ 62 of FIG. 35 performed on a store instruction;

FIG. 39 is a timing chart showing a program used to describe slack according to prior art;

FIG. 40(A) is a timing chart showing a program describing the use of slack according to a technique of prior art;

FIG. 40(B) is a timing chart showing a program describing the use of slack according to a technique for increasing the number of slack instructions, according to a third preferred embodiment of the present invention;

FIG. 41 is a block diagram showing the configuration of a processor 10 having a slack propagation table 80 and the like, according to the third preferred embodiment of the present invention;

FIG. 42 is a flowchart showing a local slack prediction process performed by an update unit 30 of FIG. 41;

FIG. 43 is a flowchart showing a subroutine of the flowchart of FIG. 42 and showing a propagation process of shared information (S41);

FIG. 44 is a flowchart showing a prediction process of shared slack to be performed by the update unit 30 of FIG. 41;

FIG. 45 is a graph showing a percentage of the number of executed instructions relative to actual slack, according to examination results obtained by the inventors;

FIG. 46 is a block diagram showing the configuration of the processor 10 having the update unit 30 according to the first preferred embodiment;

FIG. 47 is a block diagram showing the configuration of a processor 10 having an update unit 30A according to a fourth preferred embodiment of the present invention;

FIG. 48 is a flowchart showing a local slack prediction process according to the first preferred embodiment; and

FIG. 49 is a diagram showing an advantageous effect provided by a technique according to the fourth preferred embodiment, and is a graph showing a relationship between update parameters and a change in predicted slack.

### DETAILED DESCRIPTION OF THE PREFERRED EMBODIMENTS

Preferred embodiments according to the present invention will be described below with reference to the drawings. It is noted that in the following preferred embodiments like components are denoted by like reference numerals. In addition, it is noted that the chapter and section numbers are independently provided for each preferred embodiment.

### First Preferred Embodiment

In a first preferred embodiment according to the present invention, a mechanism for predicting local slack based on a heuristic technique is proposed. In the mechanism, local slack is predicted in a try-and-error manner while behavior exhibited upon execution of an instruction is observed. By this, the need to directly calculate local slack is eliminated. Furthermore, in the present preferred embodiment, as an application example, a technique for reducing the power consumption of functional units, using local slack is taken up and advantageous effects of the proposed mechanism are evaluated.

1 Technique for Heuristically Predicting Local Slack

With respect to conventional techniques, in the present preferred embodiment, a technique for heuristically predicting local slack is proposed. In this technique, local slack to be predicted (hereinafter, referred to as “a predicted slack”) is increased or decreased while behavior exhibited upon execution of an instruction is observed, and the predicted slack is brought to approximate actual local slack (hereinafter, referred to as “a target slack”). Since a prediction is made in a try-and-error manner, unlike the conventional techniques, there is no need to directly calculate local slack.

In the following, for simplicity of description, first of all, a basic operation of the proposed technique will be described. Then, a modification is made to cope with a dynamic change in target slack. Finally, the configuration of the proposed technique will be described.

1.1 Basic Operation

First of all, the basic operation of the proposed technique according to the present preferred embodiment will be shown. Upon instruction fetch, local slack is predicted and the execution latency of an instruction is increased based on the predicted slack. For every instruction, when an instruction is first fetched, its local slack is predicted to be 0. That is, an initial value of predicted slack is 0. Thereafter, while behavior exhibited upon execution of the instruction is observed, the predicted slack is gradually increased until reaching target slack.

That is, specifically, in this prediction method, first of all, upon fetching an instruction, predicted slack of the instruction is obtained and the execution latency of the instruction is increased by an amount equivalent to the obtained predicted slack. For example, when predicted slack of an instruction whose original execution latency is “1 cycle” is “2”, the execution latency of the instruction is increased to “3 cycles”. It is noted that for every instruction, when an instruction is first fetched after a program starts, the local slack of the instruction is predicted to be “0”. That is, for all instructions, the initial value of their predicted slack is set to “0”. Thereafter, behavior of the instruction upon execution is observed and the predicted slack is gradually increased until it is estimated that the predicted slack has reached target slack.

Next, a method will be described for determining, in the basic operation, whether or not predicted slack has reached target slack, based on behavior exhibited upon execution of an instruction. In this case, a situation will be considered in which the predicted slack of a particular instruction is increased and a value of the predicted slack has reached target slack. In this case, the instruction is in a state in which if the execution latency of the instruction is increased by just 1 cycle, the execution of instructions that depend on the instruction is delayed. Examples of a dependency relationship between instructions include a control dependence, a dependence via a cache line, a register data dependence, and a memory data dependence. Thus, it can be considered that an instruction whose predicted slack has reached target slack exhibits any of the following behaviors:

(a) branch prediction miss;

(b) cache miss;

(c) operand forwarding to a subsequent instruction; and

(d) store data forwarding to a subsequent instruction.

First of all, the (a) branch prediction miss will be described. A processor that performs pipeline processing simultaneously executes multiple instructions in an assembly line manner, and thus, when a sequence of instructions to be executed subsequently is changed by a branch instruction, all subsequent instructions whose processes have already started need to be discarded, reducing processing efficiency. In order to prevent this, a prediction of whether or not instructions are branched is made based on a branch occurrence state at the time of the branch instruction is executed previously, and according to a result of the prediction, instructions which are a predicted branch destination are speculatively executed. In this case, a situation where predicted slack exceeds target slack will be considered. In such a situation, the execution latency of a preceding instruction is excessively increased and accordingly the execution of subsequent instructions that depend on the preceding instruction is delayed. In such a case, a correct branch prediction cannot be made and thus a result of a branch prediction tends to become erroneous. Therefore, it can be considered that when a branch prediction miss occurs, it is highly possible that predicted slack exceeds target slack.

Next, the (b) cache miss will be described. In many processors, data with high frequency of use and the like are stored in high-speed cache memory, and this leads to that access to a low-speed storage apparatus is reduced and the speed of processing by a processor is increased. When predicted slack of a preceding instruction exceeds target slack, such a cache operation cannot be properly performed and accordingly a cache miss tends to occur more easily. Hence, it can be considered that when a cache miss occurs, too, it is highly possible that predicted slack exceeds target slack.

Now, the (c) operand forwarding to a subsequent instruction and the (d) store data forwarding to a subsequent instruction will be described. When the time interval between the execution of a preceding instruction and the execution of a subsequent instruction that refers to data defined by the preceding instruction is short, the subsequent instruction may try to read the data before a data write is completed, and as a result a data hazard may occur. Hence, in many processors having multi-stage pipelines, a bypass circuit is provided to execute operand forwarding or store data forwarding which directly provides data before writing to a subsequent instruction, and this leads to that such a data hazard is avoided. Such forwarding occurs when a subsequent instruction that refers to data defined by a preceding instruction is continuously executed immediately after the preceding instruction. Therefore, it can be determined that when operand forwarding or store data forwarding occurs, predicted slack matches target slack.

In the prediction method, when behavior exhibited upon execution of an instruction applies to any of the (a) to (d) it is estimated that predicted slack has reached target slack, and when it does not it is determined that the predicted slack has not reached the target slack. An establishment condition for such an estimation that predicted slack has reached target slack is an OR condition for the (a) to (d) and is called a “target slack reach condition”. It is noted that a mechanism for detecting behavior exhibited upon execution of an instruction, such as the (a) to (d), is normally originally provided if the processor is one that performs a branch prediction, caching, and forwarding. Thus, without newly adding such a detection mechanism for local slack prediction, it is possible to check whether or not the reach condition is established.

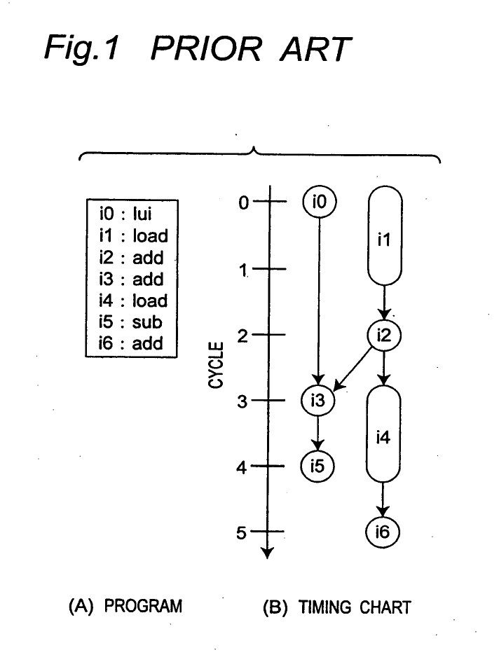

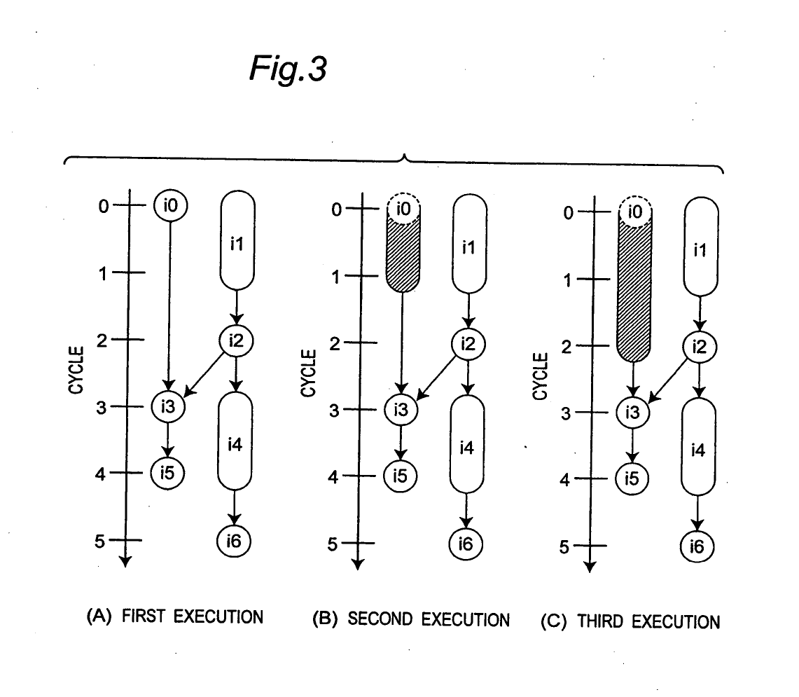

FIG. 3(A) is a timing chart showing a basic operation of a processor apparatus using the technique for heuristically predicting local slack according to the first preferred embodiment of the present invention, and showing a first execution operation. FIG. 3(B) is a timing chart showing the basic operation of the processor apparatus and showing a second execution operation. FIG. 3(C) is a timing chart showing the basic operation of the processor apparatus and showing a third execution operation. Namely, the process of repeatedly executing the program of FIG. 1(A) based on the basic operation of the proposed technique is shown in FIGS. 3(A), 3(B) and 3(C). In FIGS. 3(A), 3(B) and 3(C), a hatched portion of each node indicates execution latency increased according to predicted slack. In FIGS. 3(A), 3(B) and 3(C), for simplicity of description, only the local slack of an instruction i0 serves as a target for prediction and predicted slack is increased by 1 at a time.

In the first execution of FIG. 3(A), the predicted slack of the instruction i0 is 0. In this case, since behavior exhibited upon execution of the instruction i0 does not apply to any of the target slack reach conditions, the predicted slack has not yet reached target slack. Thus, the predicted slack of the instruction i0 is increased by 1. As a result, in the second execution of FIG. 3(B), the predicted slack of the instruction i0 becomes 1. In this case too, the predicted slack has not reached the target slack. Hence, the predicted slack of the instruction i0 is further increased by 1. By this, in the third execution of FIG. 3(C), the predicted slack of the instruction i0 becomes 2. As a result, the instruction i0 executes operand forwarding to a subsequent instruction. By this, the target slack reach condition is satisfied. Since the predicted slack has reached the target slack, the predicted slack is not increased any more. In this manner, the local slack of the instruction i0 is predicted.

1.2 Cope with Dynamic change in Target Slack

In the basic operation, it cannot sufficiently cope with a dynamic change in target slack. Even when target slack is dynamically changed, if the target slack is larger than predicted slack, the predicted slack just increases toward new target slack, and thus, there is no problem. However, if the target slack becomes smaller than the predicted slack, the predicted slack maintains its original value without being changed, and thus, the execution of subsequent instructions is delayed by an amount equivalent to the excess of the target slack (slack prediction miss penalty). This may possibly adversely influence performance.

In order to overcome this problem, first of all, a solution technique is proposed in which when target slack becomes smaller than predicted slack, the predicted slack is decreased. However, when target slack rapidly repeats increase and decrease, even if this technique is adopted, predicted slack cannot follow the target slack. As a result, a situation where the target slack becomes smaller than the predicted slack frequently occurs. Hence, a solution technique is further proposed in which reliability is adopted and an increase of predicted slack is performed carefully and a decrease of predicted slack is performed rapidly.

In the following, the above-described two solution techniques will be described in detail.

1.2.1 Decrease of Predicted Slack

For a method of implementing a decrease of predicted slack, a method is considered in which the execution time of a subsequent instruction (the time at which the subsequent instruction should be originally executed) for the case in which a slack prediction is not made is used. If the time at which a subsequent instruction should originally be executed is found out, whether or not the execution time of the subsequent instruction is delayed due to a slack prediction miss can be checked. Alternatively, target slack is directly calculated and can be compared with predicted slack. In either case, however, the time at which a subsequent instruction should originally be executed needs to be calculated taking into account various elements (resource constraints, data dependences, control dependences, etc.) that can determine the execution time of an instruction and thus it cannot be easily implemented.

In view of this, the inventors focus attention on the above-described “target slack reach condition”. By using the condition, it can be easily seen that predicted slack drops below target slack and that the predicted slack has reached the target slack. By using this feature, once predicted slack has reached target slack, then conversely, the predicted slack is decreased until dropping below the target slack. By doing so, it becomes possible to cope with a dynamic decrease in target slack with a very simple modification. Although an amount of the predicted slack that drops below the target slack becomes a waste, it can be considered that the amount is sufficiently allowable.

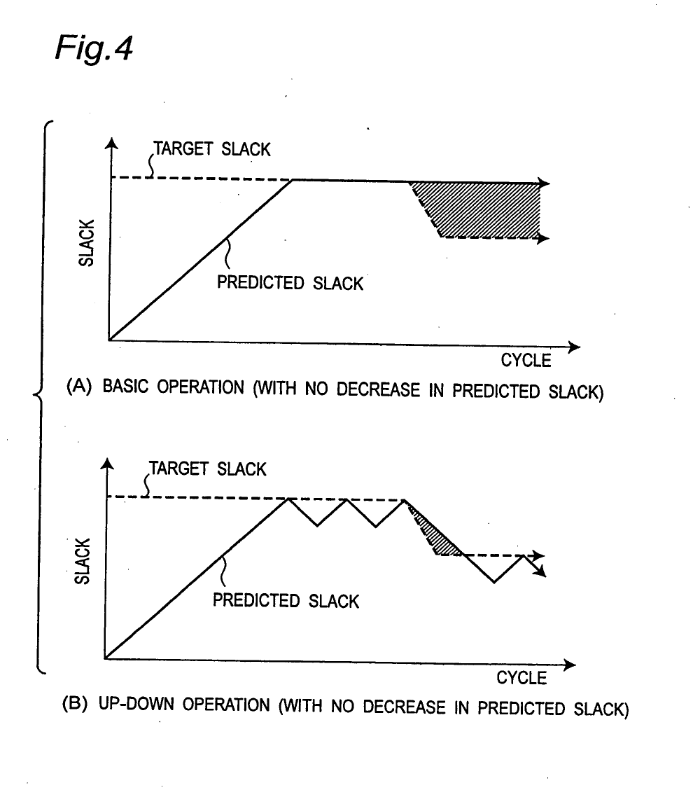

With reference to FIGS. 4(A) and 4(B), a problem of the basic operation and a solution technique for the problem will be described. FIG. 4(A) is a graph showing cycle-slack characteristics for describing the problem of the basic operation of FIG. 3 and FIG. 4(B) is a graph showing cycle-slack characteristics for describing a solution technique for the problem. FIGS. 4(A) and 4(B), namely, show examples showing how predicted slack changes when target slack dynamically decreases. In FIGS. 4(A) and 4(B), the vertical axis represents slack and the horizontal axis represents time. In line graphs, dashed lines show the case of target slack and solid lines show the case of predicted slack. Hatched portions indicate areas where the predicted slack exceeds the target slack. FIG. 4(A) shows the case of the basic operation and FIG. 4(B) shows the case of adopting a solution technique proposed in this subsection.

Referring to FIG. 4(A), the predicted slack increases until reaching the target slack. Thereafter, the target slack decreases and becomes smaller than the predicted slack. However, the predicted slack maintains its value and accordingly the execution of subsequent instructions is continuously delayed.

On the other hand, as shown in FIG. 4(B), in an operation after a modification, first of all, the predicted slack increases until reaching the target slack. After reaching, although the predicted slack decreases, the predicted slack drops below the target slack and thus immediately turns to increase and reaches the target slack again. This change is repeated for a while. Thereafter, when the target slack decreases, the predicted slack decreases to drop below the target slack and then again increase and decrease are repeated. In this manner, the predicted slack can be decreased along with a decrease in the target slack.

1.2.2 Adoption of Reliability

In order to cope with a rapid change in target slack, the basic operation is further modified. First of all, a reliability counter is adopted for each predicted slack. A counter value is decreased when an instruction satisfies the target slack reach condition; otherwise, it is increased. Then, when the counter value becomes 0, predicted slack is decreased, and when the counter value becomes larger than or equal to a given threshold value, the predicted slack is increased.

In order to carefully increase predicted slack, upon increasing the predicted slack, the counter value is reset to 0. In order to rapidly decrease predicted slack, when an instruction satisfies the “target slack reach condition”, the counter value is reset to 0.

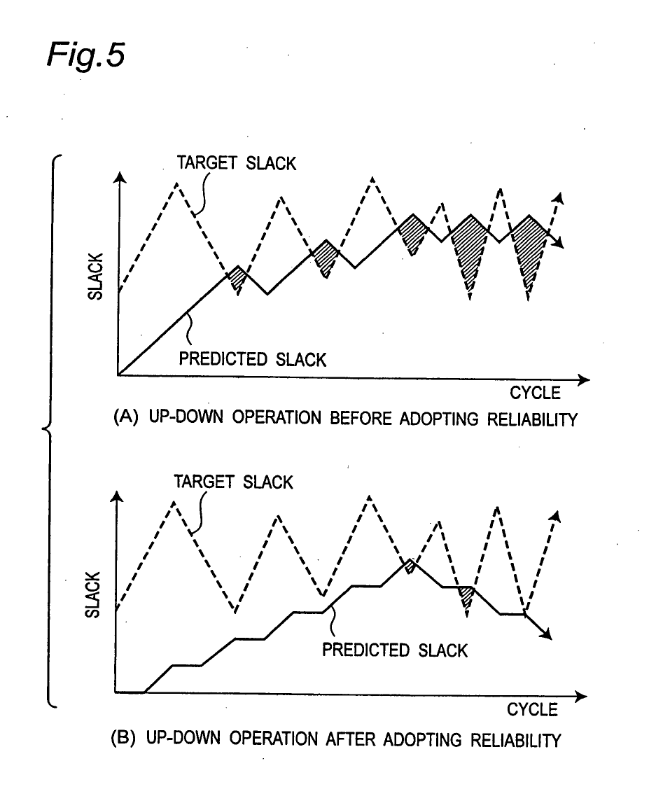

FIG. 5(A) is a graph showing cycle-slack characteristics for describing a problem of the solution technique of FIG. 4(B) and FIG. 5(B) is a graph showing cycle-slack characteristics for describing a solution technique for the problem. With reference to FIGS. 5(A) and 5(B), the problem of the solution technique shown in the previous subsection and a technique for solving the problem will be described. FIGS. 5(A) and 5(B) show examples showing how predicted slack changes when target slack rapidly repeats increase and decrease. FIG. 5(A) shows the case in which a decrease of predicted slack is adopted in the basic operation and FIG. 5(B) shows the case in which reliability is further adopted.

Referring to FIG. 5(A), it can be seen that although predicted slack tries to change toward target slack, the predicted slack cannot follow a rapid change and thus frequently exceeds the target slack. On the other hand, as shown in FIG. 5(B), when reliability is adopted, predicted slack gently increases toward target slack and repeats a change such that when the predicted slack reaches (or exceeds) the target slack, the predicted slack immediately decreases. By this, the frequency that predicted slack exceeds target slack can be reduced.

1.3 Hardware Configuration

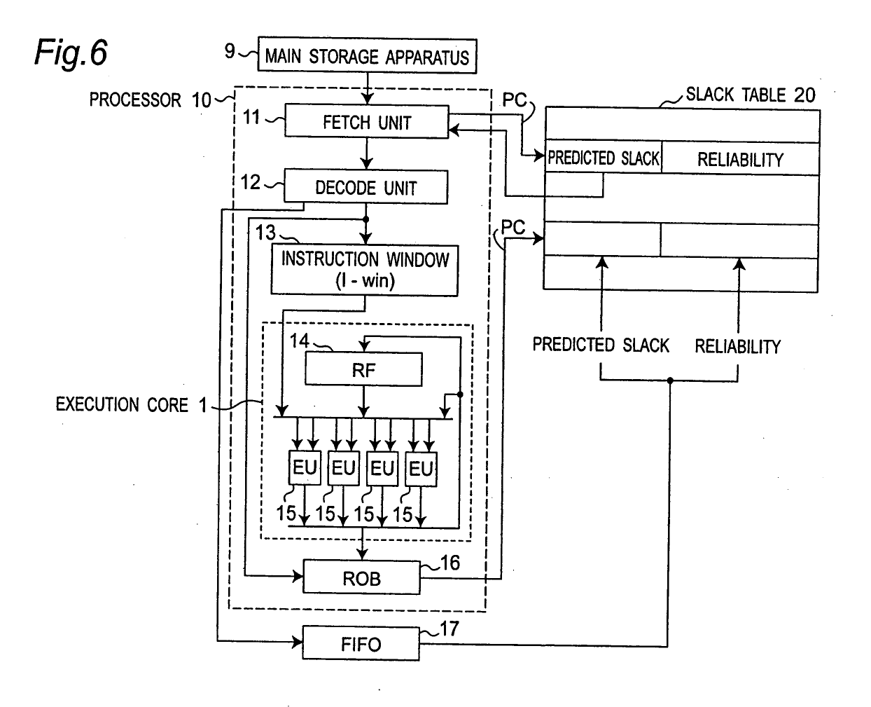

FIG. 6 is a block diagram showing the configuration of a processor 10 having a slack table 20, according to the first preferred embodiment of the present invention. In FIG. 6, a right-side portion of the processor 10 is a local slack prediction mechanism proposed by the inventors, and the proposed mechanism is composed of the slack table 20 for holding predicted slack. The slack table 20 is composed by a storage apparatus and uses a program counter value (PC: a memory address of a main storage apparatus 9 at which an instruction is stored) of an instruction as an index and each entry holds predicted slack of a corresponding instruction and reliability of the target slack reach condition.

In FIG. 6, the processor 10 is configured to include a fetch unit 11, a decode unit 12, an instruction window (I-win) 13, a register file (RF) 14, execution units (EUs) 15, and a reorder buffer (ROB) 16. The functions of the respective units composing the processor 10 are as follows. The fetch unit 11 reads an instruction from the main storage apparatus 9. The decode unit 12 analyzes (decodes) contents of the read instruction and stores the instruction in the instruction window 13 and the reorder buffer 16. The instruction window 13 is a buffer (memory) that temporarily stores an instruction before execution. A control circuit of the processor 10 fetches an instruction from the buffer of the instruction window 13 and sequentially enters instructions into the execution units 15. On the other hand, the reorder buffer 16 is a FIFO (First-In First-Out) stack memory that stores an instruction. In the reorder buffer 16, when the execution of an instruction whose storage order is the earliest among stored instructions is completed, the instruction is fetched (committed). As used herein, “to commit” means “to update a processor state according to an execution result”. A FIFO 17 accepts, as input, predicted slack and reliability which are fetched by the fetch unit 11 from the slack table 20 and then outputted from the decode unit 12, as a set at each timing, stores the predicted slack and the reliability, and outputs the predicted slack and the reliability to the slack table 20. The register file 14 is an entity of various registers that store data necessary to execute an instruction, an execution result of an instruction, address indices of instructions being executed and to be executed, and the like.

An instruction refers, upon fetching, to the slack table using a program counter value (PC) as an index and obtains predicted slack from a corresponding entry. Then, when committing, the slack table is updated based on behavior exhibited upon execution of the instruction. Parameters related to an update to the slack table and contents of the parameters are shown below. It is noted that the minimum value Vmin of predicted slack=0 and the minimum value Cmin of reliability=0.

(1) Vmax: the maximum value of predicted slack

(2) Vmin: the minimum value (=0) of predicted slack

(3) Vinc: the amount of increase in predicted slack at a time

(4) Vdec: the amount of decrease in predicted slack at a time

(5) Cmax: the maximum value of reliability

(6) Cmin: the minimum value (=0) of reliability

(7) Cth: a threshold value of reliability

(8) Cinc: the amount of increase in reliability at a time

(9) Cdec: the amount of decrease in reliability at a time

The flow of an update to the slack table 20 is shown below. When the above-described target slack reach condition is established, the reliability is reset to 0; otherwise, the reliability is increased by the amount of increase Cinc. When the reliability becomes larger than or equal to the threshold value Cth, the predicted slack is increased by the amount of increase Vinc and the reliability is reset to 0. On the other hand, when the reliability becomes 0, the predicted slack is decreased by the amount of decrease Vdec. It is noted that in section 1.2 when the target slack reach condition is established, the reliability is reset to 0, and thus, Cdec=Cth.

Furthermore, upon increasing the predicted slack, the reliability is reset to 0, and thus, Cmax=Cth.

5 Evaluation of Slack Prediction Mechanism

In this chapter, first of all, evaluation models and an evaluation environment will be described. Then, evaluation results will be described.

5.1 Evaluation Models

The following models are evaluated.

(1) NO-DELAY model: a model in which an increase of execution latency based on predicted slack is not performed.

(2) B model: a model in which only the basic operation of the proposed technique is performed.

(3) BCn model: a model in which reliability is adopted into the basic operation of the proposed technique. A numeric value n added to the model represents the threshold value Cth of reliability.

(4) BD model: a model in which a decrease of predicted slack is adopted into the basic operation of the proposed technique.

(5) BDCn model: a model in which a decrease of predicted slack and reliability are adopted into the basic operation of the proposed technique. A numeric value n added to the model represents the threshold value Cth of reliability.

The B, BCn, BD, and BDCn models are models based on the proposed technique and thus called proposed models.

2.2 Evaluation Environment

As a simulator, a superscalar processor simulator of the publicly-known Simple Scalar Tool Set (See Non-Patent Document 1, for example) is used and an evaluation is made by incorporating a proposed scheme in the simulator. For an instruction set, the publicly-known SimpleScalar/PISA which is extended from the publicly-known MIPSR10000 is used. Eight benchmark programs, bzip2, gcc, gzip, mcf, parser, per1bmk, vortex, and vpr in the publicly-known SPECint2000, are used. In gcc 1 G instructions are skipped and in others 2 G instructions are skipped and then 100M instructions are executed. Measurement conditions are shown in Table 1. For comparison with a conventional scheme, the number of entries of the slack table is made to be the same as that for the conventional scheme (See Non-Patent Document 10, for example).

TABLE 1
Measurement Conditions

| | |
|---|---|
| Fetch Width | 8 instructions |
| Issue Width | 8 instructions |
| Instruction Window | 128 entries |
| ROB | 256 entries |
| LSQ | 64 entries |
| Number of Functional | iALU 6, iMULT/DIV 1, fpALU 1, |
| Units | fpMULT/DIV/SQRT 1 |
| Instruction Cache | Complete, 1 cycle hit latency |
| Data Cache Secondary | 32 KB, 2-way, 32 B line, |
| Cache | 4 ports, 6 cycle miss penalty |
| | 2 MB, 4-way, 64 B line, |
| | 36 cycle miss penalty |
| Store Set | 8K entry SSIT, 4K entry LFST |
| Branch Prediction | 2048-entry BTB, 4-way, |
| Mechanism | gshare with 6-bit history and 8K-entry PHT, |
| | 16-entry RAS (Return Address Stack), |
| | 5 cycle branch prediction miss penalty |
| Slack Table | 8192 entries, 2-way, |
| | (Vmax + Cth) bit line |

The parameters that are related to an update to the slack table and can be changed are the maximum value Vmax, the amount of increase Vinc, the amount of decrease Vdec, the threshold value Cth, and the amount of increase Cinc. Since there are an enormous number of combinations of these parameters, some parameters are fixed to given values. First of all, since the ratio of the amount of increase Cinc to the threshold value Cth represents the frequency of an increase in slack, the amount of increase Cinc is fixed to 1 and only the threshold value Cth is changed. Next, in order to bring predicted slack to approximate target slack as much as possible, the amount of increase Vinc is fixed to 1. Finally, in order to decrease the predicted slack as fast as possible, the amount of decrease Vdec is fixed to Vmax. As such, in this chapter, an evaluation of the proposed scheme is made by changing only the maximum value Vmax and the threshold value Cth. It is noted that for an easy comparison the threshold value Cth is limited to two values, 5 and 15, and the maximum value Vmax is limited to three values, 1, 5, and 15.

2.3 Slack Prediction Accuracy

In this case, first of all, actual slack is measured for each executed dynamic instruction. Specifically, in the NO-DELAY model, local slack of a particular instruction is determined from a difference between the time at which the instruction defines register data or memory data and the time at which the data is first referred to. Thus, slack of an instruction (branch instruction) that does not define data is infinity.

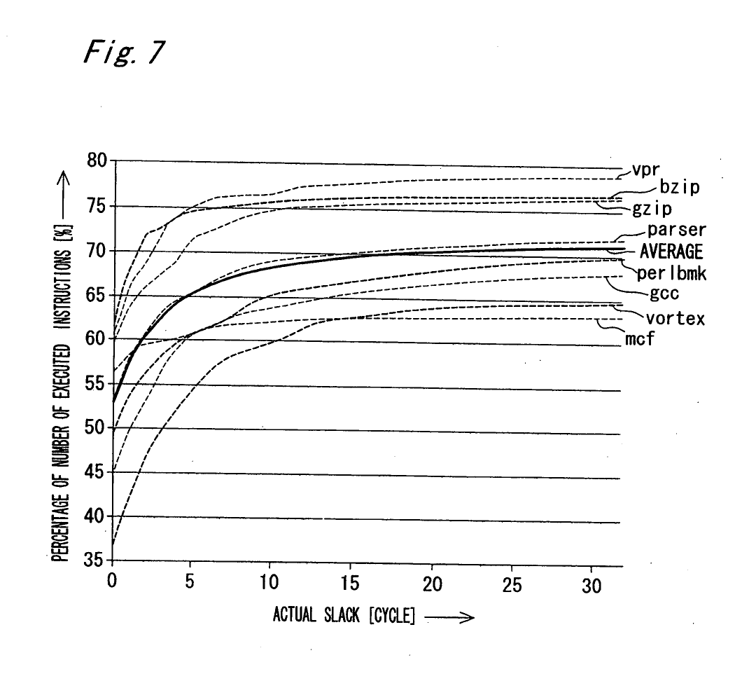

FIG. 7 is a graph showing simulation results for an implemental example of the proposed mechanism of FIG. 6, and showing a percentage of the number of executed instructions relative to actual slack in each program. FIG. 7, namely, shows a cumulative distribution of the actual slack. The vertical axis in FIG. 7 represents the percentage of the total number of executed instructions and the horizontal axis represents the actual slack. In line graphs, a solid line shows a benchmark average and dashed lines show each benchmark, respectively. At a point where the actual slack is 32 cycles, there are shown, from the top, the cases of vpr, bzip, gzip, parser, average, per1bmk, gcc, vortex, and mcf.

As shown in FIG. 7, there is an average of 52.7 percent of instructions whose actual slack is 0. As the actual slack increases, the percentage of the number of executed instructions is gradually saturated. Also, it can be seen that there is an average of 28.9 percent of instructions whose actual slack is 30 cycles or more. However, when in a normal processor the execution latency of instructions is increased by several tens of cycles or more, the instructions occupy the buffers (the reorder buffer (ROB) 16, the instruction window (I-win) 13, etc.) in the processor, significantly degrading performance (See Non-Patent Document 10, for example). How such large slack is used is not sufficiently studied at present.

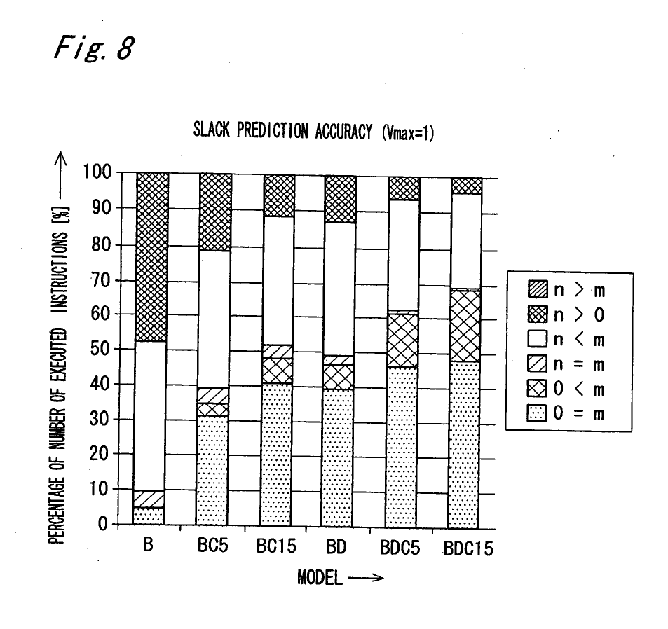

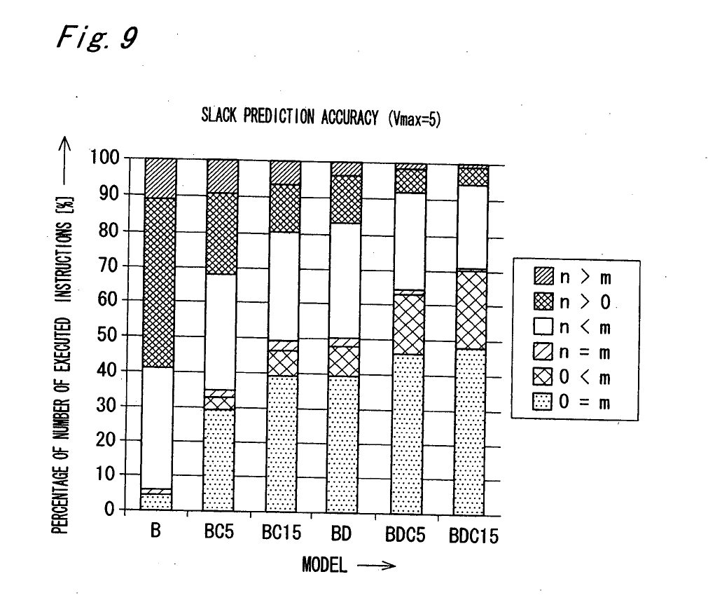

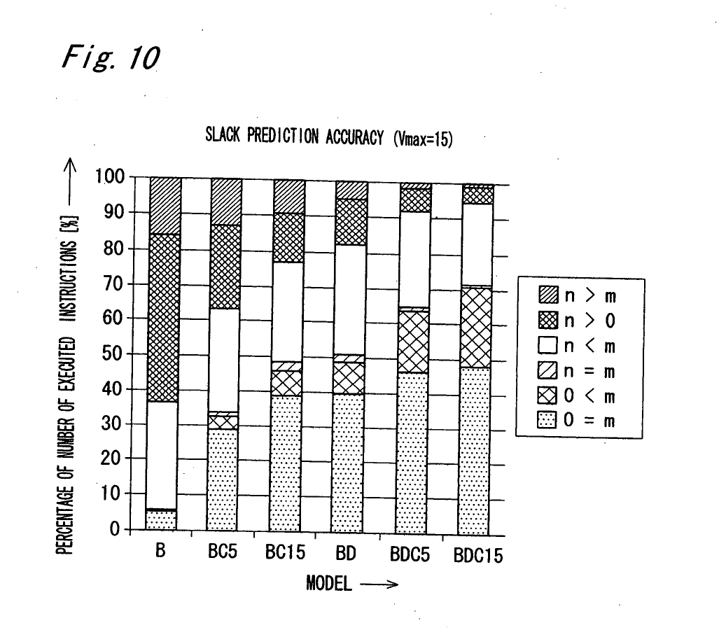

FIGS. 8, 9, and 10 are graphs showing simulation results for the implemental example of the proposed mechanism of FIG. 6, and showing percentages (slack prediction accuracy) of the number of executed instructions relative to each model for the cases in which the maximum values Vmax of predicted slack are 1, 5, and 15. In FIGS. 8 to 10, namely, results of measuring slack prediction accuracy of the proposed models are shown by benchmark averages. The vertical axis in FIGS. 8 to 10 represents the percentage of the total number of executed instructions and the horizontal axis represents the models. Each bar is composed of six portions and the top four portions show the case in which slack is predicted to be n (n is larger than or equal to 1) and the bottom two portions show the case in which slack is predicted to be 0. The cases in which slack is predicted to be n include, from the top, the case in which predicted slack n exceeds actual slack m (m is larger than or equal to 1) (n>m), the case in which predicted slack n exceeds actual slack 0 (n>0), the case in which predicted slack n drops below actual slack (n<m), and the case in which predicted slack n matches actual slack (n=m). On the other hand, the cases in which slack is predicted to be 0 include, from the top, the case in which slack drops below actual slack (0<m) and the case in which slack matches actual slack (0=m). It is noted that when the maximum value Vmax of predicted slack is 1, there is no case in which predicted slack n exceeds actual slack m, and thus, a bar is composed of five portions. Hereinafter, an event in which predicted slack matches actual slack is called a prediction hit.

It can be seen from FIGS. 8 to 10 that the prediction hit rate is lowest in the B model. On the other hand, it can be seen that a model (BD model) in which a decrease of predicted slack is adopted and a model (BCn model) in which reliability is adopted both have an advantageous effect of improving the hit rate. A model (BDCn model) in which both are adopted obtains a higher degree of advantageous effect. In the case of a model in which reliability is adopted, the higher the threshold value (a number added to the model) of reliability, the higher the hit rate. A prediction hit occurs mostly when the actual slack is 0, except for the B model in which the maximum value Vmax of predicted slack is 1. In this case, slack cannot be used.

When predicted slack exceeds actual slack, it turns out to use slack exceeding the actual slack. Hence, penalty caused by a prediction miss occurs. From FIGS. 8 to 10, the higher the hit rate, the further the occurrence rate of prediction miss penalty can be reduced. On the other hand, when predicted slack drops below actual slack, prediction miss penalty does not occur. In this case, when the predicted slack is 1 or more, slack can be used. From FIGS. 8 to 10, although the higher the hit rate the lower the rate that slack can be used without causing prediction miss penalty, such a change is relatively mild. By these, it can be seen that the proposed mechanism does not simply reduce the percentage of predicted slack being 1 or more but changes the predicted slack mainly to reduce the occurrence rate of prediction miss penalty.

Next, the influence of the maximum value Vmax of predicted slack will be considered. From FIGS. 8 to 10, when the maximum value Vmax of predicted slack is changed, the percentage of predicted slack being 0 and the percentage of predicted slack being 1 or more do not change much. From this, it can be seen that the number of instructions whose slack is predicted to be 1 or more (or no slack) does not much depend on the maximum value Vmax of predicted slack. It can also be seen that the breakdown of instructions whose predicted slack is 1 or more changes when the maximum value Vmax of the predicted slack is increased from 1 to 5 but does not change much when the maximum value Vmax of predicted slack is increased from 5 to 15. From these facts, it can be seen that when the maximum value Vmax of predicted slack is increased to a certain extent, the magnitude relationship between predicted slack and actual slack does not change much.

2.4 Difference between Actual Slack and Predicted Slack

By the evaluation made in the previous section, the magnitude relationship between actual slack and predicted slack is found out. However, only by this, it is not sure how much difference there actually is between actual slack and predicted slack. Hence, a cumulative distribution of values obtained by subtracting predicted slack from actual slack is measured. In the measurement, first of all, in the NO-DELAY model, all actual slacks of executed dynamic instructions are derived. Then, values obtained by subtracting, from actual slacks derived in the proposed models, corresponding predicted slacks are determined.

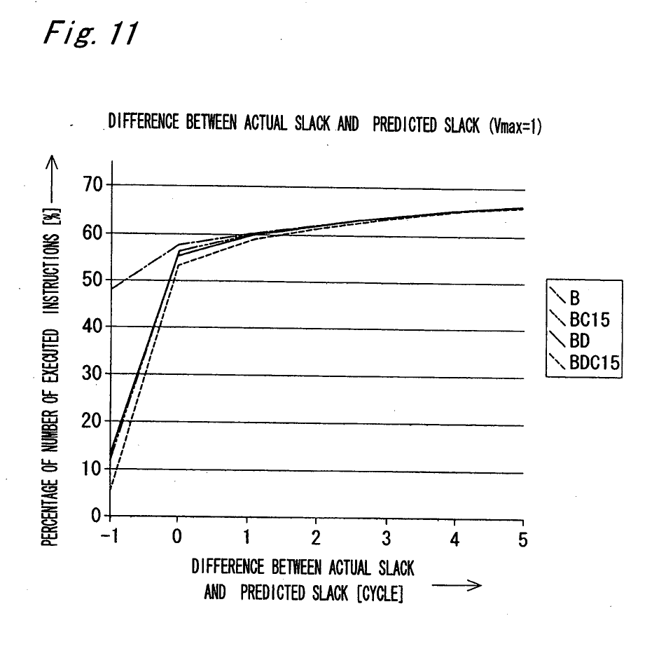

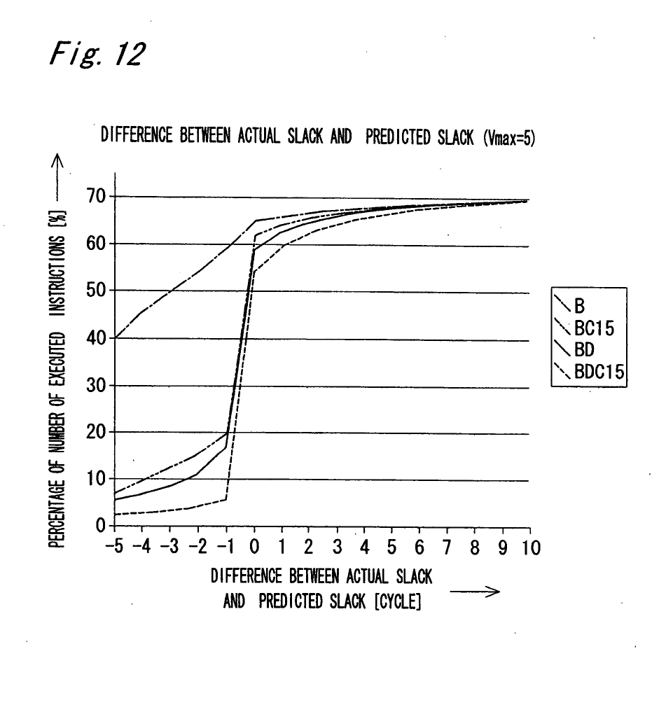

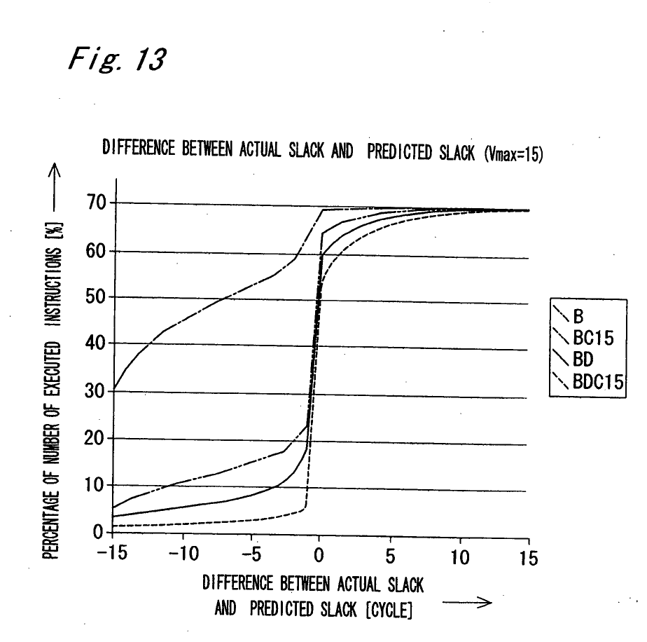

FIGS. 11, 12, and 13 are graphs showing simulation results for the implemental example of the proposed mechanism of FIG. 6, and showing percentages of the number of executed instructions relative to the difference between actual slack and predicted slack in each model for the cases in which the maximum values Vmax of predicted slack are 1, 5, and 15. The vertical axis in FIGS. 11 to 13 represents, by a benchmark average, the percentage of the total number of executed instructions and the horizontal axis represents a value obtained by subtracting predicted slack from actual slack. The value being negative indicates that predicted slack exceeds actual slack. The value being 0 indicates that slack prediction hits. The value being positive indicates that predicted slack drops below actual slack. The minimum value of the horizontal axis is a value obtained by subtracting the maximum value Vmax of predicted slack from a minimum value of actual slack of 0. In FIG. 11, the top line shows the B model, lines that substantially overlap each other show the BC15 model and the BD model, and the bottom line shows the BDC15 model. On the other hand, in FIGS. 12 and 13, lines show, from the top, the B model, the BC15 model, the BD model, and the BDC15 model. For an easy comparison of the models, results for the case in which the threshold value Cth=5 are omitted.

As is apparent from FIGS. 11 to 13, it can be seen that by adopting a decrease of predicted slack and reliability, not only the occurrence rate of prediction miss penalty but also the size of prediction miss penalty can be suppressed. The difference between the models is larger in a negative region than in a positive region. This indicates that the difference in effect of decreasing prediction miss penalty is larger than the difference in effect of increasing predicted slack. From this, it can be seen that adoption of a decrease of predicted slack and adoption of reliability can reduce slack prediction miss penalty as intended. Furthermore, it can be seen that in each model the higher the maximum value Vmax of predicted slack, the larger the prediction miss penalty. This results from the presence of a large number of instructions whose actual slack significantly decreases. For example, when the maximum value Vmax of predicted slack is 15, in the B model in which only increase and decrease of predicted slack are performed, the percentage of instructions having a difference of −15 cycles is 31.1%. This indicates that there are 31.1% of instructions whose actual slack is decreased by 15 cycles or more.

2.5 Influence on Performance

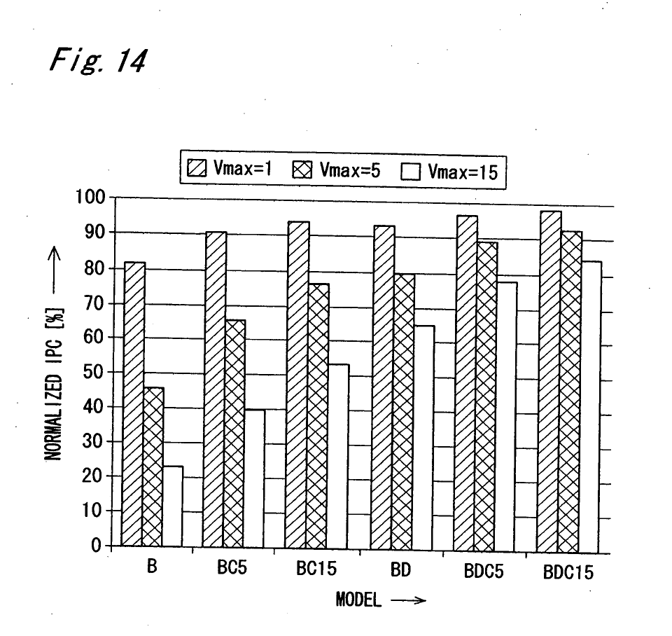

FIG. 14 is a graph showing simulation results for the implemental example of the proposed mechanism of FIG. 6, and showing normalized IPC (Instructions Per Clock cycle: the average number of instructions that can be processed per clock) in each model. The vertical axis in FIG. 14 represents, by a benchmark average, normalized IPC for the case of the NO-DELAY model. The horizontal axis in FIG. 14 represents the models. Three bars as a set respectively show, from the left, the cases in which the maximum values Vmax of predicted slack are 1, 5, and 15. It can be seen from FIG. 14 that when a comparison is made between models having the same maximum value Vmax of predicted slack, the IPC is lowest in the B model. It can also be seen that models (BDCn model) in which a decrease of predicted slack and reliability are adopted in combination achieve higher performance than models in which a decrease of predicted slack or reliability is adopted alone. In the case of a model in which reliability is adopted, the higher the threshold value (a number added to the model) of reliability, the higher the performance.

The cause of a degradation in performance of each model is the occurrence of slack prediction miss penalty. Hence, comparing the above-described results with FIGS. 8 to 10 showing slack prediction accuracy, it can be seen that when the maximum values Vmax of predicted slack are the same, models in which the rate that predicted slack exceeds actual slack (prediction miss penalty occurs) is lower have higher performance.

As is apparent from FIG. 14, it can be seen that in each model the maximum value Vmax of predicted slack is increased, the IPC is decreased. However, it can be seen that a model with higher IPC can suppress the reduction rate of IPC. The reason for this is that, as can be seen from FIGS. 11 to 13, by adopting a decrease of predicted slack and reliability, not only the occurrence rate of prediction miss penalty but also the size of prediction miss penalty can be suppressed.

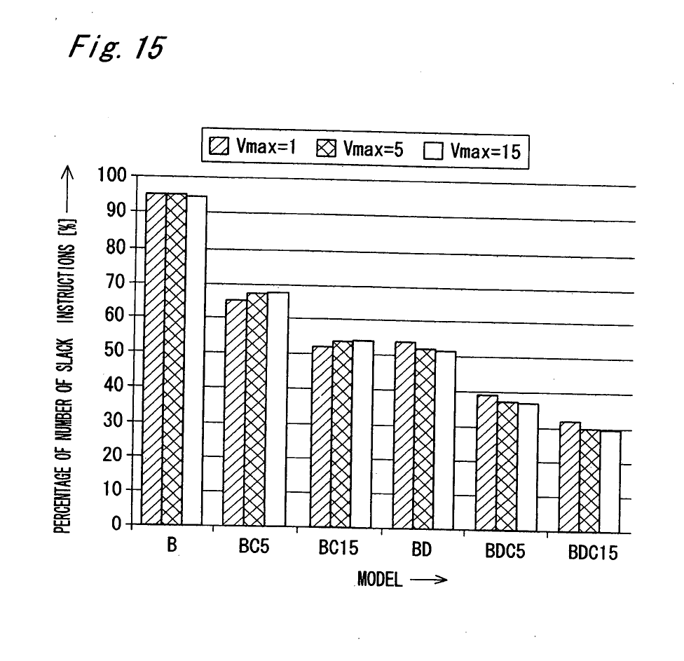

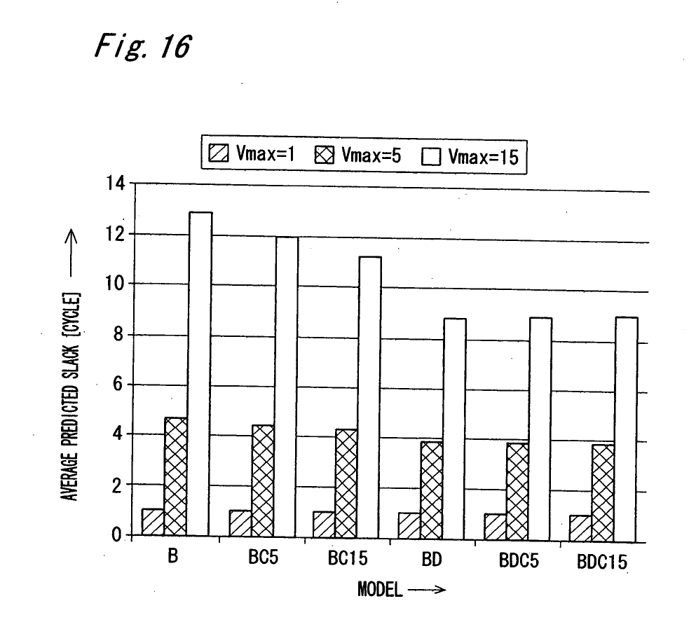

FIG. 15 is a graph showing simulation results for the implemental example of the proposed mechanism of FIG. 6 and showing a percentage of the number of slack instructions in each model. FIG. 16 is a graph showing simulation results for the implemental example of the proposed mechanism of FIG. 6 and showing average predicted slack in each model. That is, results of evaluation of predicted slack in each model are shown in FIGS. 15 and 16. FIG. 15 shows the number of “slack instructions”. As used herein, the “slack instruction” is an instruction whose execution latency is increased by 1 cycle or more based on predicted slack. The vertical axis in FIG. 15 represents, by a benchmark average, the percentage of the number of slack instructions in the total number of executed instructions and the horizontal axis represents the models. On the other hand, FIG. 16 shows “average predicted slack”. As used herein, the “average predicted slack” is a value obtained by dividing total predicted slack by the number of slack instructions. The vertical axis in FIG. 16 represents, by a benchmark average, an average value of predicted slack and the horizontal axis represents the models. From FIGS. 15 and 16, the percentage of instructions whose execution latency can be increased and average execution latency that can be increased with respect to the instructions can be found out.

From FIG. 15, the number of slack instructions depends on the type of a model or the threshold value of reliability and is smaller with a model having higher IPC but does not much depend on the maximum value Vmax of predicted slack. On the other hand, as is apparent from FIG. 16, the average predicted slack becomes larger as the maximum value Vmax of predicted slack becomes higher but is less likely to change by the type of a model or the threshold value of reliability. From these facts, when a comparison is made between models having the same maximum value Vmax of predicted slack, the total increased execution latency decreases by adopting a decrease of predicted slack and reliability and is lowest in the BDCn model. In the case of a model in which reliability is adopted, the higher the threshold value of reliability, the total increased execution latency is lower.

However, the BDCn model is the best one among others that can suppress a reduction in IPC caused by an increase in the maximum value Vmax of predicted slack. Therefore, in some cases, the BDCn model can increase predicted slack more than other models can increase predicted slack, without degrading performance much. For example, in a situation where a reduction in IPC is allowed to the order of 80%, the BC15 model, the BD model, and the BDC15 model can increase the maximum value Vmax of predicted slack to 5, 5, and 15, respectively. In this case, in the BDC15 model, the total execution latency that can be increased is higher by 15.6% than the BC15 model and by 32.6% than the BD model.

In Non-Patent Document 10, performance and the number of slack instructions are measured for the case in which local slack is predicted by a conventional technique and based on the predicted local slack the execution latency of an instruction is increased by 1 cycle. According to this, in the conventional technique, when the degradation in performance is 2.8 cycles, the percentage of the number of slack instructions is 26.7%.

Although benchmark programs and the configuration of a processor are different from those in the above-described study, the closest evaluation made in the preferred embodiment is such that in the BDC15 model the maximum value Vmax of predicted slack is 1. In this case, when the degradation in performance is 2.5 cycles, the percentage of the number of slack instructions is 31.6%. This shows that the proposed technique provides a similar result to that by the conventional technique.

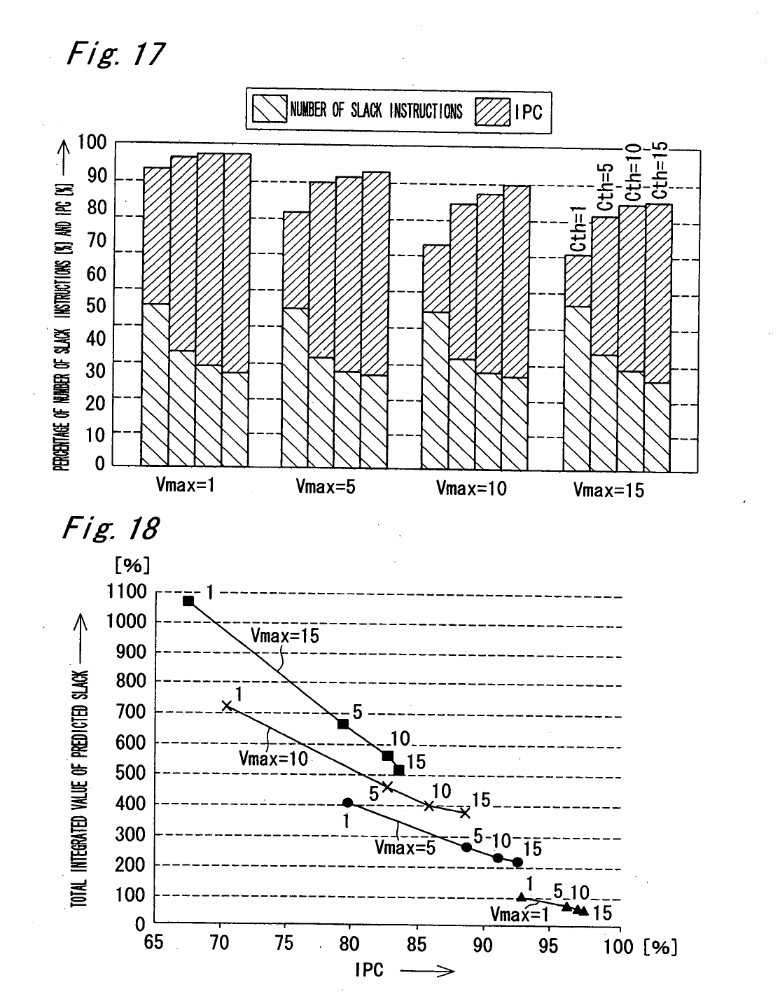

FIG. 17 is a graph showing simulation results for another implemental example of the proposed mechanism of FIG. 6 and showing a relationship between the number of slack instructions and IPC relative to each maximum value Vmax of predicted slack. FIG. 18 is a graph showing simulation results for another implemental example of the proposed mechanism of FIG. 6 and showing a total integrated value of predicted slack relative to IPC.

FIG. 17, namely, shows measurement results of the number of slack instructions and IPC in evaluations. The vertical axis in FIG. 17 represents the percentage of the number of slack instructions relative to the total number of executed instructions and the percentage of measured IPC relative to IPC for the case in which a slack prediction is not made at all, in each combination of a maximum value Vmax and a threshold value Cth. Four vertical bars as a set provided for each of the maximum values Vmax (“1”, “5”, “10”, and “15”) respectively show, from the left in the drawing, measured results for the cases in which the threshold values Cth are “1”, “5”, “10“, and “15”.

As shown in FIG. 17, when the threshold value Cth is increased, the number of slack instructions decreases. This occurs because by an increase in threshold value Cth, a condition for an increase in predicted slack becomes difficult to satisfy and accordingly the frequency of an increase in predicted slack is reduced. However, by increasing the threshold value Cth, the frequency that predicted slack exceeds target slack is reduced and thus IPC improves. From this result, it is verified that by adoption of the above-described reliability, the degradation in instruction processing performance caused by the above-described slack prediction miss penalty can be suppressed. On the other hand, by increasing the maximum value Vmax of predicted slack, it becomes possible for predicted slack to take a larger value and thus slack prediction miss penalty becomes large, degrading processing performance (IPC).

The relationship between predicted slack and IPC based on the above-described measurement results is shown in FIG. 18. The vertical axis in FIG. 18 represents the percentage of a benchmark average value of the total integrated value of predicted slack, using the case in which parameters (Vmax, Cth)=(1, 1) as a reference (100) and the horizontal axis represents the percentage of a benchmark average value of IPC using the case in which a slack prediction is not made at all as a reference (100). A number provided to each marker in FIG. 18 represents a threshold value Cth.

As shown in FIG. 18, by increasing the maximum value Vmax of predicted slack, processing performance degrades but predicted slack significantly increases. It is also verified that there are some combinations of parameters in which by increasing the maximum value Vmax and the threshold value Cth, predicted slack increases with almost no reduction in IPC. For example, with respect to the case in which parameters (Vmax, Cth)=(1, 1), in the case in which parameters (Vmax, Cth)=(5, 15), while the reduction in IPC is kept as small as 0.3%, predicted slack is about 2.2 times.

As is clear from the above results, processing performance has a trade-off relationship with the number of slack instructions and predicted slack and an optimal value for each parameter varies according to need in an application target.

3 Evaluation on Hardware of Slack Prediction Mechanism

The amount of hardware, access time, and power consumption of the slack prediction mechanism proposed in the preferred embodiment are compared with those of a conventional mechanism.

3.1 Hardware Configuration

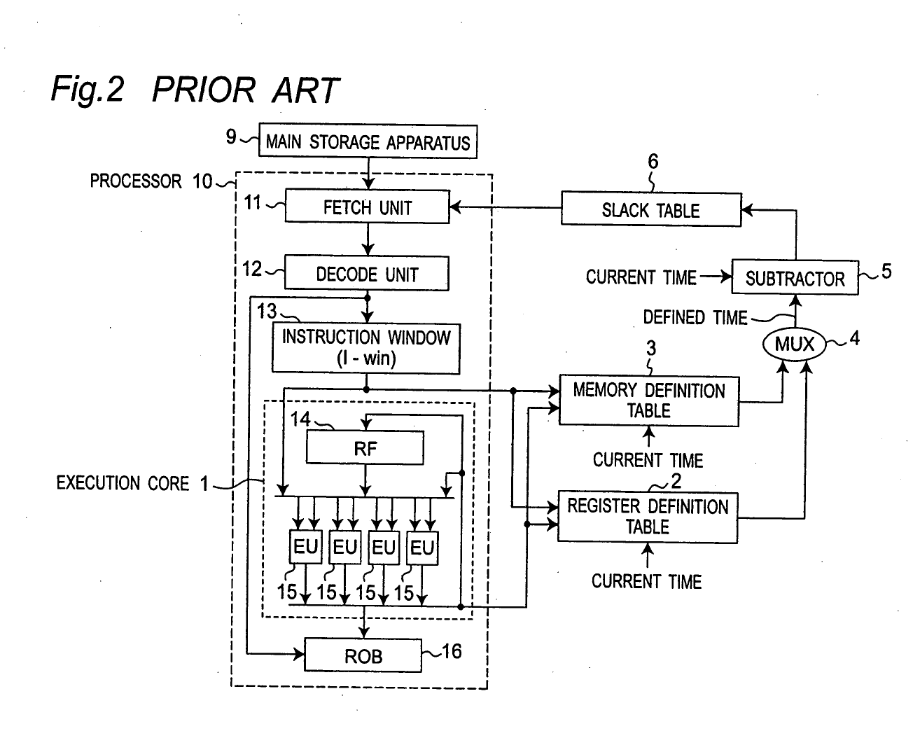

For a processor configuration, the same one as that for the evaluation environment in the previous chapter is used. The conventional mechanism of FIG. 2, namely, is used and the BDC model of FIG. 6 evaluated in the previous chapter is used as a proposed mechanism. First of all, hardware necessary for the conventional mechanism of FIG. 2 is shown below:

(1) For tables, a slack table 20, a memory definition table 3, and a register definition table 2 are provided (See FIG. 2).

(2) For computing units, a subtractor 5 (calculation of a slack value) of FIG. 2, a comparator (comparison of addresses), and a comparator (comparison of physical register numbers) are provided. The two comparators are, as will be described in detail later, hardware necessary when tables are pipelined and thus are not shown in FIG. 2.

In the conventional mechanism of FIG. 2, the slack table 20 holds slack values of instructions, uses a program counter value (PC) as an index, and is referred to upon fetching and updated upon execution. The memory definition table 3 uses a memory address as an index and holds a program counter value (PC) of an instruction that stores data at a corresponding memory address and a defined time of the data. The memory definition table 3 is updated with a store address and referred to with a load address. The register definition table 2 uses a physical register number as an index and holds a program counter value (PC) of an instruction that writes data into a corresponding physical register and a defined time of the data. The register definition table 2 is referred to immediately before the execution of an instruction with a physical register number corresponding to a source register of the instruction, and updated with a physical register number corresponding to a destination register. The subtractor 5 takes a difference between a defined time obtained from a definition table and a current time and calculates slack of an executed instruction. The comparator (comparison of addresses) and the comparator (comparison of physical register numbers) are necessary when the memory definition table 3 and the register definition table 2 are pipelined for high-speed operation. When the memory definition table 3 and the register definition table 2 are pipelined, if, before an update to a defined time is completed, a reference to the defined time occurs, the correct defined time cannot be obtained from the table. In order to solve this problem, forwarding of a defined time needs to be executed. Specifically, first of all, comparisons are made between an address used for an update and an address used for a reference and between physical register numbers of a destination register used for an update and a source register used for a reference. Then, if the addresses or physical register numbers are matched, forwarding of a memory defined time or a register defined time is executed.

Next, hardware necessary for the proposed mechanism is shown below:

(1) For tables, as shown in FIG. 6, a slack table 20 and a FIFO 17 that stores reliability and predicted slack are provided.

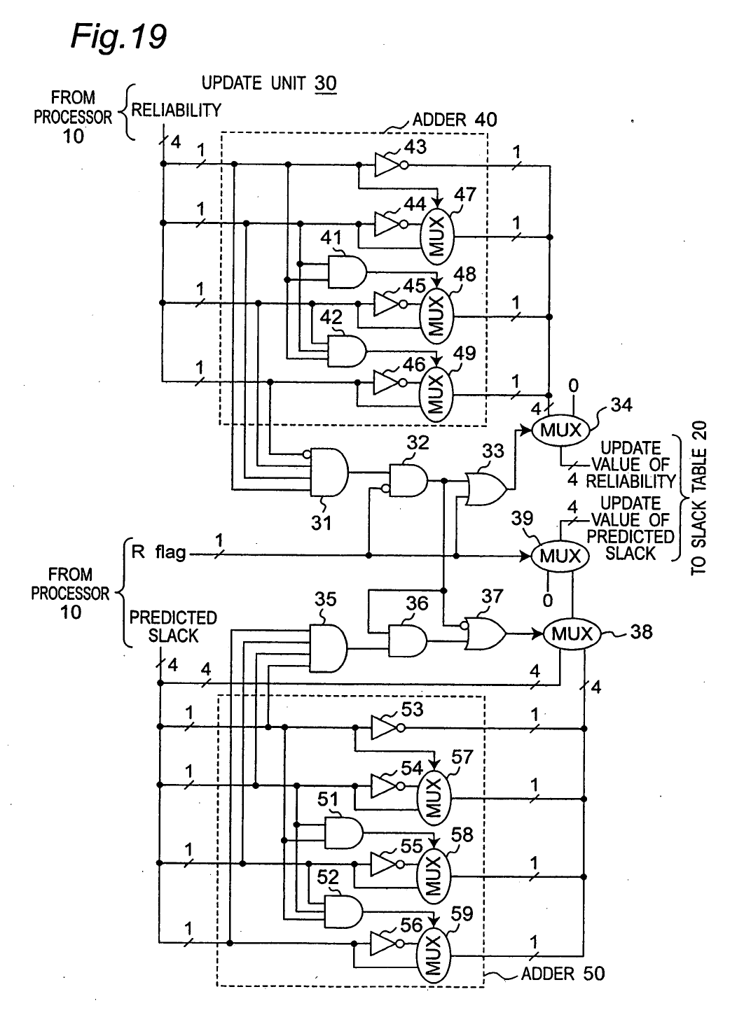

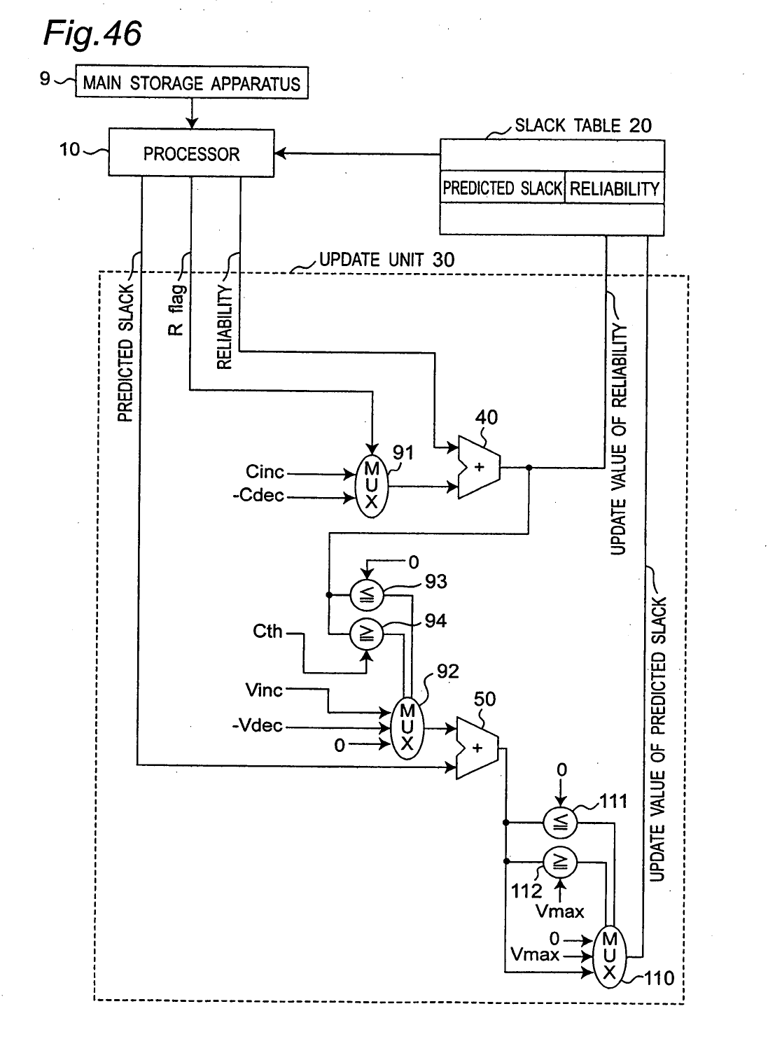

(2) For computing units, as shown in FIGS. 19 and 46, a reliability adder 40, a reliability comparator (corresponding to an AND gate 31 of FIG. 19 and a comparator 94 of FIG. 46 and hereinafter referred to as the “reliability comparator 94”), a predicted slack adder 50, and a predicted slack comparator (corresponding to an AND gate 35 of FIG. 19 and a predicted slack comparator 112 of FIG. 46 and hereinafter referred to as the “predicted slack comparator 112”) are provided.

In the proposed mechanism, the slack table 20 holds a slack value and reliability of a particular program counter value (PC) and is referred to upon fetching and updated upon committing. The FIFO 17 is a FIFO that holds reliability and predicted slack which are obtained from the slack table 20, in the order in which instructions are fetched, and is written into upon dispatching and read out upon committing. These values are used to calculate update data on the slack table 20. The FIFO 17 uses identical entries to those of the ROB 16. At the same time as an instruction is written into the ROB 16, reliability and predicted slack of the instruction is written into the FIFO 17 using an identical index and at the same time as an instruction is committed from the ROB 16, reliability and predicted slack of the instruction are read out from the FIFO 17 using an identical index and outputted to the slack table 20.

The computing units are used to update predicted slack and reliability. The reliability adder 40 is used to increase reliability by an amount of increase Cinc. The reliability comparator 94 is used to check whether increased reliability is larger than or equal to a threshold value Cth. The predicted slack adder 50 is used to increase predicted slack by an amount of increase Vinc. The predicted slack comparator 112 is used to check whether or not increased predicted slack exceeds a maximum value Vmax. If the predicted slack exceeds the maximum value Vmax, the predicted slack is set to the maximum value Vmax. In order to decrease reliability, the reliability is just reset to 0 and thus a computing unit for subtracting reliability or a comparator for checking whether or not the reliability is lower than or equal to a minimum value Cmin is not required. In addition, in this evaluation, Vdec=Vmax and to decrease predicted slack, the predicted slack is just reset to 0 and thus neither a computing unit for subtracting predicted slack nor a comparator for checking whether the predicted slack is lower than or equal to Vmin is required.

Since the amount of increase Cinc and the amount of increase Vinc are both 1, the adders 40 and 50 of the proposed mechanism need to perform only a very simple operation such as accepting, as input, only reliability or predicted slack and adding 1 to the input. Specifically, when all input bits from the 0th bit to an (n−1)-th bit are 1, one that is obtained by inverting an nth input bit is used as an nth output bit; otherwise, the nth input bit is directly used as the nth output bit. Accordingly, unlike the subtractor 5 of the conventional mechanism, the adders 40 and 50 can be very easily implemented.

By using the fact that the amounts of increase Cinc and Vinc are both 1, the comparators 94 and 112 of the proposed mechanism can also be simplified. The adder 40 (or 50) of the proposed mechanism just adds 1 to reliability (or predicted slack). Thus, the comparators 94 and 112 can determine, if input data to the adder 40 (or 50) matches Cth−1 (or Vmax), that an output from the adder 40 (or 50) is larger than or equal to the threshold value Cth (or exceeds the maximum value Vmax).

In order to properly compare the conventional mechanism and the proposed mechanism, a table configuration (the number of entries, the degree of associativity, line size, and the number of ports) needs to be found out with which in each mechanism the slack prediction accuracy does not change almost at all and access time and power consumption are kept to a minimum. However, in the conventional mechanism the influence of the configuration of tables (the slack table 20, the memory definition table 3, and the register definition table 2) on slack prediction accuracy has not yet been sufficiently examined.

In view of this, in this chapter, a table configuration is used with which the accuracy is equivalent between the conventional mechanism and the proposed mechanism. Specifically, for the slack table 20, the configuration (8K entries and a degree of associativity of 2) used for an evaluation in the previous chapter is used. The threshold value Cth and the maximum value Vmax both are assumed to be 15 which is a value, among values used for an evaluation in the previous chapter, at which the amount of hardware of the proposed mechanism is largest. For the memory definition table 3 and the register definition table 2, a configuration is used that is assumed in Non-Patent Document 10 cited for a comparison of accuracy in the previous chapter. Specifically, it is assumed that in the memory definition table 3 the number of entries is 8K and the degree of associativity is 4, and in the register definition table 2 the number of entries is 64 and the degree of associativity is 64.

According to Non-Patent Document 10, the definition tables 3 and 2 hold a part of program counter values (PC). As can be seen from the evaluation results in the previous chapter, of executed dynamic instructions, about 70 percent is those whose actual slack is 30% or less and thus there is a possibility that the number of bits necessary to represent a defined time can be reduced. However, in Non-Patent Document 10, there is no specific discussion of these numeric values. Hence, in this chapter, importance is placed on slack prediction accuracy and it is assumed that the definition tables 3 and 2 hold all program counter values (PC). It is also assumed that a reduction in the number of bits necessary to represent a defined time is not performed. Thus, each data field of the definition tables 3 and 2 has a setting that is assumed for the worst case.

The above-described table configuration places importance on slack prediction accuracy and thus access time and power consumption may become excessively high. However, there is an advantage that by using the table configuration that is found to provide substantially the same accuracy, comparisons of access time and power consumption can be made.

3.2 Comparison of Amounts of Hardware

A comparison of the amounts of hardware is made based on the number of memory cells held by required tables and the number of input bits and number of pieces of computing units. In a table, tag arrays and data arrays compose a large part of the amount of hardware. Hence, the amount of hardware of a table is estimated using the number of memory cells held by tag arrays and data arrays. Table 2 shows the number of memory cells and the number of ports of required tables. Table 2(a) shows the case of the conventional mechanism and Table 2(b) shows the case of the proposed mechanism.

TABLE 2
Costs of Tables

| Number | | | Number |
|---|---|---|---|
| of | Number of Memory Cells per Entry | | of |
| Entries | Tag Field | Data Field | Ports |

(a) Conventional Mechanism

| | | | | |
|---|---|---|---|---|
| Slack | E_{slack} | 32-log₂ (E_{slack}) + | log₂ (Vmax + 1) | N_{fetch} + |
| Table | | log₂ (A_{slack}) | | Nᵢₛₛᵤₑ |
| Memory | E_{mdef} | 32-log₂ (E_{mdef}) + | 32 + log₂ (T_{cs}) | N_{dcport} |
| Definition | | log₂ (A_{mdef}) | | |
| Table | | | | |
| Register | E_{rdef} | log₂ (E_{preg}) − | 32 + log₂ (T_{cs}) | 3 × |
| Definition | | log₂ (E_{rdef}) + | | Nᵢₛₛᵤₑ |
| Table | | log (A_{rdef}) | | |

(b) Proposed Mechanism

| | | | | |
|---|---|---|---|---|
| Slack | E_{slack} | 32-log₂ (E_{slack}) + | log₂ (Vmax + 1) + | N_{fetch} + |
| Table | | log₂ (A_{slack}) | log₂ (Cth + 1) | N_{commit} |
| FIFO | E_{rob} | — | log₂ (Vmax + 1) + | N_{fetch} + |
| | | | log₂ (Cth + 1) | N_{commit} |

In Table 2, first of all, the number of entries of each table is shown and then the number of memory cells per entry is shown separately for a tag field and a data field. The product of the number of entries and the number of memory cells per entry makes the total number of memory cells of a table. In addition, in Table 2, the number of ports of each table is shown. The number of ports is used for later evaluation of access time and power consumption. In Table 2, the numbers of entries of the slack table 20, the memory definition table 3, and the register definition table 2 are represented by E_{slack}, E_{mdef}, and E_{rdef}, respectively, and the degrees of associativity are represented by A_{slack}, A_{mdef}, and A_{rdef}, respectively. Since a comparison is made under the same conditions, the number of entries and the degree of associativity of a slack table are the same between the proposed mechanism and the conventional mechanism. N_{fetch}, Nᵢₛₛᵤₑ, N_{dcport}, and N_{commit} represent the fetch width, the issue width, the number of ports of data cache, and the commit width, respectively. N_{fetch}, Nᵢₛₛᵤₑ, and N_{commit} are assumed to be the same. E_{rob} represents the number of entries of the ROB. From the evaluation environment in the previous chapter, N_{fetch}=8 and E_{rob}=256.

The time T_{cs} is a value representing a context switch interval in a cycle unit. In the conventional mechanism, slack is calculated using a time. When the time at which a process selected by a scheduler starts its execution is 0, the time is counted until the process is saved from the processor by a context switch. Hence, in order to properly represent the time, log₂(T_{cs}) bits are required. In Linux OS (Operation System), the context switch interval is msec order and thus the time T_{cs} is assumed to be about 1 msec. From the operating frequency of an ARM core upon 0.13 μm process which is shown in Non-Patent Document 9, the operating frequency of the processor is assumed to be 1.2 GHz. From these, in order to represent the time, about 20 bits are required. Hence, hereinafter, log₂(T_{cs})=20.

Comparing the slack tables 20 between the conventional mechanism and the proposed mechanism, in the conventional mechanism, the number of memory cells in the data field is larger by log₂(Cth+1) bits. However, since there are tables other than the slack table 20, the magnitude of the amount of hardware of all tables cannot be determined only by the slack table 20.

Thus, the amount of hardware of all tables is calculated by substituting a value for each variable in the tables. The number of memory cells in the proposed mechanism is 229376 for the slack table and 2048 for the FIFO and thus 231424 in total. On the other hand, the number of memory cells in the conventional mechanism is 196608 for the slack table 20, 598016 for the memory definition table 3, and 3840 for the register definition table 2 and thus 798464 in total. Accordingly, the number of memory cells is smaller in the proposed mechanism.

Although in the above-described evaluation, in the definition tables of the conventional mechanism, the size of each data field has a setting that is assumed for the worst case, even when the size is halved, a conclusion that the number of memory cells is smaller in the proposed mechanism does not change. It is noted, however, that as described in the previous section, in order to make a proper comparison, a table configuration with which sufficient slack prediction accuracy can be obtained needs to be found out and thus it is a yet to be solved problem.

Next, a comparison is made of the amounts of hardware of computing units. Table 3 shows the number of input bits and number of pieces of computing units. Table 3(a) shows the case of the conventional mechanism and Table 3(b) shows the case of the proposed mechanism.

TABLE 3
Costs of Computing Units

| | |
|---|---|
| | Number of |
| Number of Pieces | Input Bits |

(a) Conventional Mechanism

| | | |
|---|---|---|
| Subtractor | Nᵢₛₛᵤₑ | log₂ (T_{cs}) |
| Comparator (Address) | (N_{dcport})² | 32 |
| Comparator (Register Number) | (N_{dcport})² | log₂ (E_{preg}) |

(b) Proposed Mechanism

| | | |
|---|---|---|
| Adder (Reliability) | N_{commit} | log₂(Cth + 1) |
| Comparator (Reliability) | N_{commit} | log₂(Cth + 1) |
| Adder (Predicted Slack) | N_{commit} | log₂ (Vmax + 1) |
| Comparator (Predicted Slack) | N_{commit} | log₂ (Vmax + 1) |

The number of input bits is a total of the numbers of input bits of a computing unit. The numbers of pieces of the comparators 94 and 112 are values for the case in which the number of pipeline stages that execute forwarding of a defined time is 1. When the number of stages increases, the numbers of pieces of the comparators 94 and 112 also proportionally increase; however, if forwarding does not need to be executed, no comparator is required.

Computing units are compared between the conventional mechanism and the proposed mechanism. In this case, in order to show that the amount of hardware is surely reduced in the proposed mechanism, the case will be considered in which in the conventional mechanism forwarding of a defined time does not need to be executed.

Since Nᵢₛₛᵤₑ=N_{commit}=8, it can be seen that the number of computing units in the proposed mechanism is larger by 24 than in the conventional mechanism. However, since, as described above, the computing units of the proposed mechanism can be very easily implemented, a comparison of the amounts of hardware cannot be made by simply focusing attention only on the number of pieces of computing units. Hence, the configuration of each computing unit will be studied in detail. First of all, in the subtractor of the conventional mechanism, log₂(T_{cs})=2 and thus the input is 20 bits. A basic circuit configuration is substantially the same as that of an adder with an input of 20 bits. The amount obtained by multiplying the adder by a factor of 8 is the amount of hardware of the conventional mechanism.

Now, the configuration of the computing units of the proposed mechanism will be studied in detail. First of all, if the threshold value Cth and the maximum value Vmax both are assumed to be 15, in a manner similar to that of the previous case, in each computing unit of the proposed mechanism the input is 4 bits.

FIG. 19 is a block diagram showing the configuration of an update unit 30 according to the first preferred embodiment of the present invention. In this case, FIG. 19 shows a circuit configuration of computing units (a circuit composed of these computing units is called the “update unit 30”) necessary per instruction to commit. The amount obtained by multiplying the circuit of the update unit 30 by a factor of 8 is the amount of hardware of the proposed mechanism. A reach condition flag Rflag of FIG. 19 is a flag which is 1 when the target slack reach condition is established; otherwise, it is 0. AND gates 31 and 35 at the center of FIG. 19 compose a reliability comparator 94 and a predicted slack comparator 112, respectively, portions surrounded by dashed lines compose adders 40 and 50, respectively, and other elements (OR gates 33 and 37 and multiplexers 34, 38, and 39) are circuits for control. In this case, when the number of input bits is 4 bits, the reliability comparator 94 and the predicted slack comparator 112 can be implemented by 4-input AND gates 31 and 35, respectively, that accept, as input, each bit of an input value as it is or as one obtained by inverting each bit. The adders 40 and 50 of the proposed mechanism each can be implemented by two AND gates (41 to 42; 51 to 52), four inverters (43 to 46; 53 to 56), and three multiplexers (47 to 49; 57 to 59). Thus, it can be said that it can be implemented with a sufficiently smaller amount of hardware than a 20-bit subtractor required for the conventional mechanism.

3.3 Comparison of Access Time and Power Consumption

In this section, in order to determine access time of a table and energy consumption per access, a publicly-known CACTI (See Non-Patent Document 12, for example) which is a cache simulator is used. In an evaluation by the CACTI, it is assumed that based on data on the ARM core of Non-Patent Document 9 the process is 0.13 μm and the power supply voltage is 1.1V. In the CACTI, the line size of a table needs to be inputted in a byte unit. However, in the slack table of the conventional mechanism, the data field is 4 bits and thus the line size is less than 1 byte. Hence, exclusively for the case of an evaluation by the CACTI, the data field is assumed to be 8 bits. However, by this assumption, only the size of the slack table of the conventional mechanism is doubled, and thus, under this state a fair comparison cannot be made. Hence, in the case of evaluating the proposed mechanism by the CACTI, the data fields of the slack table 20 and the FIFO 17 which are tables holding slack values are increased to 16 bits from 8 bits. Since the memory definition table 3 and the register definition table 2 do not hold slack values, their data fields are not changed.

By the above-described assumption, in the slack table 20 of the proposed mechanism, access time is increased by 4.1% and energy consumption is increased by 23%. From this fact, it can be considered that evaluation results for the slack table 20 of the conventional mechanism also have the same level of error. In the FIFO 17 of the proposed mechanism, the access time is reduced by 4.2% and the energy consumption is increased by 116%. Thus, upon making a comparison, the influence of this error is taken into account. The reason that the access time of the FIFO 17 is reduced is that the CACTI changes a division method for a data array, depending on the table configuration.

First of all, access time is compared between the proposed mechanism and the conventional mechanism. As already described, the size of a computing unit used in the slack prediction mechanism is smaller than that of an ALU (Arithmetic Logical Unit). On the other hand, for tables, there is one with the same size (or larger size) as data cache used in a processor. Therefore, it can be considered that the access times of the proposed mechanism and the conventional mechanism are determined by the access time of a table. Hence, a comparison is made between access times of tables.

Table 4 shows access times of tables which are measured by the CACTI. Table 4(a) shows the case of the conventional mechanism and Table 4(b) shows the case of the proposed mechanism.

TABLE 4
Access Time of Table

Access Time

(a) Conventional Mechanism

| | |
|---|---|
| Slack Table | 4.85 ns |
| Memory Definition Table | 1.94 ns |
| Register Definition Table | 1.67 ns |

(b) Proposed Mechanism

| | |
|---|---|
| Slack Table | 5.05 ns |
| FIFO | 0.50 ns |

It can be seen from Table 4 that in spite of the fact that the slack tables 20 have a smaller amount of hardware than the memory definition table 3, the slack tables 20 have a very long access time. The reason for this is that the access time of a table is determined not by the amount of hardware but by a table configuration (the number of entries, the degree of associativity, line size, the number of ports, etc.).

It can also be seen that since the operating frequency is assumed to be 1.2 GHz (a cycle time of 0.83 nsec), in order to make high-speed access to the slack tables 20, the memory definition table 3, and the register definition table 2, the slack tables 20, the memory definition table 3, and the register definition table 2 need to be pipelined into the order of six, three, and two stages, respectively. Even when measurement error in the access time of the slack tables 20 is taken into account, the number of stages does not decrease. However, even when the tables 3 and 2 are pipelined into six stages, the number of cycles required to obtain predicted slack of a fetched instruction is very large and thus it is difficult to use it. In addition, if the memory definition table 3 and the register definition table 2 are pipelined, forwarding of a defined time is executed, causing a problem of an increase in power consumption. In this section, however, discussion proceeds such that the tables 3 and 2 are pipelined in the above-described manner, and these problems will be discussed in the next section.

Furthermore, it can be seen from Table 4 that in both the mechanisms, the access times of the slack tables 20 are longest. Hence, it can be seen that the access time is longer in the proposed mechanism. Although there is measurement error in the access times of the slack tables 20, it can be considered that in both the mechanisms the access times increase by the same amount and thus this conclusion is not affected.

Next, a comparison of power consumption is made. In this regard, from the evaluation results in the previous chapter, since execution time is substantially the same between the conventional mechanism and the proposed mechanism, a comparison of energy consumption should be made. The total energy consumption of circuits is represented by the product of energy consumption required per operation and the number of operations.

The number of operations of each circuit is measured using the evaluation environment in the previous chapter. Since the conventional mechanism is not incorporated in the simulator used in the previous chapter, the number of operations of each circuit of the conventional mechanism is estimated from the operation of the processor 10. Specifically, in the case of the slack table 20, the slack table 20 is referred to upon fetching and updated upon execution of an instruction, and thus, the sum of the number of fetched instructions and the number of instructions executed by functional units is the number of operations. In the case of the memory definition table 3, the memory definition table 3 is referred to upon execution of a load instruction and updated upon execution of a store instruction, and thus, the number of executions of load/store instructions is the number of operations. In the case of the register definition table 2, the register definition table 2 is referred to with a physical register number corresponding to a source register of an instruction to be executed and updated with a physical register number corresponding to a destination register, and thus, the sum of the number of source registers of instructions executed by the functional units 15 and the number of destination registers is the number of operations. In the case of the subtractor 5, the sum of the number of instructions that possibly calculate slack from a time, i.e., instructions executed by the functional units 15 and having destination registers, and the number of store instructions is the number of operations. For the comparators of the conventional mechanism, assuming that there are pipelined memory definition table 3 and register definition table 2, a simulation is performed in each cycle to determine which instruction performs reference/update on which table. Then, a comparison of memory addresses or a comparison of physical register numbers which is required for forwarding of a defined time is made between instructions that perform reference/update on one same table, and the numbers of comparisons are the numbers of operations of the address comparator and the register number comparator, respectively. Since the cycle time is assumed to be 0.83 nsec, from Table 4 the memory definition table 3 and the register definition table 2 are assumed to be pipelined into three and two stages, respectively.

Energy consumption per operation is measured using the CACTI for tables. On the other hand, in the case of computing units, based on the amounts of hardware shown in the previous section, which energy consumption is higher is studied.

Table 5 shows a benchmark average of the number of operations of each circuit and energy consumption per operation of tables. Table 5(a) shows the case of the conventional mechanism and Table 5(b) shows the case of the proposed mechanism.

TABLE 5
Energy Consumption

| | |
|---|---|
| Number of | Energy Consumption |
| Operations | per Operation |

(a) Conventional Mechanism

| | | |
|---|---|---|
| Slack Table | 322M | 4.33 nJ |
| Memory Definition Table | 52M | 1.33 nJ |
| Register Definition Table | 261M | 1.12 nJ |
| Subtractor | 111M | — |
| Comparator (Address) | 27M | — |
| Comparator (Register Number) | 488M | — |

(b) Proposed Mechanism

| | | |
|---|---|---|
| Slack Table | 288M | 5.37 nJ |
| FIFO | 278M | 0.28 nJ |
| Update Unit | 100M | — |

First of all, a comparison is made of energy consumption of computing units. In this case, the energy consumption per operation of a computing unit is represented by the product of an average of load capacitances charged and discharged per operation and the square of a power supply voltage. The power supply voltage is constant. On the other hand, the load capacitance charged and discharged is represented by the total capacitance of nodes switched during an operation. In order to properly determine this value, a computing unit is designed and which node is switched with respect to a provided input needs to be checked and thus it cannot be easily evaluated. Hence, in this section, for an easy comparison, it is assumed that the load capacitance charged and discharged increases with a larger amount of hardware. Then, based on the amounts of hardware shown in the previous section, a comparison is made of energy consumption of computing units per operation.

From the previous section, the amount of hardware of a computing unit (update unit 30) of the proposed mechanism is sufficiently smaller than that of the subtractor of the conventional mechanism. Therefore, it can be determined that energy consumption required for a single operation of the computing unit of the proposed mechanism is also lower. From Table 5, the number of operations of the computing unit is smaller in the proposed mechanism. From these facts, it can be considered that the total energy consumption of the computing unit of the proposed mechanism is lower than that of the subtractor of the conventional mechanism.

Furthermore, in the conventional mechanism, forwarding of a defined time needs to be executed. Specifically, an operation is performed such that comparison values (addresses or register numbers) and defined times are broadcast using wiring lines, an address comparison or a register number comparison is made using a comparator and if comparison results are matched, a corresponding defined time is supplied to the subtractor 5 to the multiplexer 4. Thus, it can be considered that energy consumption per operation reaches a non-negligible level. In addition, from Table 5, the number of comparisons of addresses and the number of comparisons of register numbers are as large as 27M and 488M, respectively.

From these facts, it can be considered that the total energy consumption of the computing unit of the proposed mechanism is considerably lower than the total energy consumption of the computing units (the subtractor, the comparators, and the wiring lines for broadcast) of the conventional mechanism.

Next, a comparison is made of energy consumption of tables. In the slack tables 20 having substantially the same role, although the energy consumption per operation is lower in the conventional mechanism and the number of operations is smaller in the proposed mechanism, the total energy consumption of the slack table 20 is lower in the conventional mechanism. However, when energy consumptions of all tables are totaled, the result is 1.76 J for the conventional mechanism and 1.62 J for the proposed mechanism; accordingly, it can be seen that the energy consumption is lower in the proposed mechanism.

In this case, the influence of measurement error of the CACTI will be considered. Although there is measurement error in energy consumption of the slack tables 20, it can be considered that in both the mechanisms the energy consumption increases by the same amount, and thus, it can be said that the comparison results of the slack tables 20 are not affected. In addition, although by measurement error the energy consumption of the FIFO is estimated to be a higher level, measurement error does not occur in the energy consumption of the memory definition table 3 and the register definition table 2. From these facts, taking into account the influence on the energy consumption of all tables, measurement error to occur more adversely acts on the proposed mechanism. Hence, it can be said the conclusion that the proposed mechanism has lower energy consumption does not change.

From the above, it can be considered that all energy consumption for the computing units and tables is higher in the conventional mechanism.

The slack table 20 of the conventional mechanism has lower energy consumption than that of the proposed mechanism. Thus, if the energy consumption of the memory definition table 3 and the register definition table 2 can be reduced without reducing slack prediction accuracy, there is a possibility that the energy consumption of all tables can be made lower than that of the proposed mechanism. As an approach for attaining this object, a method is considered in which the size of transistors used in a circuit is reduced to reduce load capacitance to be charged and discharged. With this method, the table configuration does not need to be changed and thus energy consumption can be reduced without reducing slack prediction accuracy.

This approach, however, reduces the size of transistors, increasing the access times of the memory definition table 3 and the register definition table 2. As a result, in these tables, the number of pipeline stages increases, increasing energy consumption required for forwarding of a defined time. As such, it can be seen that forwarding of a defined time which is required for high-speed access not only increases the energy consumption of computing units but also hinders a reduction in energy consumption by the above-described approach.

3.4 Optimization of Table Configuration using Locality of Reference

The table configuration used in the previous section causes a problem that the use of predicted slack is made difficult because the access time is very long, and a problem that energy consumption for forwarding of a defined time increases. In order to solve these problems, the table configuration (the number of entries, the degree of associativity, line size, and the number of ports) needs to be changed. However, as described in Section 3.1, in the conventional mechanism, the influence of the table configuration on slack prediction accuracy is not revealed. Therefore, there is not much sense in simply changing the table configuration and measuring access time and power consumption.

Hence, in this section, only a change that is considered to have less influence on slack prediction accuracy is made on the table configuration used in the previous section and an evaluation is made of how access time and power consumption improve. It is noted that in the FIFO 17 of the proposed mechanism the access time is sufficiently shorter than that of other tables and thus the configuration is not changed.

For this object, the inventors focus attention on an access pattern of each table. First of all, the slack table 20 is considered for a pattern upon data reference and a pattern upon data update. In referring to the slack table 20, a program counter value (PC) of an instruction to be fetched is used as an index. Therefore, in a manner similar to that of the instruction cache, a program counter value (PC) used as an index continues until reaching a branch predicted as “taken”, and has very high locality of reference.

On the other hand, in updating the slack table 20, in the case of the conventional mechanism, a program counter value (PC) of an instruction executed by a functional unit 15 is used as an index. Thus, a program counter value (PC) used as an index becomes discontinuous by out-of-order execution but a range in which order changes is limited to instructions in the processor 10 and thus it can be said that the locality of reference remains high. In the case of the proposed mechanism, a program counter value (PC) of an instruction committed from the ROB 16 is used as an index. Thus, a program counter value (PC) used as an index continues until reaching a taken branch and the locality of update is very high.

From the above, it can be considered that in the slack table 20, without exerting much influence on slack prediction accuracy, the line size can be increased. It is noted, however, that in a manner similar to that of cache, when the line size is increased too much, line use efficiency decreases and the table miss rate increases, and thus, taking it into account, the line size needs to be determined.

Furthermore, it can be considered that by using the fact that a program counter value (PC) used as an index continues and performing reference/update in a line unit, the number of read ports and the number of write ports can be reduced.

In this case, it is considered how many read ports and write ports can be reduced by performing reference/update in a line unit, when the line size of the slack table 20 is increased and slack values for two instructions are held on a single line. In the processor 10 assumed in this section, N_{fetch}=8, and thus, when reference/update are performed in a line unit, the number of ports can be reduced up to 10 (five read ports and five write ports). Even if there are more ports, they cannot be used. Since slack values which are the target of reference/update are not always arranged in order from the head of a line, if the number of ports is further reduced to 8, reference/update may fail. It can be seen from these facts that once the line size is determined, the number of ports that can be reduced can be uniquely determined.

Considering the case in which in a likewise manner the line size is further increased, it can be seen that when slack values for four instructions and slack values for eight instructions are held on a single line, the numbers of ports are 6 and 4, respectively. It is noted, however, that even if the line size is increased further, since there is a possibility that slack values which are the target of reference/update may be present separately in two lines, the number of ports cannot be made smaller than 4. In the case of the conventional mechanism, since a PC used as an index upon update is not continuous, even if an update is performed in a line unit, the number of write ports cannot be reduced. However, it can be considered that by making a change that updated data is stored in a buffer and an update is performed therefrom in order of fetch, the updated data can be relatively easily sorted. Hence, in this section, it is assumed that in the conventional mechanism too, a reduction in the number of write ports is possible.

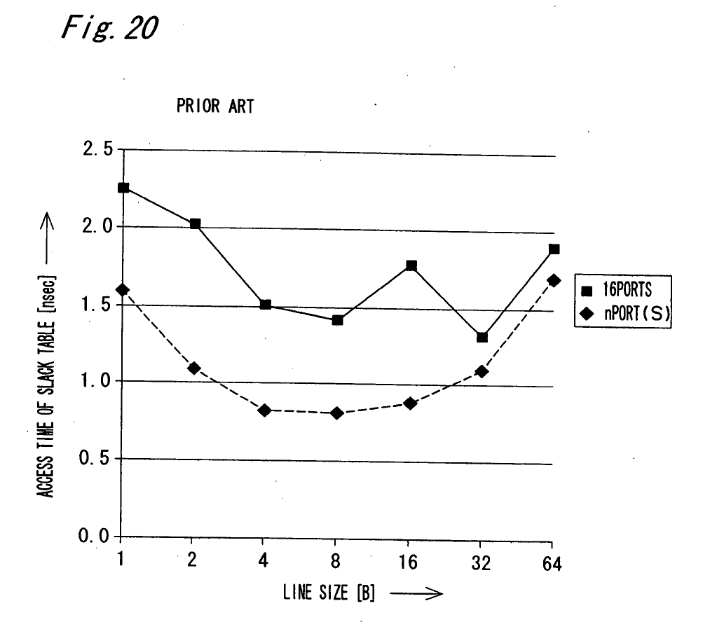

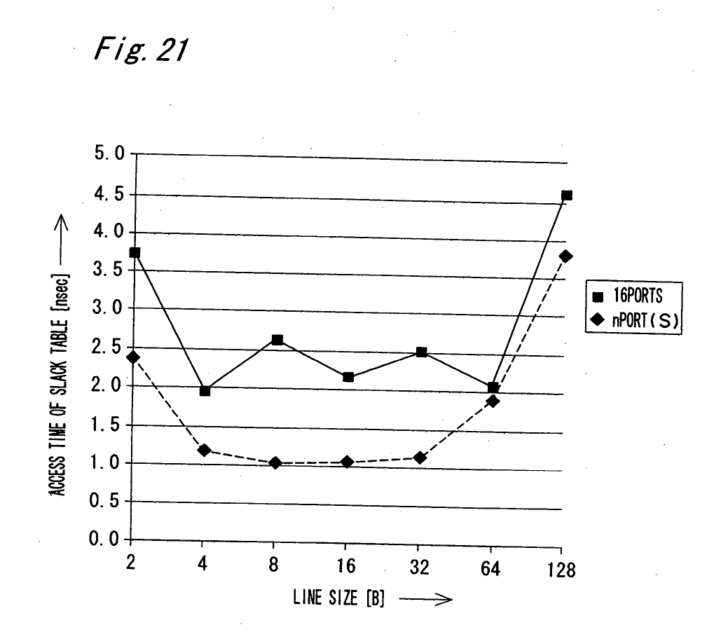

FIG. 20 is a graph showing simulation results for the conventional mechanism according to prior art and showing the access time of a slack table relative to line size. FIG. 21 is a graph showing simulation results for the proposed mechanism having the update unit 30 of FIG. 19, and showing the access time of a slack table relative to line size. Namely, FIGS. 20 and 21 respectively show results of an evaluation of access time for the conventional mechanism and the proposed mechanism, which is made by increasing the line size of the slack table 20 by 2ⁿ times (1≦n≦7). The CACTI is used for evaluation. As described in the previous section, in the slack table 20 of the conventional mechanism the data field is 4 bits and thus when the line size is not increased, an evaluation cannot be made by the CACTI. However, when the line size is increased as described above, the line size increases in a byte unit and thus an evaluation can be made by the CACTI. Hence, in this section, unlike the previous section, an evaluation is made without changing the number of bits in the data field. By this, a comparison of the conventional mechanism and the proposed mechanism can be made more properly than in the previous section.

The vertical axis in FIGS. 20 and 21 represents access time and the horizontal axis represents line size. In line graph, the top line shows the case in which the number of ports is not reduced and the bottom line shows the case in which the number of ports is reduced. As is apparent from FIGS. 20 and 21, it can be seen that when the number of ports is reduced, the access time decreases. On the other hand, it can be seen that the access time decreases first with an increase in line size, however, after some time, the access time on the contrary has a tendency to increase. Accordingly, it can be seen that to decrease the access time, the number of ports should be reduced and slack values for 8 instructions or 16 instructions should be held on a single line. However, even when slack values for 16 instructions or more are held on a single line, these values cannot be simultaneously required and thus line use efficiency decreases. Hence, in this section, the line size of the slack table 20 is changed to a size that can hold slack values for eight instructions, to reduce the number of ports. Specifically, in the case of the conventional mechanism the line size is 4 B (B represents a byte; the same applies hereinafter), and in the case of the proposed mechanism the line size is 8 B. In this state, in both the mechanisms, the number of ports can be reduced to 4.

Now, the memory definition table 3 will be considered. The memory definition table 3 is referred to and updated using a load address and a store address as indices. Thus, in a manner similar to that of data cache, it can be said that the locality of reference is high. Therefore, it can be considered that without exerting much influence on slack prediction accuracy, the line size can be increased. It is noted, however, that in a manner similar to the above, the line size should not be increased too much.

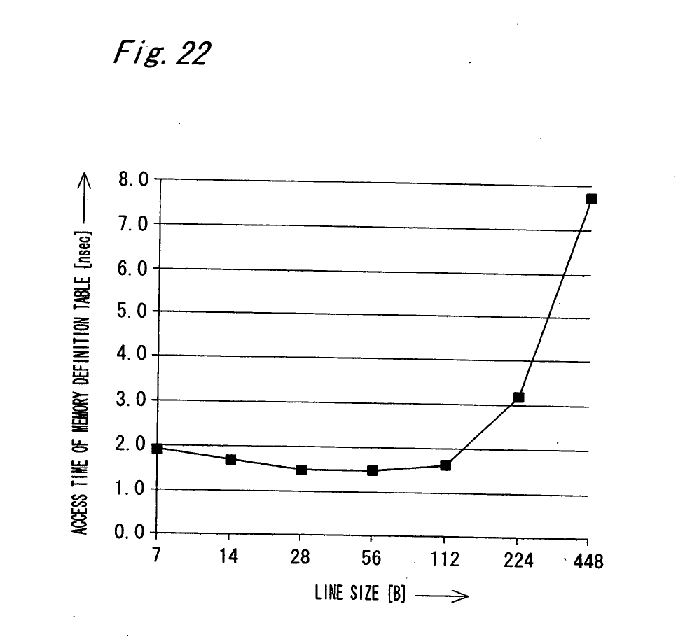

FIG. 22 is a graph showing simulation results for the proposed mechanism having the update unit 30 of FIG. 19, and showing the access time of a memory definition table relative to line size. FIG. 22, namely, shows results of an evaluation of access time which is made by changing the line size of the memory definition table 3. The vertical axis in FIG. 22 represents access time and the horizontal axis in FIG. 22 represents line size. As is apparent from FIG. 22, it can be seen that although the access time decreases with an increase in line size, the access time stops decreasing at the point of 28B and increases with a line size of 112B or more. Accordingly, it can be seen that to decrease the access time the line size should be increased not to exceed 56B.

If the line size is increased too much, however, line use efficiency decreases and there is a possibility that the table miss rate may increase. Non-Patent Document 7 shows that in data caches with capacities of 1K to 256 KB, when the line size is increased from 16 B to 256 B, in any capacity up to 32 B the cache miss rate decreases. In this case, the minimum block is 4 B and thus when the line size is 32 B, it means that data of 8 blocks is held on a single line. Though an evaluation environment for benchmarks or the like is different, in this section, with reference to this result, a line size range that does not increase the table miss rate is assumed. Specifically, in the memory definition table 3, the minimum block is 7 B (PC+defined time) and thus it is assumed that with a line size of 56 B or less the table miss rate does not increase. From the above, in this section, the line size of the memory definition table 3 is changed to 56 B.

Finally, the register definition table 2 will be considered. The register definition table 2 is referred to immediately before execution of an instruction using, as an index, a physical register number assigned to the instruction, and updated. Thus, the register definition table 2 does not have the locality of reference as the slack table 20 and the memory definition table 3 do. Therefore, in this section, the configuration of the register definition table 2 is not changed.

Table 6 shows access time and energy consumption per operation for the case in which the table configuration is optimized focusing attention on the locality of reference. In this section, upon evaluating by the CACTI, the number of bits in the data field does not need to be changed as done in the previous section. Hence, access time and energy consumption per operation are shown also for the FIFO 17 for the case in which such a change is not made.

TABLE 6
Access Time and Energy Consumption after
Table Configuration is Changed

| | |
|---|---|
| | Consumption Energy |
| Access Time | per Operation |

(a) Conventional Mechanism

| | | |
|---|---|---|
| Slack Table | 0.82 ns | 0.22 nJ |
| (4 B-line, 4-port) | | |
| Memory Definition Table | 1.47 ns | 1.09 nJ |
| (56 B-line) | | |

(b) Proposed Mechanism

| | | |
|---|---|---|
| Slack Table | 1.02 ns | 0.32 nJ |
| (8 B-line, 4-port) | | |
| FIFO | 0.52 ns | 0.13 nJ |
| (1 B-line, 16-port) | | |

It can be seen from Table 6 that in both the slack tables of the conventional mechanism and the proposed mechanism, the access time is significantly decreased and reaches a very close value to an assumed cycle time of 0.83 nsec. By this, since the number of pipeline stages is reduced to 1 for the conventional mechanism and 2 for the proposed mechanism, the use of a slack value of a fetched instruction becomes sufficiently possible. In addition, the access time of the memory definition table is decreased and the number of pipeline stages is reduced to 2 from 3. By this, the number of address comparators is reduced by an amount equivalent to the number of stages and the number of operations of the comparators is reduced to 13M from 27M. However, forwarding of a defined time remains necessary and thus the total energy consumption of computing units is higher in the conventional mechanism. In addition, it can be seen from Table 6 that in both the slack table 20 and the memory definition table 3, the energy consumption per operation is reduced.

Next, the overall access time and energy consumption of the slack prediction mechanism will be considered. It can be seen from Tables 4 and 6, by a decrease in the access times of the slack tables 20, the access time in the conventional mechanism becomes longer than that in the proposed mechanism.

With respect to Tables 5 and 6, energy consumption after optimization of the table configuration is calculated. It is noted that since a change that reference/update are performed in a line unit and the number of ports is reduced to one-quarter is made to the slack tables 20, a calculation is performed assuming that the numbers of operations of the slack tables are one-quarter of the values shown in Table 5. As a result of the calculation, the energy consumption of all tables is 0.37 J for the case of the conventional mechanism and 0.06 J for the case of the proposed mechanism; accordingly, it can be seen that in both mechanisms the energy consumption is significantly reduced. In a manner similar to that of the previous section, the energy consumption of the slack table 20 is lower in the conventional mechanism and the energy consumption of all tables is lower in the proposed mechanism.

From the above, it can be seen that by optimizing the table configuration using the locality of reference a problem about the access time of the slack table 20 can be solved. It can also be seen that the energy consumption of the slack prediction mechanism can be significantly reduced.

4 Reduction in Power Consumption of Functional Units

As an application example of local slack prediction, a study is conducted on the reduction in the power consumption of functional units without significantly degrading performance, by executing instructions with a predicted slack of 1 or more by slower functional units with lower power consumption (See Non-Patent Document 6, for example). In the present preferred embodiment too, the above-described reduction in power consumption is taken up as an application example and advantageous effects of the proposed technique are evaluated.

4.1 Evaluation Environment

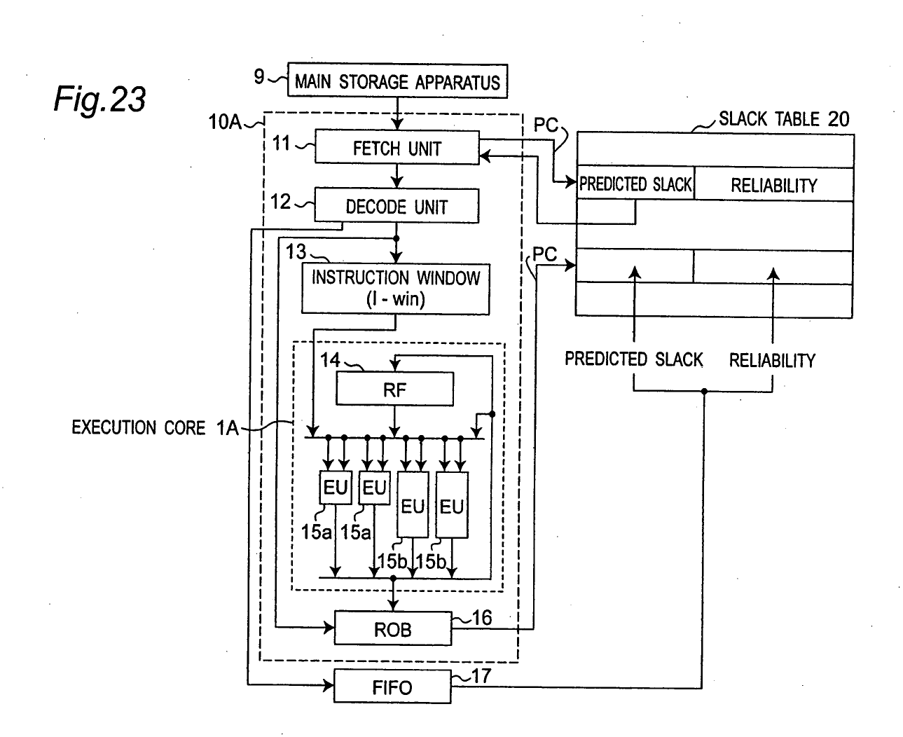

Differences in evaluation environment between this chapter and Chapter 2 will be described. FIG. 23 is a block diagram showing the configuration of a processor 10A having a slack table 20, according to a first modified preferred embodiment of the first preferred embodiment of the present invention.

For integer arithmetic functional units (iALUs), two types of such units, a fast iALU and a slow iALU, are prepared. In FIG. 23, reference numeral 15a indicates a functional unit that operates at higher speed and reference numeral 15b indicates a functional unit that operates at low speed. According to Non-Patent Document 9, it is shown that in the ARM core in 0.13 μm process, when the operating frequencies are 1.2 GHz and 600 MHz, the power supply voltages are 1.1V and 0.7V, respectively. Based on this, it is assumed that the operating frequency of the processor is 1.2 GHz (a cycle time of 0.83 nsec) and a fast iALU and a slow iALU have execution latencies of 1 cycle and 2 cycles and power supply voltages of 1.1V and 0.7V, respectively. In an evaluation, a model having n fast iALUs is called a (nf, (6−n)s) model.

Local slack is predicted using the proposed technique. In order to make an evaluation under conditions close to those of the conventional technique, the maximum value Vmax of predicted slack is set to 1 and the threshold value Cth is set to 15 and all parameters of the slack table 20 are fixed. After an instruction scheduler selects instructions to be executed by the iALUs, from instructions whose operands are ready, the instruction scheduler assign, among the selected instructions, instructions whose predicted slack is 1 to the slow iALUs and instructions whose predicted slack is 0 to the fast iALUs. If there are no slow iALUs available then an instruction is assigned to a fast iALU, and if there are no fast iALUs available then an instruction is assigned to a slow iALU. Predicted slack is used only when an instruction is assigned to an iALU and is not used for any other process. For example, the instruction scheduler never uses predicted slack when selecting instructions to be executed by the iALUs. The order in which instructions are assigned to the iALUs follows the order in which the instruction scheduler selects the instructions and predicted slack is never used.

In the above-described technique, by executing instructions by slow iALUs, the energy consumption of iALUs is reduced. However, when predicted slack exceeds actual slack, an adverse influence is exerted on processor performance. In the processor 10, the performance is a very important element. Hence, as an index that can simultaneously consider the effect of a reduction in energy consumption and the adverse influence on processor performance, the product (EDP: Energy Delay Product) of energy consumption and the execution time of the processor is measured.

The execution time of the processor 10 can be represented by the product of the number of execution cycles and a cycle time (the reciprocal of an operating frequency). On the other hand, energy consumption of the functional units 15a and 15b can be represented by the product of the number of times instructions are executed by an iALU and energy consumption per execution. The energy consumption per execution can be represented by the product of an average of load capacitances charged and discharged at a single execution and the square of a power supply voltage. Thus, the EDP is expressed by the following Equation (1):
EDP=(C_{f}·V_{f}²·N_{f}+Cₛ·Vₛ²·Nₛ)·N_{c}/f (1),

where C_{f} and Cₛ are load capacitances charged and discharged per execution in a fast iALU and a slow iALU, respectively; V_{f} and Vₛ are power supply voltages of the fast iALU and the slow iALU, respectively; N_{f} and Nₛ are the number of times instructions are executed by the fast iALU and the slow iALU, respectively; N_{c} is the number of execution cycles; and f is the operating frequency.

For the parameters V_{f}, Vₛ, and f, values assumed in the above are used. The parameters N_{f}, Nₛ, and N_{c} are determined by simulation. Although a fast iALU and a slow iALU have different operating frequencies and different power supply voltages, the type of an executable instruction is the same for both iALUs. Hence, in this section, it is assumed that even when a particular dynamic instruction is executed by both the iALUs, the load capacitances (the total capacitance of nodes switched during an operation) charged and discharged before the execution of the instruction is completed is the same for the iALUs, and thus C_{f}=Cₛ.

Strictly speaking, since a node to be switched in a circuit depends on the type of computing (addition, shift, etc.) and an input value, if they vary, the load capacitances charged and discharged at a single execution also change. In order to properly determine this value, a computing unit is designed and which node is switched with respect to a provided input needs to be checked and thus it is not easy. Hence, in an evaluation in this section, the change in load capacitance caused by different types of computing or different input values is not taken into account.

4.2 Evaluation Results

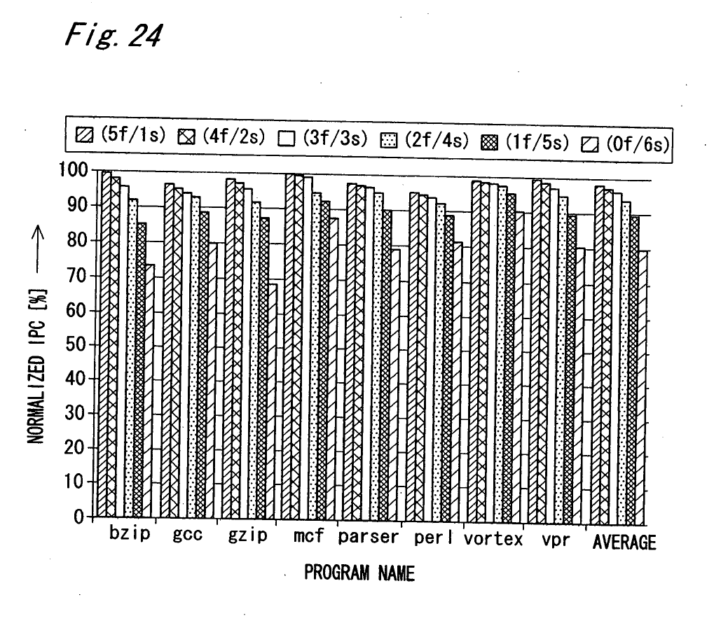

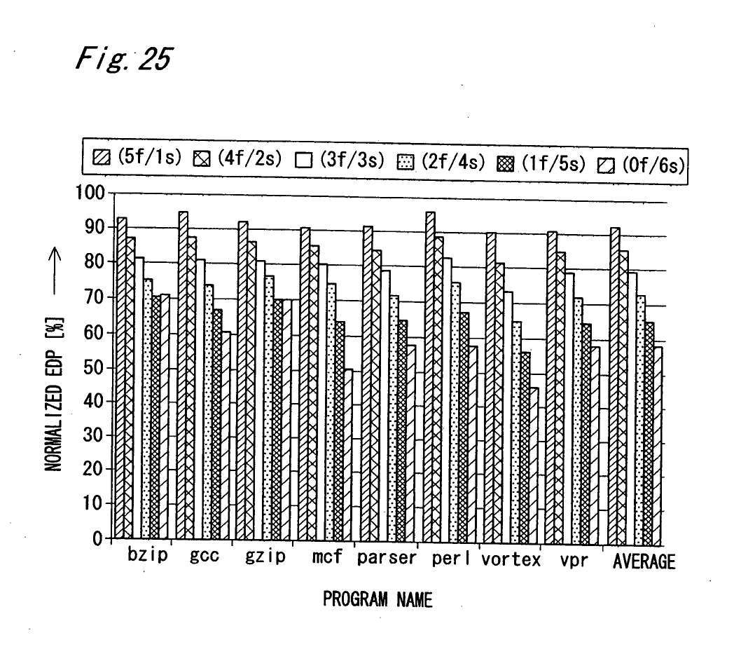

FIG. 24 is a graph showing simulation results for an implemental example of the processor 10A of FIG. 23 and showing normalized IPC relative to each program. FIG. 25 is a graph showing simulation results for the implemental example of the processor 10A of FIG. 23 and showing normalized EDP (Energy Delay Product: the product of energy consumption and the execution time of the processor 10A) relative to each program. Namely, FIGS. 24 and 25 show IPC and EDP for each benchmark, respectively. Six bars as a set respectively show, from the left, the cases of (5f/1s), (4f/2s), (3f/3s), (2f/4s), (1f/5s), and (0f/6s) models. The vertical axis in FIG. 24 represents IPC normalized by IPC of the (6f/0s) model (a model in which all iALUs are of a fast type) and the vertical axis in FIG. 25 represents EDP normalized by EDP of the (6f/0s) model.

It can be seen from FIGS. 24 and 25 that all benchmarks exhibit a substantially similar tendency. When the number of fast iALUs is reduced, in most cases, EDP decreases monotonously. However, in the proposed technique, since instructions are scheduled based on predicted slack, the decrease in IPC can be suppressed. In the (0f/6s) model (a model in which all iALUs are of a slow type), the decrease in IPC is 20.2% and the reduction rate of EDP is 41.6% on average. On the other hand, in the (1f/5s) model, in spite of the fact that the reduction rate of EDP is as high as 34.5%, the decrease in IPC can be improved up to 10.5%. In the (3f/3s) model, in spite of the fact that the decrease in IPC is as small as 3.8%, the reduction rate of EDP is as high as 20.3%.

In Non-Patent Document 6, though benchmark programs and a processor configuration are different from those in the present preferred embodiment, the (3f/3s) model is evaluated using the conventional technique as a slack prediction mechanism. As a result, it shows that with a decrease of IPC of 4.5%, EDP of 19% can be reduced. From this, it can be seen that the proposed technique shows similar results as the conventional technique.

In the above-described evaluation, attention is focused only on the power consumption of functional units. When the power consumption of a slack table is also taken into account, it is sufficiently possible that the overall power consumption of the processor does not decrease and thus it is a yet to be solved problem. However, it is considered that even in the current state, by suppressing the power consumption of functional units, an advantageous effect that the number of hot spots on a chip can be reduced can be obtained.

4.3 Application Example of the Case in which Maximum Value Vmax of Predicted Slack is 2 or More

In the application example evaluated in the previous section, an advantage of slack that the degree of urgency upon executing each instruction can be classified into three or more types is not fully used. Hence, an application example is shown of the case in which in the proposed slack prediction mechanism the maximum value Vmax of predicted slack is two or more.

As an application example, suppression of a degradation in the performance of a processor in which the power consumption of functional units is reduced is considered. For example, in the (3f/3s) model in which the maximum value Vmax of predicted slack is 2, instructions selected by an instruction scheduler are assigned to iALUs as follows. First of all, instructions whose predicted slack is 0 are assigned to fast iALUs. If there are no fast iALUs available, then the instructions are assigned to slow iALUs. Next, instructions whose predicted slack is 2 are assigned to slow iALUs. If there are no slow iALUs available, then the instructions are assigned to fast iALUs. Finally, instructions whose predicted slack is 1 are assigned to slow iALUs. If there are no slow iALUs available, then the instructions are assigned to fast iALUs. By this, when the total number of instructions whose predicted slack is 1 or 2 exceeds the number of slow iALUs, an instruction with a higher degree of urgency (a predicted slack of 1) can be assigned to a fast iALU on a priority basis.

Other application examples than the above can also be considered in which instruction scheduling is performed based on predicted slack to improve performance. For example, in the (3f/3s) model in which Vmax=2, the following modification is made to an instruction scheduler. Namely, from among instructions whose operands are ready, instructions are selected in increasing order of predicted slack, and if the predicted slack of a non-selected instruction is 1 or 2, then the predicted slack is decremented by 1. A decrement of the predicted slack of a non-selected instruction by 1 is performed because the execution start of the instruction is delayed by 1 cycle as a result of the instruction being not selected. This modification prevents an instruction whose predicted slack is n+1 or more from being selected instead of an instruction whose predicted slack is n. As a result, instructions can be executed in the order according to the degree of urgency and thus there is a possibility that the decrease in performance due to the reduction in power consumption can be lessened.

### 5 CONCLUSIONS

The inventors propose a mechanism for predicting slack by a heuristic technique. Since slack is indirectly predicted based on behavior of an instruction, the mechanism can be implemented by simpler hardware than that of conventional techniques. As a result of an evaluation, it has been found that when the threshold value of the reliability of a slack table is 15, with a decrease in IPC of as small as 2.5%, the execution latency of 31.6% of instructions can be increased by 1 cycle. It has also been found that when the power consumption of functional units are reduced, with a decrease in IPC of as small as 3.8%, EDP can be reduced by 20.3%.

6 Simulation Results for another Implemental Example

Simulation results for another implemental example will be described below.

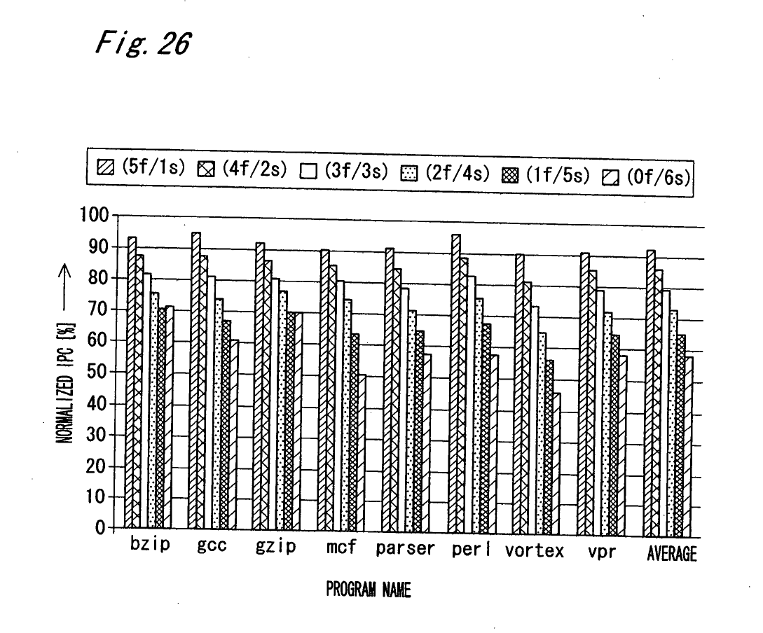

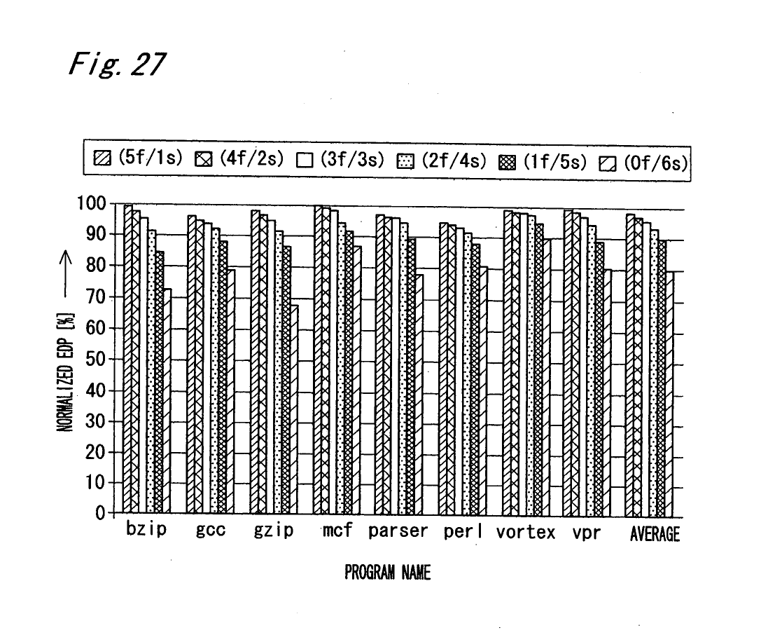

FIG. 26 is a graph showing simulation results for another implemental example of the processor 10A of FIG. 23 and showing normalized IPC relative to each program. FIG. 27 is a graph showing simulation results for another implemental example of the processor 10A of FIG. 23 and showing normalized EDP (Energy Delay Product: the product of energy consumption and the execution time of the processor) relative to each program. Namely, FIGS. 26 and 27 show measurement results of normalized IPC and normalized EDP for each benchmark in each model. The vertical axis in FIG. 26 represents the percentage of IPC using IPC in a (6f/0s) model (a model in which all iALUs are of a fast type) as a reference (100) and the vertical axis in FIG. 27 represents the percentage of EDP using EDP in the (6f/0s) model (a model in which all iALUs are of a fast type) as a reference (100). Six vertical bars as a set for each benchmark program of FIGS. 26 and 27 respectively show, from the left in the drawings, measurement results of (5f/1s), (4f/2s), (3f/3s), (2f/4s), (1f/5s), and (0f/6s) models.

As shown in FIGS. 26 and 27, all benchmark programs exhibit a similar tendency. That is, when the number of fast iALUs is reduced, in most cases, EDP decreases monotonously. However, by dividing instructions based on the results of prediction of local slack, the decrease in IPC resulting from the reduction in the number of fast iALUs is favorably suppressed. For example, in the (0f/6s) model, i.e., a model in which all iALUs are of a slow type, the decrease in the IPC of a benchmark average is 20.2% and the reduction rate of EDP is 41.6%. On the other hand, in the (1f/6s) model, in spite of the fact that the reduction rate of EDP is as high as 34.5%, the decrease in IPC remains at 10.5%. Furthermore, in the (3f/3s) model, while the decrease in IPC is as small as 3.8%, the reduction rate of EDP is as high as 20.3%.

In the above-described evaluation, attention is focused only on the power consumption of the functional units 15 and the power consumption required for the operation of the slack table 20 is not considered at all, and thus, the effect of reducing the overall power consumption of the processor is lower than the above-described results. However, if the power consumption required for the operation of the slack table 20 can be reduced to a sufficiently low level, a sufficient effect can also be expected on the reduction in the overall power consumption of the processor. It is to be understood that the functional units 15 are one of representative hot spots on a chip and thus even if the overall power consumption of the processor cannot be reduced, when the power consumption of the functional units can be suppressed, an advantageous effect that the hot spots on the chip can be distributed can be obtained.

In the local slack prediction mechanism according to the present preferred embodiment, the fetch unit 11 also functions as the above-described execution latency setting means. In addition, the slack table 20 (strictly speaking, an operation circuit that updates entries of the slack table 20) also functions as the above-described estimation means and predicted slack update means.

According to the above-described local slack prediction method and local slack prediction mechanism of the present preferred embodiment, the following advantageous effects can be obtained.

(1) Since predicted slack is not directly determined by calculation but is determined such that while behavior exhibited upon execution of an instruction is observed, the predicted slack is gradually increased until reaching target slack, a complex mechanism required to directly compute predicted slack is not required, making it possible to predict local slack with a simpler configuration.

(2) Since behaviors of the above-described conditions (A) to (D) exhibited upon execution of an instruction, which can be detected by a detection mechanism originally included in a processor, are local slack reach conditions, without additionally installing an extra detection mechanism for local slack prediction, the reach of predicted slack to target slack can be checked.

(3) Since predicted slack is decreased upon the establishment of a target slack reach condition, the occurrence of a delay in execution of subsequent instructions due to an excess evaluation of predicted slack can be favorably suppressed.

(4) Since a reliability counter is installed and an increase of predicted slack is performed carefully and a decrease of predicted slack is performed rapidly, even when target slack frequently repeats increase and decrease, the frequency of the occurrence of a delay in execution of subsequent instructions due to an excess evaluation of predicted slack can be reduced to a low level.

7 Expansion of Index Technique of Slack Table

Next, further function expansion of the above-described local slack prediction method and prediction mechanism will be described. In many cases, behavior of a branch instruction in a program depends on what functions and instructions have been executed before the branch is executed (hereinafter, referred to as a “control flow”). A technique is proposed for predicting a result of a branch instruction with higher accuracy by using such a property. Conventionally, such a branch prediction technique is used to improve the accuracy of speculative execution of an instruction, but by adopting a similar principle in prediction of local slack, further improvement in prediction accuracy can be expected. A technique for making a slack prediction with higher accuracy taking into account a control flow will be described below.

A program determines what functions and instructions execute, by using a branch instruction and thus by focusing attention on a branch condition in the program a control flow can be simplified. Specifically, a history (branch history) of establishment and non-establishment of a branch condition in a program is kept such that when the branch condition is established “1” is set, and when the branch condition is not established “0” is set. For example, a branch history of branch conditions in order of fetch being such that establishment (1)→establishment (1)→non-establishment (0)→establishment (1) is represented as “1101” for the case in which the newer one is kept in the lower order. In order to use a branch history for slack prediction, an index to a slack table is generated from the branch history and a PC of an instruction. By doing so, slack can be predicted taking into account both a program counter value (PC) and a control flow. For example, even when program counter values (PC) are identical, if the control flow is different, different entries of a slack table are used and thus a prediction according to the control flow can be made.

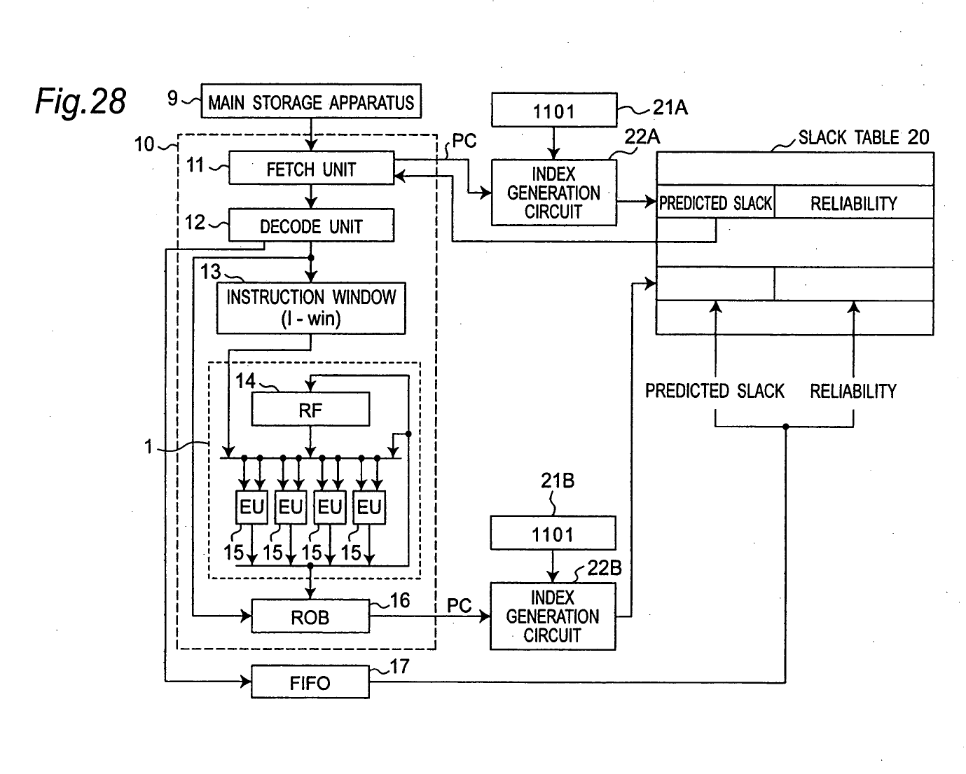

FIG. 28 is a block diagram showing the configuration of a processor 10 having a slack table 20 and two index generation circuits 22A and 22B, according to a second modified preferred embodiment of the first preferred embodiment of the present invention. FIG. 28, namely, shows an example of a hardware configuration of a local slack prediction mechanism that makes a slack prediction taking into account a control flow. In this configuration, in addition to those exemplified in FIG. 6, there are further provided a branch history register 21A, a branch history register 21B, and the two index generation circuits 22A and 22B. The branch history register 21A and the branch history register 21B are registers that keep a branch history.

The index generation circuits 22A and 22B have the same circuit configuration except that the input is different. Upon fetching an instruction, by accepting, as input, a branch history register value from the branch history register 21A and a program counter value (PC) of the instruction, the index generation circuit 22A generates an index to the slack table 20 and then refers to the slack table 20. On the other hand, upon committing an instruction, by accepting, as input, a branch history register value from the branch history register 21B and a program counter value (PC) of the instruction, the index generation circuit 22B generates an index to the slack table 20 and then updates an entry of the slack table 20. The branch history registers 21A and 21B and the index generation circuits 22A and 22B will be described in more detail below.

First of all, an update operation of a branch history by the branch history registers 21A and 21B will be described. The branch history register 21A keeps a branch history based on results of branch prediction by the processor. Specifically, an update operation is performed by the following steps. When a branch instruction is fetched, a value held by the branch history register 21A is shifted one bit to the left and if, in the fetch unit 11, the branch condition of the branch instruction is predicted to be established, then “1” is written into the lowest bit of the branch history register 21A and if, in the fetch unit 11, the branch condition of the branch instruction is predicted to be not established, then “0” is written into the lowest bit of the branch history register 21A.

The branch history register 21B keeps a branch history based on results of branch execution by the processor. Specifically, an update operation is performed by the following steps. When a branch instruction is committed, a value held by the branch history register 21B is shifted one bit to the left and if the branch condition of the branch instruction is established, then “1” is written into the lowest bit of the branch history register 21B and if the branch condition of the branch instruction is not established, then “0” is written into the lowest bit of the branch history register 21B.

As such, the reason that there are two ways of taking a branch history is because the timing at which a branch history is used is different between the branch history registers 21A and 21B, such as referring to the slack table upon fetching and updating the slack table upon committing. Upon fetching, a branch instruction is not yet executed and thus the processor predicts whether or not its branch condition is established and reads out the instruction from the memory. Therefore, in the branch history register 21A which is used upon fetching, a branch history is kept based on branch prediction. On the other hand, upon committing, a branch instruction is already executed and thus a branch history can be kept based on an execution result.

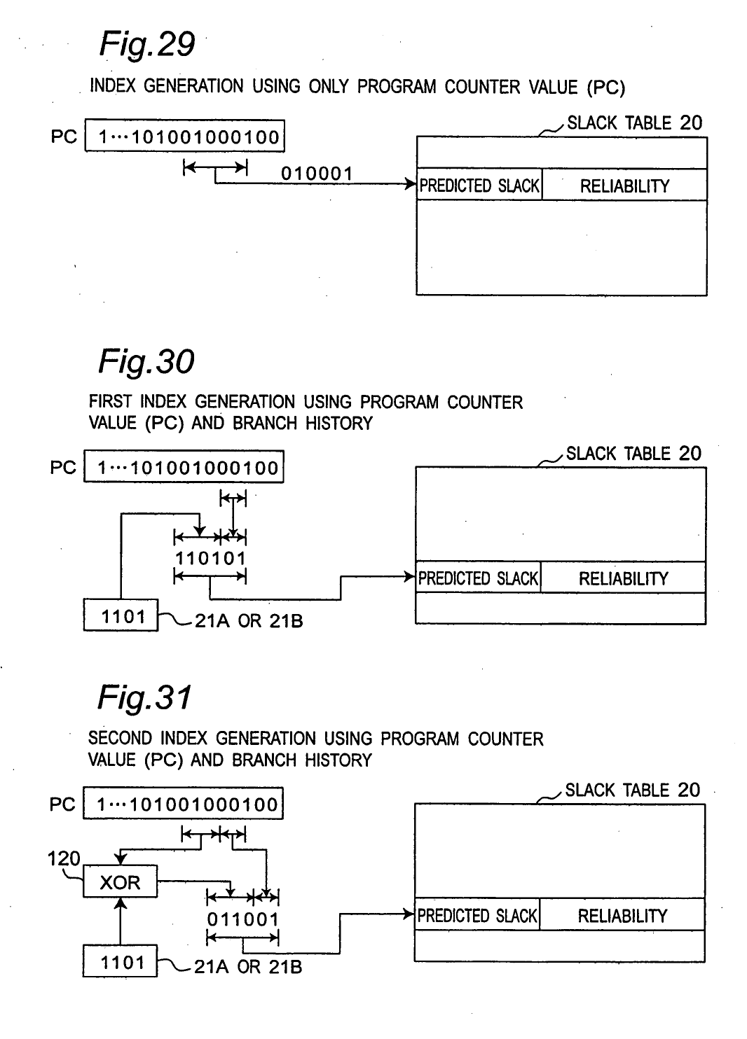

Next, with reference to FIGS. 29 to 31, index generation modes by the index generation circuits 22A and 22B will be described in detail.

FIG. 29 is a diagram showing an exemplary operation to be performed when a slack prediction is made in the slack prediction mechanism according to the first preferred embodiment, without taking into account a control flow. FIG. 29, namely, shows index generation in the above-described preferred embodiment, i.e., an index generation technique using only a PC of an instruction. In this case, some bits of a program counter value (PC) are cut and the bits are used as an index to the slack table 20.

FIG. 30 is a diagram showing a first exemplary operation to be performed when a slack prediction is made in the slack prediction mechanism of FIG. 28, taking into account a control flow. FIG. 31 is a diagram showing a second exemplary operation to be performed when a slack prediction is made in the slack prediction mechanism of FIG. 28, taking into account a control flow. FIG. 30, namely, shows an example of index generation using a branch history and a program counter value (PC) and FIG. 31 shows another example of index generation using a branch history and a program counter value (PC) as well. It is noted that when mounting to the actual processor 10, an index generation technique that is common between the two index generation circuits 22A and 22B needs to be adopted. The reason for this is because if different index generation techniques are adopted for the index generation circuits 22A and 22B, different indices are generated when updating and referring to the slack table 20, and accordingly, slack cannot be correctly predicted.

In the case of FIG. 30, an index is generated by concatenating i bits of the branch history with j bits cut from the program counter value (PC). On the other hand, in the case of FIG. 31, an index is generated by taking the exclusive OR (EXOR) of i bits of the branch history and the same number (i) of bits cut from the PC by an exclusive OR gate 120 on a bit-by-bit basis, and concatenating that bit string with j bits further cut from the program counter value (PC).

As shown in FIG. 31, even when the branch history is monotonous (all “establishment” or all “non-establishment”), by taking the exclusive OR with bits cut from the PC, the high-order bits of an index can be prevented from becoming monotonous, making it possible to effectively use entries of the slack table 20.

For example, as shown in FIGS. 30 and 31, the case will be considered in which, when the branch history is 4 bits and the low-order bits cut from the program counter value (PC) are 2 bits, slack of two instructions (an instruction 1 and an instruction 2) between which only the low-order 2 bits cut from the program counter value (PC) are the same is updated. In the following description, of PCs of the instructions 1 and 2, bits that are not related to generation of an index are omitted and the high-order 4 bits and the low-order 2 bits of bits that are not omitted are shown with a space separating them. In this case, it is assumed that the PC of the instruction 1 is “ . . . 001101 . . . ” and the PC of the instruction 2 is “ . . . 110001 . . . ”. When the branch histories of the instructions 1 and 2 both are all “establishment” (1111), in the technique of FIG. 30 the index to the slack table 20 has the same value (111101) for both instructions. On the other hand, in the technique of FIG. 31, the index to the slack table 20 has different values for the two instructions, i.e., “110001” for the instruction 1 and “001101” for the instruction 2.

As such, the technique of FIG. 31 is more advantageous upon effectively using entries; however, since extra calculation is required, a technique to be adopted is selected depending on the requirement for the slack table, i.e., depending on whether or not slack prediction with higher accuracy is desired or simplicity of the mechanism is desired. In any case, by individually storing predicted slack for different branch patterns taking into account a control flow, the accuracy of slack prediction can be further improved.

8 Extension of Target Slack Reach Condition

For behaviors exhibited upon execution of an instruction that can be used as target slack reach conditions, in addition to the above-described reach conditions (A) to (D), for example, (E) to (I) listed below may be considered. By adding part or all of them to the target slack reach conditions, a slack prediction may be more correctly made.

(E) The instruction is the oldest instruction in the instruction window 13 (See FIGS. 6 and 28) (the instruction remains in the instruction window 13 for the longest time).

(F) The instruction is the oldest instruction in the reorder buffer 16 (See FIGS. 6 and 28) (the instruction remains in the ROB for the longest time).

(G) The instruction is an instruction that passes an execution result to the oldest one of instructions present in the instruction window.

(H) The instruction is an instruction that passes an execution result to the largest number of subsequent instructions among instructions executed in the same cycle. For example, when two instructions are executed in the same cycle and one of the instructions passes an execution result to two subsequent instructions and the other passes an execution result to five subsequent instructions, the latter instruction is determined to satisfy the target slack reach condition.

(I) The number of subsequent instructions that are brought into an executable state by passing an execution result of the instruction is larger than or equal to a predetermined determination value. As used herein, the executable state refers to a state in which input data is ready and execution can start anytime.

These reach conditions (E) to (I) will be described using, as an example, the case of executing the following instructions i1 to i6, i.e.;

Instruction i1: A=5+3;

Instruction i2: B=8−3;

Instruction i3: C=3+A;

Instruction i4: D=A+C;

Instruction i5: E=9+B; and

Instruction i6: F=7−B.

First of all, if an instruction i1 and an instruction i2 are simultaneously executed in the first cycle, the instruction i1 passes an execution result to an instruction i3 and an instruction i4 and the instruction i2 passes an execution result to an instruction i5 and an instruction i6. Thus, the number of subsequent instructions to which the instruction passes an execution result is two for both of the instructions i1 and i2; however, since in the instruction i4 input data is not ready yet, the number of instructions that are brought into an executable state by the execution result of the instruction i1 is one and the number of instructions that are brought into an executable state by the execution result of the instruction i2 is two. If the determination value in the condition (I) is “1” then the instructions i1 and i2 satisfy the condition (I), and if the determination value is “2” then only the instruction i2 satisfies the condition (I).

These conditions (E) to (I) are conventionally proposed for use as the conditions to detect a critical path but can also be sufficiently used as local slack reach conditions.

9 Extension of Parameters Related to Updating Slack Table

In the above-described preferred embodiment, of parameters related to updating a slack table, the amounts of decrease Vdec and Cdec in predicted slack and reliability counter at a time are fixed to the same values as the maximum value Vmax of predicted slack and the threshold value Cth, respectively. In addition, the amounts of increase Vinc and Cinc in predicted slack and reliability counter at a time are both fixed to “1”. However, when it is important to suppress the degradation in performance or when the amount of slack that can be predicted needs to be increased as much as possible, for example, optimal values for the parameters vary depending on the situation. Therefore, it is not always necessary to fix the parameters as described above and it is desirable to appropriately determine the parameters according to a field to which slack prediction is applied.

In the above-described preferred embodiment, each parameter related to updating the slack table is set to a uniform value, regardless of the type of an instruction. For example, regardless of whether the instruction is a load instruction or a branch instruction, the same value is used for the threshold value Cth of reliability. However, in practice, the behavior of local slack, such as the degree of a dynamic change or the frequency of the change, differs depending on the type of an instruction. A typical example is a branch instruction. In a branch instruction, the amount of change in local slack is very large as compared with other instructions. When branch prediction succeeds, the influence on subsequent instructions is very little and the local slack tends to increase; however, when branch prediction fails, instructions that are mistakenly executed are all discarded and thus very large penalty occurs; accordingly, the local slack becomes “0”. This means that when the success and failure of branch prediction are switched the local slack abruptly changes. Thus, in the case of a branch instruction, it is desirable to set the threshold value Cth of a reliability counter and the amount of decrease Cdec in reliability counter at a time to larger values than those for other instructions.

In instructions belonging to other types than a branch instruction too, if the instructions have characteristics in their operation in the processor, it can be considered that there are appropriate values for parameters suitable for the characteristics for the individual types. Thus, by classifying instructions into several categories and individually setting parameters related to updating a slack table, for each category, prediction accuracy may further improve. For example, focusing attention on the difference in operation in the processor, instructions can be classified into the following four categories: a category of load instructions; a category of store instructions; a category of branch instructions; and a category of other instructions.

Parameters are individually set for each category of instructions thus classified. Upon updating, first of all, it is determined to which category a particular instruction belongs. This determination can be easily performed by looking at the OP code of the instruction. Then, a slack table is updated using unique parameters of the category to which the instruction belongs. It is noted that for a classification mode of categories of instructions, a mode in which a load instruction and a store instruction are classified into the same category or a mode in which addition and subtraction are classified into different categories can also be considered. How instructions are classified varies depending on a range to which slack prediction is applied. It is noted that when individual parameters are thus used for different types of instructions, the configuration of a local slack prediction mechanism becomes complicated, and thus, to suppress this the number of categories needs to be reduced to the minimum necessary.

### 10 Conclusion of First Preferred Embodiment

The means for solving the problems in the present preferred embodiment will be summarized below.

In the local slack prediction method according to the present preferred embodiment, an instruction to be executed by a processor is executed such that the execution latency of the instruction is increased by an amount equivalent to a value of predicted slack which is a predicted value of local slack of the instruction, an estimation is made, based on behavior exhibited upon execution of the instruction, as to whether or not the predicted slack has reached target slack which is an appropriate value for current local slack, and the predicted slack is gradually increased each time the instruction is executed until it is estimated that the predicted slack has reached the target slack.

In the above-described prediction method, a predicted value of local slack (predicted slack) of an instruction is gradually increased each time the instruction is executed. By thus increasing the predicted slack, the value eventually reaches an appropriate value (target slack) for current local slack. Meanwhile, an estimation is made, based on behavior of the processor exhibited upon execution of the instruction, as to whether or not the predicted slack has reached the target slack and when an estimation that the predicted slack has reached the target slack is established, the increase of the predicted slack stops. As a result, without directly calculating predicted slack, local slack can be predicted.

The conditions for establishing an estimation that predicted slack have reached target slack, such as the one described above, include any of the following:

(A) a branch prediction miss occurs upon execution of the instruction;

(B) a cache miss occurs upon execution of the instruction;

(C) operand forwarding to a subsequent instruction occurs;

(D) store data forwarding to a subsequent instruction occurs;

(E) the instruction is the oldest one of instructions present in an instruction window;

(F) the instruction is the oldest one of instructions present in a reorder buffer;

(G) the instruction is an instruction that passes an execution result to the oldest one of instructions present in the instruction window;

(H) the instruction is an instruction that passes an execution result to the largest number of subsequent instructions among instructions executed in the same cycle; and

(I) the number of subsequent instructions that are brought into an executable state by passing an execution result of the instruction is larger than or equal to a predetermined determination value.

In this case, the behaviors of (A) and (B) are observed in a state in which predicted slack exceeds target slack and the execution of subsequent instructions is delayed. The behaviors of (C) and (D) are observed when predicted slack matches target slack. Thus, when these behaviors are observed, it can be estimated that predicted slack has reached target slack.

On the other hand, the behaviors of (E) to (I) are used, by a conventional technique, as conditions for determining whether or not an instruction is present on a critical path. They can also be used as the above-described reach estimation conditions because a situation similar to that of an instruction on a critical path is brought about, such that when predicted slack has reached target slack, if the execution latency of an instruction is further increased even by 1 cycle, a delay occurs in execution of subsequent instructions.

If, in a situation where predicted slack matches target slack, the target slack dynamically decreases, the predicted slack exceeds the target slack and accordingly prediction miss penalty occurs that the execution of subsequent instructions is delayed. In view of this, when an estimation is made that predicted slack has reached target slack, the predicted slack is decreased, making it also possible to cope with such a dynamic decrease in the target slack.

If predicted slack is increased or decreased immediately upon the establishment or non-establishment of the estimation, in the case in which target slack frequently repeats increase and decrease, the frequency of occurrence of prediction miss penalty may become high. In such a case too, by increasing the predicted slack on the condition that the number of non-establishments for an establishment condition for an estimation that the predicted slack has reached the target slack, reaches a specified number of times and decreasing the predicted slack on the condition that the number of establishments for the establishment condition reaches a specified number of times, the increase in the frequency of prediction miss penalty caused when the target slack frequently increases and decreases can be suppressed.

In this case, by setting the number of non-establishments for an establishment condition required to increase the predicted slack to a value larger than that of the number of establishments for an establishment condition required to reduce the predicted slack, the increase of the predicted slack is performed carefully and the decrease of the predicted slack is performed rapidly. Therefore, the increase in the frequency of prediction miss penalty caused when the target slack frequency repeats increase and decrease can be effectively suppressed. Such an advantageous effect can be similarly obtained even when, while predicted slack is increased on the condition that the number of non-establishments for an establishment condition for an estimation that the predicted slack has reached target slack reaches a specified number of times, the decrease of the predicted slack is performed on condition of establishment of the establishment condition.

The behavior of local slack, such as the degree of a dynamic change or the frequency of the change, differs depending on the type of an instruction. Hence, in order to more accurately predict local slack, it is desirable that the upper limit value of predicted slack or the amount of update (the amount of increase or decrease) of the predicted slack at a time be made different for different types of instructions. When predicted slack is updated on the condition that the number of establishments or non-establishments for the establishment condition for estimation reaches a specified number of times, by making such a specified number of times different for different types of instructions, a prediction can be made with higher accuracy. For reference, it can be considered that such instruction types are classified into four categories of load instructions, store instructions, branch instructions, and other instructions, for example.

Meanwhile, the local slack of an instruction may significantly change depending on a branch path of a program leading up to the execution of the instruction. In view of this, by individually setting predicted slack for different branch patterns of a program leading to the execution of the instruction, local slack is individually predicted for each branch path of the program leading up to the execution of the instruction, making it possible to predict local slack more accurately.

In order to solve the above-described problems, the local slack prediction mechanism according to the present preferred embodiment includes, as a mechanism for predicting local slack of an instruction to be executed by a processor, a slack table in which predicted slack which is a predicted value of local slack of each instruction is stored and held; execution latency setting means for referring, upon execution of an instruction, to the slack table and this leads to obtaining of the predicted slack of the instruction, and increasing execution latency by an amount equivalent to the obtained predicted slack; estimation means for estimating, based on behavior exhibited upon execution of the instruction, whether or not the predicted slack has reached target slack which is an appropriate value for the current local slack of the instruction; and predicted slack update means for gradually increasing the predicted slack each time the instruction is executed, until it is estimated by the estimation means that the predicted slack has reached the target slack.

In the above-described configuration, predicted slack of an instruction is gradually increased by the predicted slack update means each time the instruction is executed and the execution latency of the instruction is also gradually increased in a likewise manner by the execution latency setting means each time the instruction is executed. When the predicted slack has reached target slack, the behavior of a processor exhibited upon execution of the instruction indicates such a fact and an estimation of the fact is made by the estimation means; as a result, the increase of the predicted slack by the predicted slack update means can be stopped. By this, without directly performing calculation, predicted slack can be determined.

An estimation by the estimation means that predicted slack has reached target slack can be made using one or a plurality (i.e., at least one) of the above-described (A) to (I), for example, as an establishment condition for the estimation.

By providing a reliability counter in which when an establishment condition for an estimation that predicted slack has reached target slack is determined to be establishment a counter value of the reliability counter is increased/decreased, and when the establishment condition for estimation is determined to be non-establishment the counter value is decreased/increased, and updating the predicted slack such that the predicted slack is increased on the condition that the counter value of the reliability counter is an increase determination value and the predicted slack is decreased on the condition that the counter value of the reliability counter is a decrease determination value, the increase in the frequency of occurrence of prediction miss penalty caused when the target slack frequently repeats increase and decrease can be favorably suppressed. In order to more effectively suppress the increase in the frequency of occurrence of prediction miss penalty in such a state, it is desirable to set the amount of increase/decrease in counter value upon establishment of an establishment condition for estimation in the reliability counter to a value larger than that of the amount of decrease/increase in the counter value upon non-establishment of the establishment condition for estimation.

Furthermore, in order to more accurately predict local slack by coping with a difference in the aspect of a dynamic change in local slack by instruction types, it is desirable that the amount of update (the amount of increase or the amount of decrease) of predicted slack of each instruction at a time by the update means be made different according to the instruction type. When an upper limit value is set to the predicted slack of each instruction to be updated by the update means, it is also effective to make the upper limit value different according to the instruction type. Furthermore, when a reliability counter is provided, it is effective to make the amounts of increase and decrease in counter value different according to the instruction type. For reference, it can be considered that instruction types are classified into four categories of load instructions, store instructions, branch instructions, and other instructions.

Providing a branch history register that keeps a branch history of a program and individually storing predicted slack of an instruction in a slack table, for different branch patterns which are obtained by referring to the branch history register are also effective to improve prediction accuracy.

According to the local slack prediction method and prediction mechanism according to the present preferred embodiment, a predicted value of local slack (predicted slack) of an instruction is not directly determined by calculation but is determined by gradually increasing the predicted slack until the predicted slack reaches an appropriate value, while behavior exhibited upon execution of the instruction is observed. Therefore, a complex mechanism required to directly compute predicted slack is not required, making it possible to predict local slack with a simpler configuration.

### Second Preferred Embodiment

In a second preferred embodiment, a technique for removing memory ambiguity using slack prediction is proposed. The slack is the number of cycles the execution latency of an instruction can be increased without exerting an influence on other instructions. In a proposed mechanism, a store instruction whose slack is larger than or equal to a predetermined threshold value is predicted not to depend on a subsequent load instruction and the load instruction is speculatively executed. By this, even if slack of a store instruction is used, the execution of a subsequent load cannot be delayed.

1 Problems of First Preferred Embodiment and Prior Art

As described above, since there is memory ambiguity between load/store instructions, if slack of a store instruction is used based on prediction, the execution of a subsequent load is delayed, causing a problem of exerting an adverse influence on processor performance. As used herein, the memory ambiguity means that the dependency relationship between load/store instructions is not known until a memory address to access is found out.

Hence, the present preferred embodiment proposes a mechanism for predicting a data dependency relationship between a store instruction and a load instruction using slack and speculatively removing memory ambiguity. In this mechanism, a store instruction whose slack is larger than or equal to a predetermined threshold value is predicted not to depend on a subsequent load instruction and the load instruction is speculatively executed. By this, even if slack of a store instruction is used, the execution of a subsequent load cannot be delayed.

2 Slack

The slack is as described in the prior art and the first preferred embodiment. Local slack differs from global slack and is easy not only to determine but also to use. Thus, in the present preferred embodiment, hereinafter, discussion proceeds using “local slack” as a target. “Local slack” is simply denoted as “slack”.

3 Influence of Memory Ambiguity on use of Slack

In this chapter, a problem will be described that arises due to memory ambiguity when slack of a store instruction is used.

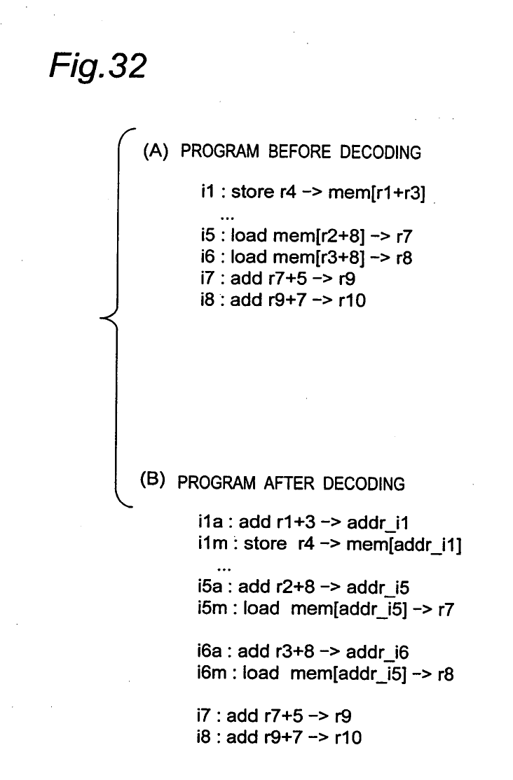

FIG. 32(A) is a diagram for describing a problem that arises in prior art due to memory ambiguity when slack of a store instruction is used, and showing a program before decoding. FIG. 32(B) is a diagram for describing a problem that arises in prior art due to memory ambiguity when slack of a store instruction is used, and showing a program after decoding.

In FIG. 32(A), r1, r2, . . . represent a first register, a second register, . . . A store instruction i1 stores a value of a register r4 at a memory address obtained by adding a value of a register r1 to r3. A load instruction i5 writes a value loaded from a memory address obtained by adding a value of a register r2 to 8, into a register r7. A load instruction i6 writes a value loaded from a memory address obtained by adding a value of a register r3 to 8, into a register r8. An instruction i7 writes a value obtained by adding the value of the register r7 to 5, into a register r9. An instruction i8 writes a value obtained by adding the value of the register r9 to 8, into a register r10.

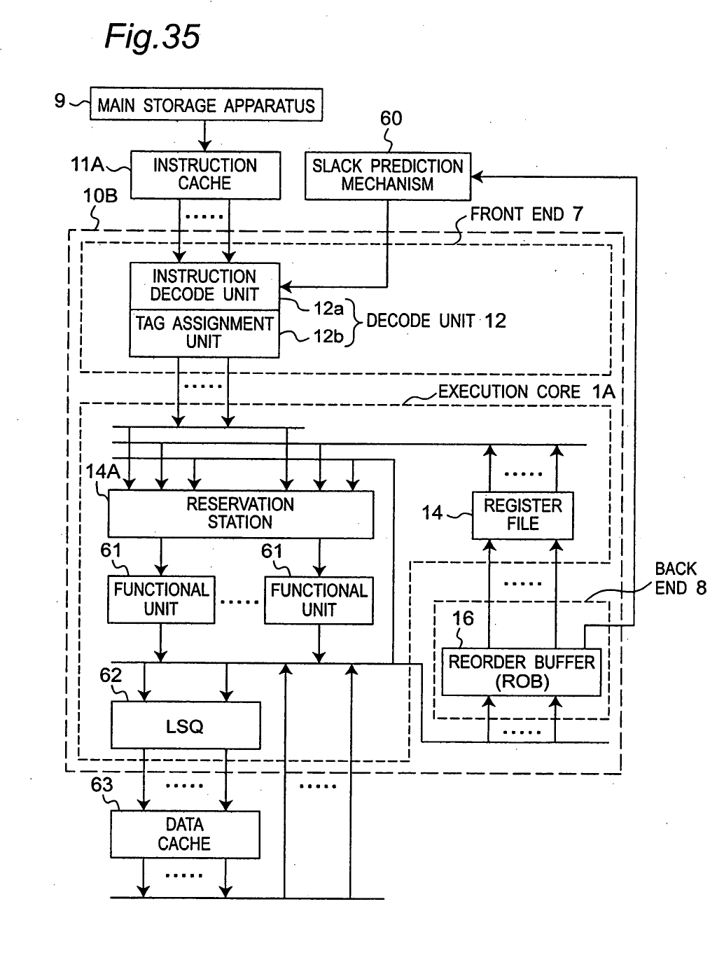

It is assumed that the instruction i5 does not depend on the instruction i1 and the instruction i6 depends on the instruction i1. It is to be noted, however, that within a processor 10B (See FIG. 35), due to memory ambiguity, their dependency relationships are not known until address calculation is done. In addition, the instruction i7 requires the value obtained by the instruction i5 and the instruction i8 requires the value obtained by the instruction i7.

It is assumed that as a scheme for efficiently scheduling load/store instructions a separate load/store scheme is used. In this scheme, a memory instruction is separated into two parts, an address calculation part and a memory access part, and they are scheduled separately. For scheduling, a dedicated buffer memory called a load/store queue (hereinafter, referred to as an “LSQ”) 62 is used. Since address calculation only has register dependence, scheduling is performed using a reservation station 14A. On the other hand, memory access is scheduled to satisfy memory dependence.

A program obtained after the program of FIG. 32(A) is decoded in a processor using the separate load/store scheme is shown in FIG. 32(B). In FIGS. 32(A) and 32(B), a memory instruction is separated into an address calculation instruction (an instruction with “a” added to its name) and a memory access instruction (an instruction with “m” added to its name).

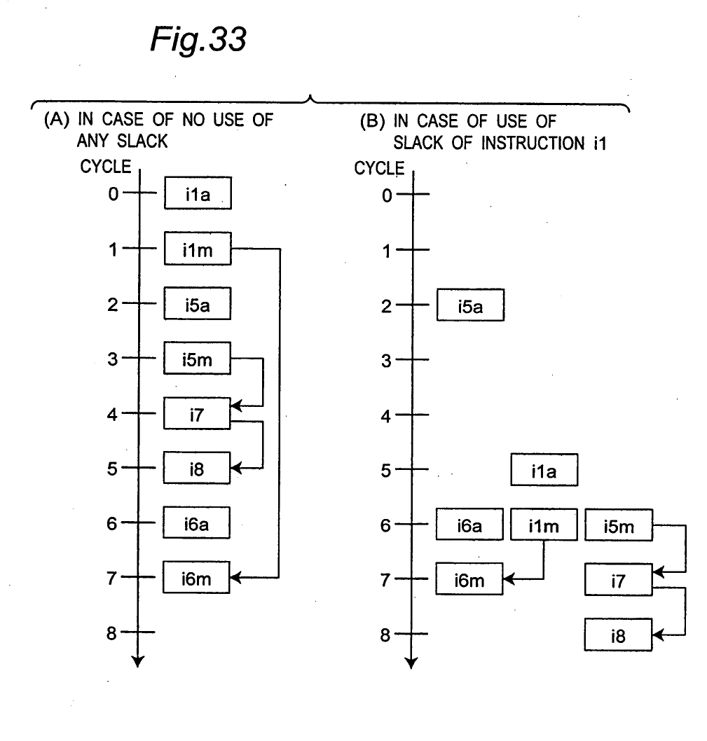

FIG. 33(A) is a diagram used to describe the influence of memory ambiguity on the use of slack in a process by the processor and is a timing chart showing a process of executing a program for the case of no use of any slack. FIG. 33(B) is a diagram used to describe the influence of memory ambiguity on the use of slack in a process by the processor and is a timing chart showing a process of executing a program for the case of use of slack.

Processes of executing the programs shown in FIGS. 32(A) and 32(B) are shown in FIGS. 33(A) and 33(B), respectively. In FIGS. 33(A) and 33(B), the vertical axis represents the number of cycles and a rectangular portion surrounded by a solid line represents an instruction executed in a cycle and the content of the execution.

FIG. 33(A) shows an exemplary case of no use of any slack. In this example, it is assumed that instructions i1a, i5a, i7, i8, and i6a can obtain execution results in the 0th, second, fifth, and sixth cycles, respectively.

Since the address of an instruction i1 is found out in the 0th cycle, memory access by the instruction i1 can be executed in the first cycle. Then, the address of an instruction i5 is found out in the second cycle. At this point, it is found that the instruction i5 does not depend on the instruction i1 which is a preceding store. Thus, the instruction i5 executes memory access in the third cycle. In the fourth cycle, addition is performed using a value loaded by the instruction i5. In the fifth cycle, addition is performed using a value determined by an instruction i7. It is found in the sixth cycle that an instruction i6 depends on the instruction i1 which is a preceding store. At this point, the instruction i1 has completed its execution, and thus, the execution of the instruction i6 depending on the instruction i1 can also be started. In the ninth cycle, store data is forwarded from the instruction i1 to the instruction i6 depending on the instruction i1.

On the other hand, FIG. 33(B) shows the case of use of slack of the instruction i1. In this case, it is assumed that the slack is predicted to be 5 and the execution latency of an instruction i1a is increased by 5 cycles. By using the slack of the instruction i1, in FIG. 33(B), the cycle where an execution result of the instruction i1a is obtained is delayed by 5 cycles relative to the case of FIG. 33(A).

The address of an instruction i5 is found out in the second cycle. At this point, however, the address of the instruction i1 which is a preceding store is not known. Since, though the address of the instruction i5 is found out, it is not sure if the instruction i5 depends on the preceding store, the instruction i5 cannot execute memory access, causing a delay in execution. When the address of the instruction i1 is found out in the fifth cycle, it is finally found that the instruction i5 does not depend on the instruction i1. Thus, in the sixth cycle, the instruction i5 executes memory access. This causes a wasteful delay in execution, exerting an adverse influence on performance.

4 Speculative Removal of Memory Ambiguity using Slack Prediction

In order to lessen the adverse influence of the use of slack of a store instruction on the execution of a load instruction that does not have a dependency relationship with the store instruction, attention is focused on the way of determining slack of a store instruction in a conventional technique. In the conventional technique, slack of a store instruction is determined focusing attention only on a load having a dependency relationship with the store instruction. Therefore, when the slack of a store instruction is n (n>0), it can be seen that after n cycle(s) has/have elapsed since the store instruction is executed, a load instruction depending on the store instruction is executed.

From this fact, it can be considered that when a memory instruction is separated into address calculation and memory access, it is highly possible that store/load instructions having a dependency relationship are executed in the following order. First of all, the address of a store instruction is calculated. Thereafter, memory access by the store instruction is executed. After n−1 cycle(s) has/have elapsed since the memory access is executed, address calculation of a load instruction depending on the store instruction is performed and in a subsequent cycle, memory access is executed.

When a memory instruction is executed in the above-described order, during at least n cycle(s) after a store instruction performs address calculation, a load instruction depending on the store instruction cannot perform address calculation. Therefore, it is found that a load instruction whose address has been found out during such a period of time does not depend on the store instruction even without comparing addresses.

From the above, it can be considered that even if, as a result of increasing the execution latency of a store instruction whose slack is n (>0), address calculation of the store instruction is delayed by n cycle(s), it is highly possible that a load instruction whose address has been found out during such a period of time does not depend on the store instruction.

Hence, the inventors propose a technique for predicting that a load instruction whose address has been found out does not depend on a preceding store instruction whose slack is n (>0) and speculatively removing memory ambiguity related to the store instruction. By this, the adverse influence of the use of slack of a store instruction on the execution of a load instruction that does not have a dependency relationship with the store instruction can be lessened.

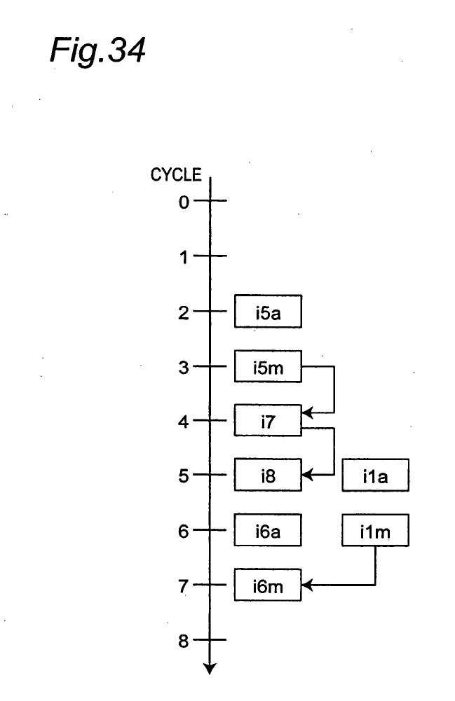

FIG. 34 is a timing chart showing speculative removal of memory ambiguity according to the second preferred embodiment of the present invention. In this case, with reference to FIG. 34, an operation which is a target of the proposed technique will be described. FIG. 34, namely, shows a process performed when the programs shown in FIG. 32 are executed using the proposed technique. In a manner similar to that of FIG. 33(B), the slack of an instruction i1a is predicted to be 5 and the execution latency of the instruction i1a is increased by 5 cycles. Unlike FIG. 33(B), however, memory ambiguity related to the instruction i1 is speculatively removed using slack.

In the second cycle, the address of an instruction i5 is found out. At this point, the address of an instruction i1 which is a preceding store is not known. However, since the instruction i1 has a slack larger than 0, it is predicted that the instruction is does not depend on the instruction i1. Then, in the third cycle, the instruction is speculatively executes memory access. In this manner, the execution of a load instruction that does not have a dependency relationship with a store instruction using slack is prevented from being delayed.

However, since slack is determined by prediction, there is a possibility that prediction of a memory dependency relationship may fail. Since penalty upon failure is large, a prediction needs to be made as careful as possible. Hence, only when the slack of a store instruction is larger than or equal to a given threshold value Vth, a subsequent load instruction is predicted not to depend on the store instruction.

5 Proposed Mechanism

In this chapter, a mechanism for implementing the proposed technique shown in Chapter 4 will be described.

5.1 Summary of Proposed Mechanism

FIG. 35 is a block diagram showing the configuration of the processor 10B having a speculative removal mechanism for memory ambiguity (hereinafter, referred to as the “proposed mechanism”) of FIG. 34. In FIG. 35, an instruction cache 11A and a data cache 63 are shown above and below the processor 10B, respectively. A slack prediction mechanism 60 that predicts slack of a fetched instruction is shown on the right side of a processor 20. The inside of the processor 10B is large and is configured to include a front end 7, an execution core 1A, and a back end 8.

The instruction cache 11A temporarily stores an instruction from a main storage apparatus 9 and thereafter outputs the instruction to a decode unit 12. The decode unit 12 is composed of an instruction decode unit 12a and a tag assignment unit 12b. The decode unit 12 decodes an instruction to be inputted and assigns a tag to the instruction, and thereafter, outputs the instruction to a reservation station 14A in the execution core 1A.

In the execution core 1A, address calculation is scheduled using the reservation station 14A, an address is calculated by a functional unit 61 (corresponding to an execution unit 15), and the address is outputted to an LSQ 62 and an ROB 16 in the back end 8. In addition, in the execution core 1A, a load instruction and/or a store instruction is(are) scheduled using the LSQ 62 and a load request and/or a store request is(are) sent to the data cache 63. An address to be outputted from the ROB 16 upon reordering is inputted to the reservation station 14A via a register file 14.

The proposed mechanism of FIG. 35 is implemented in the LSQ 62 and can be mainly divided into a memory dependence prediction mechanism and a recovery mechanism from a prediction miss. The memory dependence prediction mechanism predicts a memory dependency relationship based on slack and speculatively executes a load instruction. On the other hand, the recovery mechanism checks the success or failure of memory dependence prediction and allows a processor state to be recovered from a state of a memory dependence prediction miss.

In the following, first of all, the memory dependence prediction mechanism will be described and then the recovery mechanism will be described.

5.2 Memory Dependence Prediction Mechanism

The proposed mechanism according to the present preferred embodiment implements the memory dependence prediction mechanism by making a simple modification to the LSQ 62. First of all, the configuration of a modified LSQ 62 will be described.

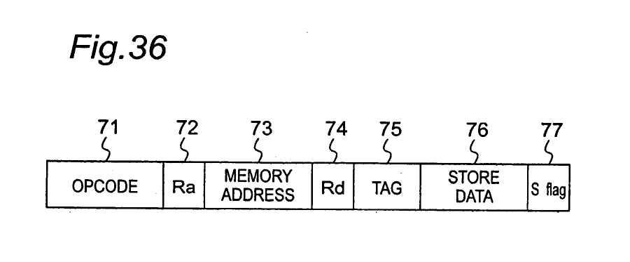

FIG. 36 is a diagram showing a format of modified instruction data to be entered into the load/store queue (LSQ) 62 of FIG. 35. In the instruction data of FIG. 36, in addition to an OP code 71, a memory address 73, a tag 75, and store data 76, three flags 72, 74, and 77 are added. In this case, Ra and Rd respectively represent flags indicating that address and store data can be used. Sflag is a determination flag of predicted slack of a store instruction which is newly added to adopt the proposed mechanism, and is a flag indicating whether the predicted slack of a store instruction is larger than or equal to a threshold value Vth. In the case of a load instruction, the flag Sflag has no meaning. The flag Sflag is set to 1 if the predicted slack of a store instruction is larger than or equal to the threshold value Vth; otherwise, it is reset to 0. The set/reset of the flag Sflag is performed by a functional unit 61 when a store instruction is assigned to the LSQ 62.

Now, the operation of the modified LSQ 62 will be described. In a normal LSQ 62, when the address of a load instruction and the addresses of all preceding store instructions are found out, the load instruction compares the addresses. Then, if it is found that the load instruction does not depend on the preceding store instructions, then the load instruction executes memory access; otherwise, the load instruction obtains data from a dependent store by forwarding.

On the other hand, in the modified LSQ 62, when the address of a load instruction is found out and furthermore preceding store instructions, without exception, satisfy any of the following conditions, the load instruction compares addresses.

(1) An address is known.

(2) Though an address is not known, the flag Sflag is 1.

An address comparison is, however, performed only on store instructions whose addresses are known. A store instruction whose address is not known and whose flag Sflag is 1 is predicted to have no dependency relationship with the load instruction. As a result of the address comparison, if it is found that there are no dependent store instructions, then the load instruction executes memory access; otherwise, the load instruction obtains data from a dependent store by forwarding. If a memory dependency relationship is predicted, the load instruction is speculatively executed.

5.3 Recovery Mechanism

In the proposed mechanism according to the present preferred embodiment, in order to check whether or not prediction of a memory dependency relationship is correct, a store instruction that is possibly a prediction target, i.e., a store instruction whose flag Sflag is 1, checks the success or failure of prediction after an address is found out. Specifically, the address of the store instruction is compared with the addresses of subsequent load instructions whose execution has been completed.

If the addresses are not matched, the memory dependence prediction is successful. A delay, caused by the use of slack of a store instruction, in the execution of a load instruction which does not have a dependency relationship with the store instruction can be prevented. On the other hand, if the addresses are matched, the memory dependence prediction is failed. Load instructions whose addresses match the address of the store instruction and instructions subsequent thereto are flushed from the processor and their execution is redone. Cycles required to redo the execution become prediction miss penalty.

6 Processing Flow of LSQ 62

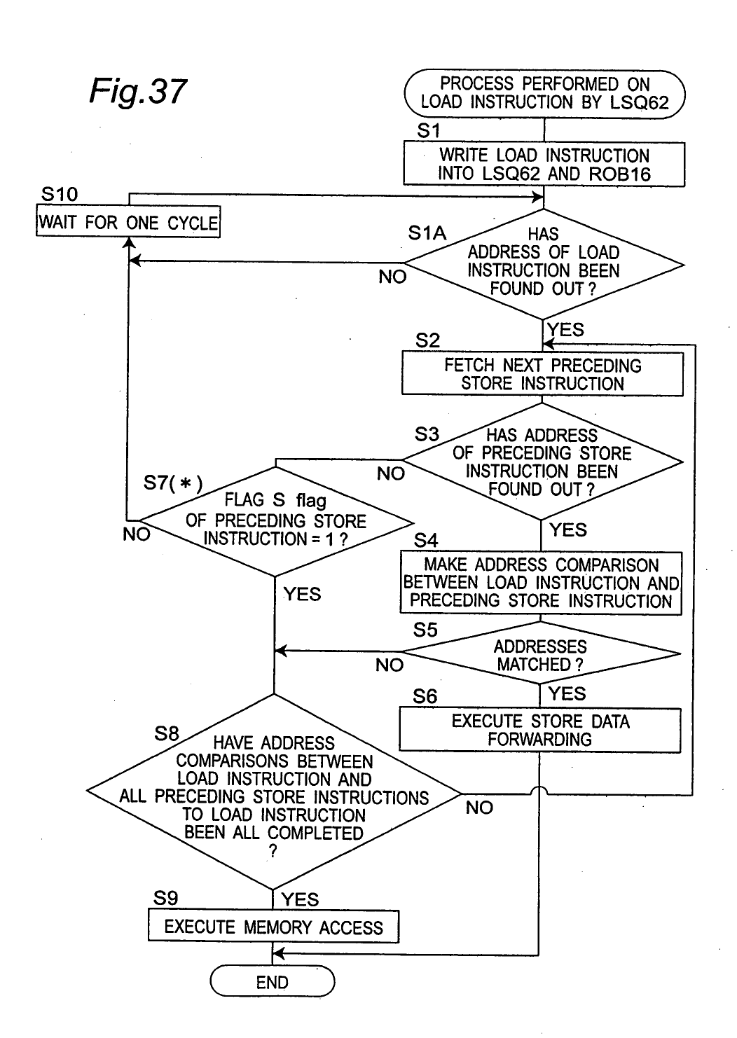

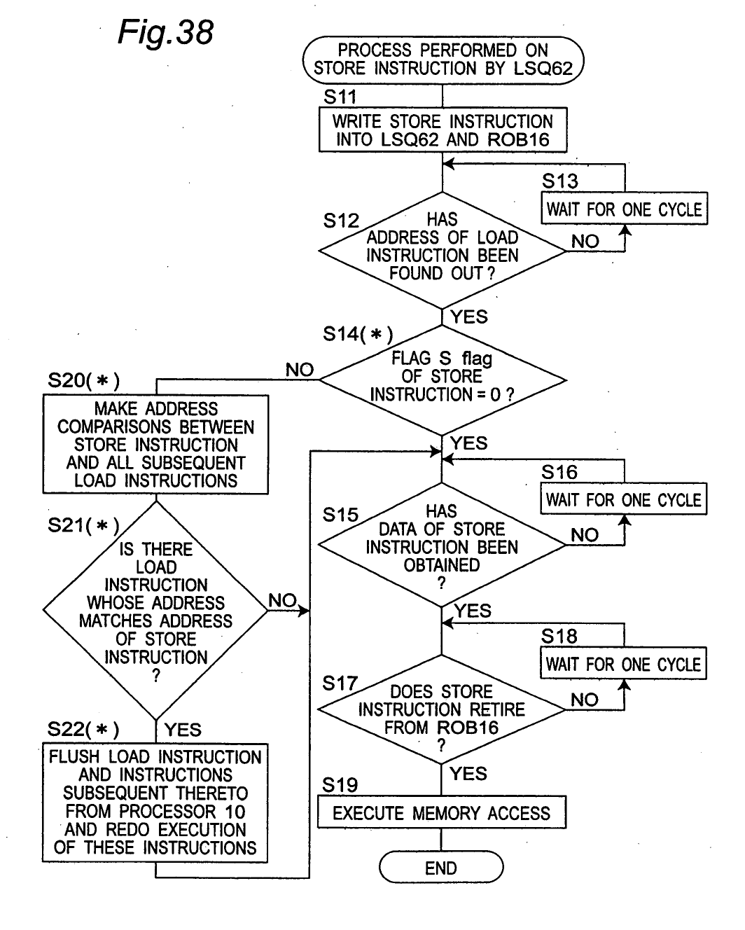

FIG. 37 is a flowchart showing a process by the LSQ 62 of FIG. 35 performed on a load instruction. In FIG. 37, an asterisk (*) is put after a step number that is an additional step from the conventional mechanism; in FIG. 37, a process in step S7 is added. It is noted that although in FIG. 37 for a clear description a portion from step S2 to step S8 has a loop process, normally, this portion is processed in parallel. In addition, it is noted that in FIGS. 37 and 38 an address refers to a memory address of the main storage apparatus 9 at which each instruction is stored.

Referring to FIG. 37, first of all, in step S1, a load instruction is written into the LSQ 62 and the ROB 16. Then, instep S1A, it is determined whether or not the address of the load instruction written into the LSQ 62 has been found out; if YES then the process flow proceeds to step S2, and if NO then the process flow proceeds to step S10. In step S2, a next preceding store instruction is fetched. In step S3, it is determined whether or not the address of the preceding store instruction has been found out; if YES then the process flow proceeds to step S4, and if NO then the process flow proceeds to step S7. In step S4, an address comparison between the load instruction and the preceding store instruction is made. Then, in step S5, it is determined whether or not the addresses are matched; if YES then the process flow proceeds to step S6, and if NO then the process flow proceeds to step S8. In step S6, “store data forwarding” is executed and then the process by the LSQ 62 ends.

In step S7, it is determined whether or not the flag Sflag of the preceding store instruction is 1, i.e., whether or not predicted slack is larger than or equal to the threshold value Vth; if YES then the process flow proceeds to step S8, and if NO then the process flow returns to step S10. In step S10, after waiting for one cycle, the process flow returns to step S1A. In step S8, it is determined whether or not address comparisons between the load instruction and all preceding store instructions have been completed; if NO then the process flow returns to step S2, and if YES then memory access is executed and then the process by the LSQ 62 ends.

The “store data forwarding” in step S6 refers to the following process. When data requested by a load instruction is data of a preceding store instruction for each buffer such as a store queue or the LSQ 62, normally, the store instruction retires, performs a write into the data cache 63, and needs to wait for memory dependence to be eliminated. If necessary store data can be obtained from a buffer, such a wasteful waiting time is eliminated. Providing store data from the buffer before the data is written into the data cache 63 is referred to as “store data forwarding”. This can be implemented as follows. When a matched entry is found as a result of a buffer association search by an execution address, a buffer is modified so as to output corresponding store data.

FIG. 38 is a flowchart showing a process by the LSQ 62 of FIG. 35 performed on a store instruction. In FIG. 38, an asterisk (*) is put after a step number that is an additional step from the conventional mechanism; in FIG. 38, processes in steps S14 and S20 to S22 are added.

In FIG. 38, first of all, in step S11, a store instruction is written into the LSQ 62 and the ROB 16. Thereafter, it is determined in step S12 whether or not the address of the store instruction has been found out; if NO then the process flow returns to step S13, and if YES then the process flow proceeds to step S14. In step S13, after waiting for one cycle, the process flow returns to step S12. In step S14, it is determined whether or not the flag Sflag of the store instruction is 0, i.e., whether the predicted slack of the store instruction is larger than or equal to the threshold value Vth; if YES then the process flow proceeds to step S15, and if NO then the process flow proceeds to step S20. In step S20, address comparisons between the store instruction and all subsequent load instructions are made to determine whether or not there is a load instruction whose address matches the address of the store instruction; if YES then the process flow proceeds to step S22, and if NO then the process flow proceeds to step S15. In step S22, the load instruction and instructions subsequent thereto are flushed from the processor 10 (instruction data is cleared) and execution of these instructions is redone and then the process flow proceeds to step S15.

In step S15, it is determined whether or not data of the store instruction has been obtained; if YES then the process flow proceeds to step S17, and if NO then the process flow proceeds to step S16. In step S16, after waiting for one cycle, the process flow returns to step S15. In step S17, it is determined whether or not the store instruction retires from the ROB 16; if YES then the process flow proceeds to step S19, and if NO then the process flow proceeds to step S18. In step S18, after waiting for one cycle, the process flow returns to step S17. In step S19, memory access is executed and then the process by the LSQ 62 ends.

It is noted that the term “retire” refers to that a process by the back end 8 ends and there are no instructions from the processor 10B.

7 Advantageous Effects of Second Preferred Embodiment

As described above, according to the processor and processing method thereof according to the second preferred embodiment of the present invention, a store instruction having predicted slack larger than or equal to a predetermined threshold value is predicted and determined to have no data dependency relationship with load instructions subsequent to the store instruction, and thus, even if the memory address of the store instruction is not known, the subsequent load instructions are speculatively executed. Therefore, if prediction is correct, a delay due to the use of slack of a store instruction does not occur in execution of load instructions having no data dependency relationship with the store instruction and an adverse influence on the performance of the processor apparatus can be suppressed. In addition, since output results of the slack prediction mechanism are used, there is no need to newly prepare hardware for predicting a dependency relationship between a store instruction and a load instruction. Accordingly, with a simpler configuration over prior art, a local slack prediction can be made and the execution of program instructions can be performed at higher speed.

### Third Preferred Embodiment

In the present preferred embodiment, a technique for sharing local slack based on a dependency relationship is proposed. Local slack is the number of cycles the execution latency of an instruction can be increased without exerting an influence on other instructions. In a proposed mechanism according to the present preferred embodiment, local slack of a particular instruction is shared between instructions having a dependency relationship. By this, instructions that do not have local slack can use slack.

1 Problems of Prior Art and First Preferred Embodiment

As described above, in the techniques according to the prior art and the first preferred embodiment, the number of instructions (the number of slack instructions) whose local slack can be predicted to be 1 or more is small and thus the chance of being able to use slack cannot be sufficiently secured.

Hence, in the present preferred embodiment, a technique for sharing local slack of a particular instruction between a plurality of instructions having a dependency relationship is proposed. In this proposed mechanism, with an instruction having local slack as a starting point, between instructions having no local slack, information indicating that there is sharable slack is propagated from a dependent destination to a dependent source. Then, based on the information, by using a heuristic technique, the amount of slack used by each instruction is determined. By this, instructions that do not have local slack can use slack.

2 Slack

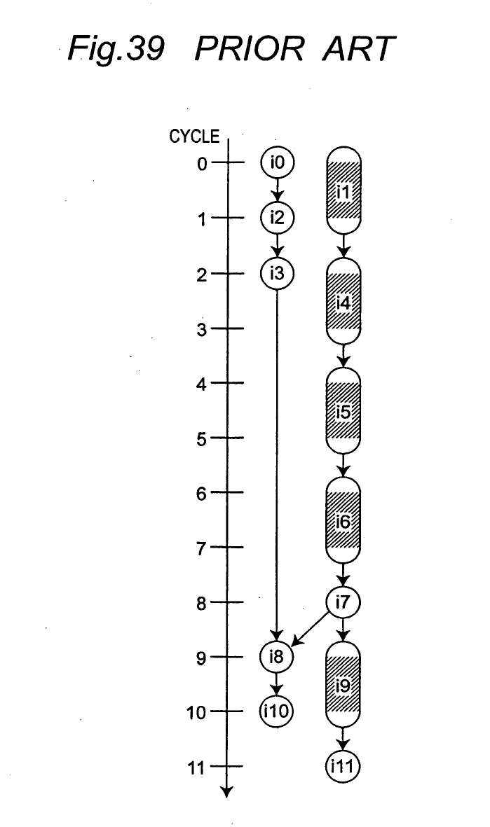

FIG. 39 is a timing chart showing a program used to describe slack according to prior art. In FIG. 39, nodes represent instructions and edges represent data dependency relationships between instructions. The vertical axis in FIG. 39 represents a cycle in which an instruction is executed. The length of a node represents the execution latency (which refers to an execution delay time) of an instruction. Instructions i1, i4, i5, i6, and i9 have an execution latency of 2 cycles and other instructions have an execution latency of 1 cycle.

First of all, the global slack of an instruction i3 will be considered. When the execution latency of the instruction i3 is increased by 7 cycles, the execution of instructions i8 and i10 which directly and indirectly depend on the instruction i3 is delayed. As a result, the instruction i10 is executed at the same time as an instruction i11 which is the last one to be executed in the program. Hence, if the execution latency of the instruction i3 is further increased, the total number of execution cycles of the program increases. That is, the global slack of the instruction i3 is 7. As such, in order to determine the global slack of a particular instruction, there is a need to examine the influence of an increase in the execution latency of the instruction on the execution of the entire program. Thus, determination of global slack is very difficult.

In this case, attention is focused on, in addition to the instruction 3, the global slack of an instruction i0 having an indirect dependency relationship with the instruction i3. In a manner similar to the above, it can be seen that the global slack of the instruction i0 is also 7. Hence, when these instructions increase their execution latency by 7 cycles by using the global slack, the instruction i10 is executed 7 cycles later than the last one to be executed in the program. As such, when a particular instruction uses global slack, there is a possibility that other instructions cannot use global slack. Thus, it can be said that it is also difficult to use global slack.

Next, the local slack of the instruction i3 will be considered.

When the execution of the instruction i3 is increased by 6 cycles, no influence is exerted on the execution of subsequent instructions. However, if the execution latency is further increased, the execution of the instruction i8 that directly depends on the instruction i3 is delayed. That is, the local slack of the instruction i3 is 6. As such, in order to determine the local slack of a particular instruction, attention should be focused on the influence on an instruction that depends on that instruction. Thus, local slack can be relatively easily determined.

In this case, attention is focused on the local slack of the instruction i10 having an indirect dependency relationship with the instruction i3. In a manner similar to the above, it can be seen that the local slack of the instruction i10 is 1. Even when the instruction i3 uses local slack, no influence is exerted on an instruction that directly depends on the instruction i3, and thus, the instruction i10 can use local slack. Unlike global slack, even when a particular instruction uses local slack, regardless of that, other instructions can use local slack.

As described above, unlike global slack, local slack is easy not only to determine but also to use. Hence, in the present preferred embodiment, hereinafter, discussion proceeds using local slack as a target.

3 Conventional Slack Prediction Mechanism

A summary of a conventional mechanism will be described. The details are described in the prior art and the first preferred embodiment. In a mechanism based on a time, local slack is calculated from a difference between the time at which a particular instruction defines data and the time at which the data is referred to by another instruction, and local slack to be used upon subsequent execution is predicted to be the same as the local slack obtained by the calculation. On the other hand, in a mechanism based on a heuristic technique, while behavior exhibited upon execution of an instruction, such as a branch prediction miss or forwarding, is observed, local slack to be predicted (predicted slack) is increased and decreased and the predicted slack is brought to approximate actual local slack (actual slack).

Both techniques achieve the same degree of prediction accuracy but have a problem that the number of slack instructions is small. For example, in the heuristic technique, in a processor issuing four instructions, while the degradation in performance is suppressed to less than 10%, the number of predictable slack instructions is the order of at maximum 30 to 50 percent of all executed instructions. If the number of slack instructions is small, the chance to use slack is limited. Hence, it is important to consider measures to increase the number of slack instructions.

4 Technique for Increasing Number of Slack Instructions

In this chapter, a technique is proposed in which local slack of a particular instruction is used (shared) not only by the instruction but also by other instructions. If, by sharing of slack, instructions that do not have local slack are allowed to use slack, the number of slack instructions can be increased.

First of all, what relationship there is between instructions that share slack will be considered.

If an instruction that does not have local slack increases its execution latency, an influence is exerted on the execution of an instruction that depends on that instruction. As a result, if local slack of a particular instruction is decreased, these instructions can be considered to share slack. From this fact, the inventors consider that instructions that share slack are instructions that have an influence on the execution of an instruction having local slack, i.e., instructions that directly and indirectly supply operands.

For example, in FIG. 39, the instruction i3 is an instruction having local slack. The instructions i0 and i2 are then instructions that directly and indirectly supply operands to the instruction i3. When the execution latency of these instructions is increased, the usable local slack of the instruction i3 decreases. Accordingly, the local slack of the instruction i3 can be shared among the instructions i0, i2, and i3.

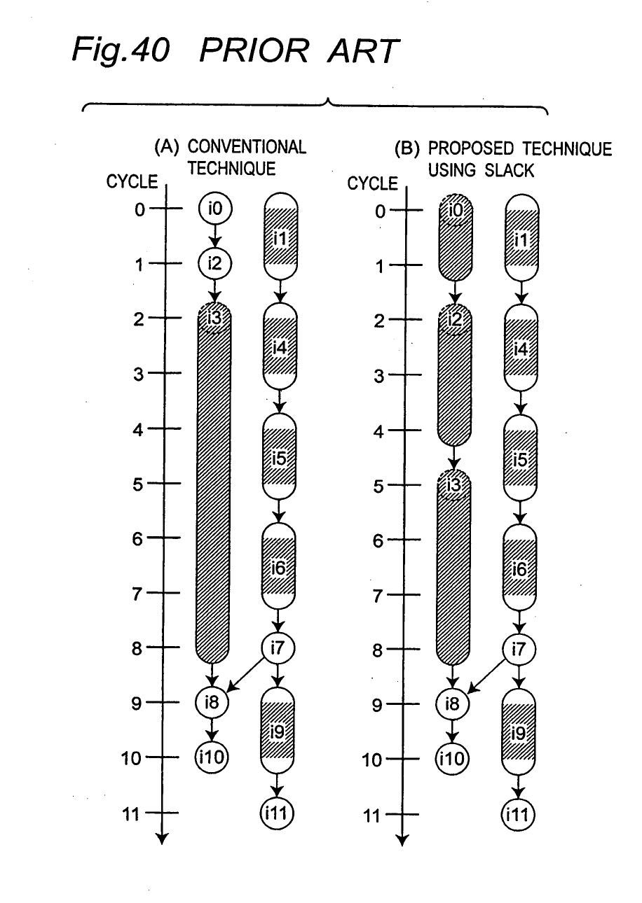

FIG. 40(A) is a timing chart showing a program describing the use of slack according to a technique of prior art, and FIG. 40(B) is a timing chart showing a program describing the use of slack according to a technique for increasing the number of slack instructions, according to the third preferred embodiment of the present invention.

With reference to FIGS. 40(A) and 40(B), the conventional technique and a sharing technique according to the present preferred embodiment will be described. FIGS. 40(A) and 40(B) show the operation for the case in which in the program of FIG. 39 the local slack of the instruction i3 is used. In the conventional technique of FIG. 40(A), the local slack of the instruction i3 is used only by the instruction i3. On the other hand, in the proposed technique of FIG. 40(B), it can be seen that the local slack of the instruction i3 is shared among the instructions i0, i2, and i3. By this, the number of slack instructions increases. It is noted that by sharing, slack per instruction decreases. Therefore, it should be noted that sharing is not suitable for application where large slack is required for each instruction.

Next, a method of determining instructions that share slack will be considered.

For a technique for implementing sharing, a method is considered in which a Data Flow Graph (DFG) showing a dependency relationship between instructions is used. If a data flow graph is known, instructions that directly and indirectly supply operands to local slack of a particular instruction, i.e., instructions that perform sharing, can be determined. Thereafter, a slack distribution method, such as equally dividing slack among these instructions, may be determined according to the situation. However, since dependency relationships between instructions are complex and furthermore the relationships dynamically change by a branch, creation of a data flow graph is considered to be not easy.

Hence, an inventors' approach is such that information (shared information) indicating that there is sharable slack is propagated with an instruction having local slack as a starting point, such that a dependency relationship is traced backward from a dependent destination to a dependent source. For example, in FIG. 39, shared information is propagated from the instruction i3 having local slack to the instruction i2 and then propagated from the instruction i2 to the instruction i0. Since each instruction just needs to propagate shared information to an instruction which does not have slack and on which the instruction directly depends, implementation of sharing is much easier than that by the method of creating a data flow graph.

Furthermore, since local slack dynamically changes, the propagation speed of shared information is allowed to change. Specifically, when the predicted slack of an instruction is larger than or equal to a given threshold value (threshold value for propagation), the instruction propagates shared information. Hereinafter, the threshold value for propagation is referred to as a “propagation threshold value Pth”.

Finally, a slack prediction method will be considered. Prediction has two types: local slack prediction and slack prediction to be used by an instruction that receives shared information.

Local slack dynamically changes. When sharing is performed, slack per instruction decreases and thus a dynamic change in local slack becomes more complex. In order to cope with this change, as a local slack prediction technique, the heuristic local slack prediction (See the first preferred embodiment) that can control the steep and mild increase and decrease of predicted slack is used.

Sharable slack dynamically changes. In addition, an instruction having received shared information only knows that slack can be shared. This is very similar to a situation where in heuristic local slack prediction, slack to be predicted dynamically changes and each instruction only knows whether or not the predicted slack reaches actual slack. Hence, slack is heuristically predicted also for an instruction having received shared information.

Specifically, the following is performed. First of all, a reliability counter is adopted for each predicted slack. If shared information is received upon execution, then it is determined that predicted slack has not yet reached usable slack and thus a reliability counter is increased. If not so, then it is determined that the predicted slack has reached usable slack and thus the reliability counter is decreased. Then, when a counter value becomes 0 the predicted slack is decreased, and when the counter value becomes larger than or equal to a given threshold value the predicted slack is increased.

5 Proposed Mechanism

In this chapter, a mechanism for implementing the proposed technique shown in the previous chapter will be described. First of all, a summary of a proposed mechanism will be described. Then, each component of the proposed mechanism will be described. Finally, the overall operation will be described in detail.

5.1 Configuration of Proposed Mechanism

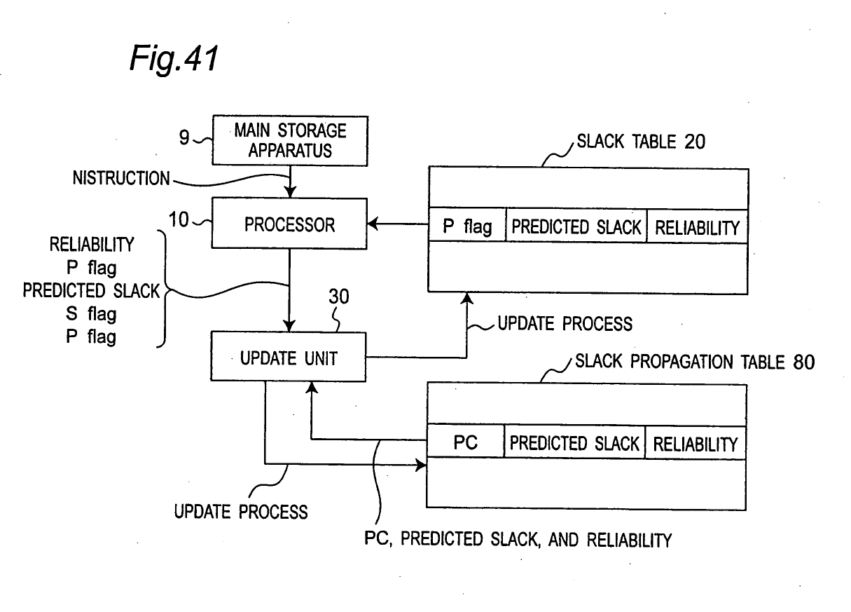

FIG. 41 is a block diagram showing the configuration of the proposed mechanism which is a processor 10 having a slack propagation table 80 and the like, according to the third preferred embodiment of the present invention. Although the inside of the processor 10 and an update unit 30 is omitted because it is not related to the description of this section, the detailed configuration of the processor 10 is shown in FIG. 6 or 35 and the detailed configuration of the update unit 30 is shown in FIG. 19 or 46. In this case, the proposed mechanism further includes the following three components, in addition to the processor 10:

(1) a slack table 20A;

(2) a slack propagation table 80; and

(3) an update unit 30.

The slack table 20A is stored in a storage apparatus, such as hard disk memory, and holds, for each instruction, a propagation flag Pflag, predicted slack, and reliability. When the processor 10 fetches an instruction from a main storage apparatus 9, the processor 10 refers to the slack table 20A upon fetching and uses predicted slack obtained from the slack table 20A as its own predicted slack. The propagation flag Pflag indicates the content of local slack prediction. When the propagation flag Pflag is 0, it indicates that a conventional local slack prediction is made. When the propagation flag Pflag is 1, it indicates that a slack prediction based on shared information is made. Since shared information can be propagated only after local slack is predicted, the initial value of the propagation flag Pflag is set to 0.

The slack propagation table 80 is used to propagate shared information held by each instruction to an instruction which does not have local slack and on which the instruction directly depends. The slack propagation table 80 uses a destination register number of an instruction as an index. Each entry has, for each instruction, a program counter value (PC), predicted slack, and reliability of an instruction that does not have local slack. In addition, the update unit 30 is used to calculate predicted slack and reliability of a committed instruction based on behavior exhibited upon execution of the instruction or shared information. A value calculated by the update unit 30 is written into the slack table 20A.

5.2 Details of Components

When the processor 10 fetches an instruction, the processor 10 refers to the slack table 20A upon fetching and obtains its predicted slack from the slack table 20A. Then, upon committing an instruction, a propagation flag Pflag, reliability, predicted slack, and behavior exhibited upon execution are transmitted to the update unit 30. When the propagation flag Pflag of the instruction is 0, reliability and predicted slack are calculated based on the heuristic local slack prediction technique and then the slack table 20A is updated. At this time, the propagation flag Pflag is not changed.

Then, by using local slack obtained by calculation, update/reference are performed on the slack propagation table 80. In this case, when the propagation flag Pflag is 0 and the predicted slack is 1 or more, the instruction has local slack. On the one hand, even when the propagation flag Pflag is 0 and the predicted slack is 0, if the reliability is 1 or more, there is a possibility that the instruction may have local slack upon subsequent execution. Hence, in these cases, an entry of the slack propagation table 80 corresponding to a destination register is cleared. On the other hand, when none of the above applies, it can be said that the instruction does not have local slack and there is no possibility that the instruction will have local slack upon subsequent execution. Hence, in this case, the program counter value (PC), predicted slack, and reliability of the instruction are written into an entry of the slack propagation table 80 corresponding to a destination register.

When the instruction has local slack or when the instruction becomes able to use slack by sharing, the slack is compared with the propagation threshold value Pth. When the slack is less than the propagation threshold value Pth, the slack propagation table 80 is referred to with a source register number. It is found that an instruction obtained as a result of the reference does not receive shared information. Hence, based on this information, slack of the instruction is predicted and a referred entry is cleared. When the slack is larger than or equal to the propagation threshold value Pth, it is found that an instruction corresponding to a source register number receives shared information from the instruction. However, there is a possibility that shared information cannot be received from an instruction subsequent to the instruction. Therefore, at this point, nothing is performed. Thereafter, it is found that when an instruction that re-defines a corresponding entry is committed, the instruction of the entry receives shared information from all dependent instructions. Thus, based on this information, slack of the instruction is predicted.

Finally, slack prediction based on shared information will be described. In slack prediction based on shared information, based on information indicating whether or not shared information is received, reliability and predicted slack are calculated and the slack table 20A is updated. Basically, calculation of update data is performed using the same idea as the heuristic local slack prediction technique; however, the slack prediction based on shared information is different from the heuristic local slack prediction technique in that a slack prediction is made based not on the target slack reach condition but on shared information.

Parameters related to an update to the slack table and contents of the parameters are shown below. It is noted that the minimum value Vmin_s of predicted slack=0 and the minimum value Cmin_s of reliability=0.

(1) Vmax_s: the maximum value of predicted slack;

(2) Vmin_s: the minimum value (=0) of predicted slack;

(3) Vinc_s: the amount of increase in predicted slack at a time;

(4) Vdec_s: the amount of decrease in predicted slack at a time;

(5) Cmin_s: the minimum value (=0) of reliability;

(6) Cth_s: a threshold value of reliability;

(7) Cinc_s: the amount of increase in reliability at a time; and

(8) Cdec_s: the amount of decrease in reliability at a time.

The types and contents of the parameters are the same as those for local slack prediction. It should be noted, however, that propagation of shared information takes time and thus a value that a parameter should take is not always the same.

The flow of an update to the slack table will be described using the above-described parameters. When an instruction receives shared information, the reliability is increased by an amount of increase Cinc_s; otherwise, the reliability is decreased by an amount of decrease Cdec_s. When the reliability is larger than or equal to a threshold value Cth_s, the predicted slack is increased by an amount of increase Vinc_s and the reliability is reset to 0. On the other hand, when the reliability is 0, the predicted slack is decreased by an amount of decrease Vdec_s.

When, by the above-described operation, the predicted slack of an instruction whose propagation flag Pflag is 0 becomes 1 or more, it means that the use of slack is enabled by sharing and thus the propagation flag Pflag is set to 1. In contrast, when the predicted slack of an instruction whose propagation flag Pflag is 1 becomes 0, it means that sharing of slack is disabled and thus the propagation flag Pflag is set to 0.

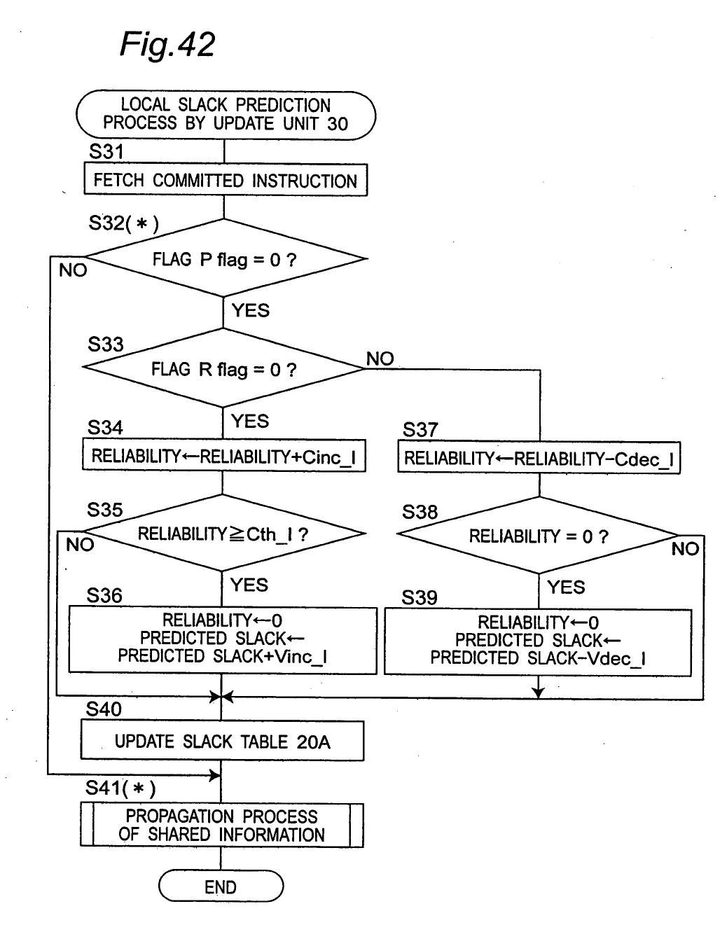

FIG. 42 is a flowchart showing a local slack prediction process performed by the update unit 30 of FIG. 41. It is noted that steps S32 and S41 are new processes and thus an asterisk (*) is put after their step numbers. In this case, the numerical ranges of predicted slack and reliability are such that 0≦reliability≦Cth_1 and 0≦predicted slack≦Vmax_1. A reach condition flag Rflag is a flag used in the first preferred embodiment. The reach condition flag Rflag is 1 when the target slack reach condition is established; otherwise, it is 0. A determination flag Sflag is a determination flag of predicted slack of a store instruction which is newly added in the second preferred embodiment. The determination flag Sflag is a flag indicating whether the predicted slack of a store instruction is larger than or equal to a threshold value Vth. In this case, in the case of a load instruction, the flag Sflag has no meaning. The flag Sflag is set to 1 if the predicted slack of a store instruction is larger than or equal to the threshold value Vth; otherwise, it is reset to 0. The set/reset of the flag Sflag is performed by a functional unit 61 when a store instruction is assigned to the LSQ 62.

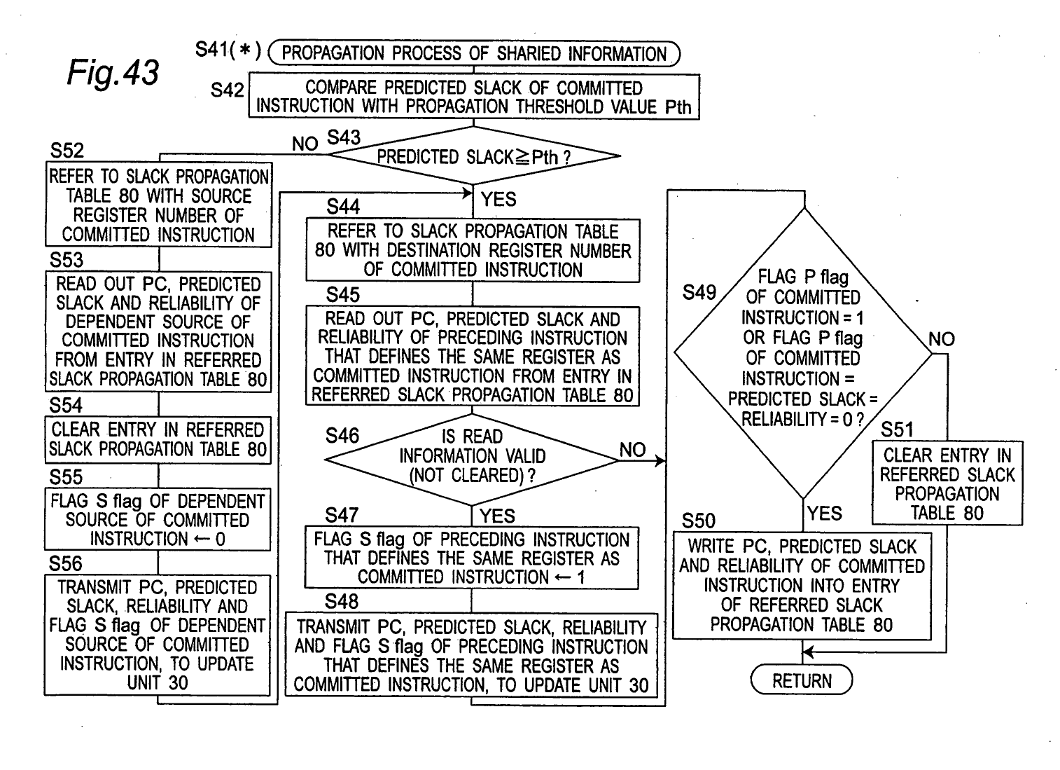

In FIG. 42, first of all, in step S31, a committed instruction is fetched. In step S32, it is determined whether or not the propagation flag Pflag=0; if YES then the process flow proceeds to step S33, and if NO then the process flow proceeds to step S41. In step S33, it is determined whether or not the reach condition flag Rflag=0; if YES then the process flow proceeds to step S34, and if NO then the process flow proceeds to step S37. In step S34, an amount of increase Cinc_1 is added to the value of reliability and a result of the addition is inserted as the value of reliability. In step S35, it is determined whether or not reliability≧Cth_1; if YES then the process flow proceeds to step S36, and if NO then the process flow proceeds to step S40. In step S36, the value of reliability is reset to 0, an amount of increase Vinc_1 is added to the value of predicted slack, and a result of the addition is inserted as the value of predicted slack, and then, the process flow proceeds to step S40. On the other hand, in step S37, an amount of decrease Cdec_1 is subtracted from the value of reliability and a result of the subtraction is inserted as the value of reliability. Thereafter, in step S38, it is determined whether or not reliability=0; if YES then the process flow proceeds to step S39, and if NO then the process flow proceeds to step S40. In step S39, the value of reliability is reset to 0, an amount of decrease Vdec_1 is subtracted from the value of predicted slack, and a result of the subtraction is inserted as the value of predicted slack, and then, the process flow proceeds to step S40. In step S40 the slack table is updated based on the above-described computation result, and in step S41 a propagation process of shared information in FIG. 43 is performed, and then, the local slack prediction process ends.

FIG. 43 is a flowchart showing a subroutine of the flowchart of FIG. 42 and showing the propagation process of shared information (S41).

In step S42, the predicted slack of the committed instruction is compared with the propagation threshold value Pth. In step S43, it is determined whether or not the predicted slack≧Pth; if YES then the process flow proceeds to step S44, and if NO then the process flow proceeds to step S52. In step S44, the slack propagation table 80 is referred to with a destination register number of the committed instruction. In step S45, a program counter value (PC), predicted slack, and reliability of a preceding instruction that defines the same register as the committed instruction are read out from a referred entry of the slack propagation table 80. In step S46, it is determined whether or not the read information is valid (not cleared). If YES in step S46 then the process flow proceeds to step S47, and if NO then the process flow proceeds to step S49. In step S47, the flag Sflag of the preceding instruction that defines the same register as the committed instruction is set to 1. In step S48, the program counter value (PC), predicted slack, reliability, and flag Sflag of the preceding instruction that defines the same register as the committed instruction are transmitted to the update unit 30 and the process flow proceeds to step S49.

On the other hand, in step S52, the slack propagation table 80 is referred to with a source register number of the committed instruction. In step S53, a program counter value (PC), predicted slack, and reliability of a dependent source of the committed instruction are read out from a referred entry of the slack propagation table 80. Subsequently, in step S54, the referred entry of the slack propagation table 80 is cleared. In step S55, the flag Sflag of the dependent source of the committed instruction is reset to 0. Thereafter, in step S56, the program counter value (PC), predicted slack, reliability, and flag Sflag of the dependent source of the committed instruction are transmitted to the update unit 30 and the process flow proceeds to step S44.

Furthermore, in step S49, it is determined whether the propagation flag Pflag of the committed instruction=1 or the propagation flag Pflag of the committed instruction=predicted slack=reliability=0; if YES then the process flow proceeds to step S50, and if NO then the process flow proceeds to step S51. In step S50, the PC, predicted slack, and reliability of the committed instruction are written into the referred entry of the slack propagation table 80 and the process flow returns to the original main routine. On the other hand, in step S51, the referred entry of the slack propagation table 80 is cleared and the process flow returns to the original main routine.

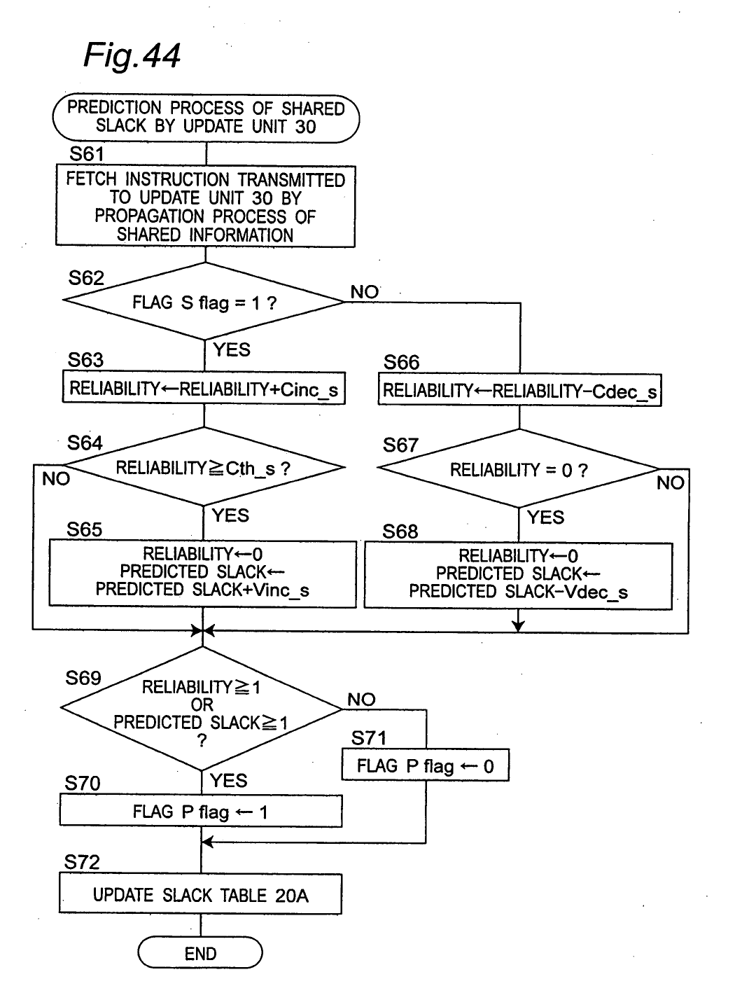

FIG. 44 is a flowchart showing a new control flow and showing a prediction process of shared slack to be performed by the update unit 30 of FIG. 41. In this case, the numerical ranges of predicted slack and reliability are such that 0≦reliability≦Cth_s and 0≦predicted slack≦Vmax_s.

In step S61, first of all, an instruction transmitted to the update unit 30 by a propagation process of shared information is fetched. In step S62, it is determined whether or not the flag Sflag=1; if YES then the process flow proceeds to step S63, and if NO then the process flow proceeds to step S66. In step S63, an amount of increase Cinc_s is added to the value of reliability and a result of the addition is inserted as the value of reliability. In step S64, it is determined whether or not the reliability≧Cth_s (threshold value); if YES then the process flow proceeds to step S65, and if NO then the process flow proceeds to step S69. In step S65, the value of reliability is reset to 0, an amount of increase Vinc_s is added to the value of predicted slack, and a result of the addition is inserted as the value of predicted slack, and then, the process flow proceeds to step S69. On the other hand, in step S66, an amount of decrease Cdec_s is subtracted from the value of reliability and a result of the subtraction is inserted as the value of reliability. In step S67, it is determined whether or not the reliability=0; if YES then the process flow proceeds to step S68, and if NO then the process flow proceeds to step S69. In step S68, the value of reliability is reset to 0, an amount of decrease Vdec_s is subtracted from the value of predicted slack, and a result of the subtraction is inserted as the value of predicted slack, and then, the process flow proceeds to step S69. In step S69, it is determined whether or not the reliability≧1 or the predicted slack≧1; if YES then the process flow proceeds to step S70, and if NO then the process flow proceeds to step S71. In step S70, the propagation flag Pflag is set to 1 and the process flow proceeds to step S72. On the other hand, in step S71, the propagation flag Pflag is reset to 0 and the process flow proceeds to step S72. In step S72, the slack table 20A is updated based on the above-described computation result and the prediction process of shared slack ends.

As described above, according to the third preferred embodiment, by using a second prediction method which is a slack prediction method based on shared information, based on an instruction having local slack, shared information indicating that there is sharable slack is propagated from a dependent destination to a dependent source between instructions that do not have local slack and the amount of local slack used by each instruction is determined based on the shared information and using a predetermined heuristic technique, and this leads to that control is performed to enable the instructions that do not have local slack to use local slack. Accordingly, it becomes possible for instructions that do not have local slack to use local slack, and thus, with a simpler configuration over prior art, a local slack prediction is made by effectively and sufficiently using local slack and the execution of program instructions can be performed at higher speed.

### Fourth Preferred Embodiment

In the present preferred embodiment, a technique for improving prediction accuracy by focusing attention on the distribution of slack is proposed. A mechanism for predicting local slack using a heuristic technique is proposed. Local slack is the number of cycles which the execution latency of an instruction can be increased without exerting an influence on other instructions. The proposed mechanism according to the present preferred embodiment is characterized in that while behavior exhibited upon execution of an instruction, such as a branch prediction miss or operand forwarding, is observed, local slack to be predicted is increased and decreased and the local slack is brought to approximate actual local slack.

1 Problems of Prior Art and First Preferred Embodiment

Actual local slack (actual slack) dynamically changes. Thus, a technique for coping with this change is proposed (See Non-Patent Document 6 and the first preferred embodiment, for example). However, there is a possibility that the change in actual slack cannot be sufficiently followed, causing a degradation in performance. In order to prevent this, a technique for making the increase in predicted slack mild is proposed (See the first preferred embodiment); however, there is a problem that the number of instructions (the number of slack instructions) whose slack can be predicted to be 1 or more decreases.

Hence, in the present preferred embodiment, a technique for improving prediction accuracy by focusing attention on the distribution of slack is proposed. In this technique, a modification is made to a conventional mechanism so that parameters used to update slack can be changed according to a value of slack. By doing so, a degradation in performance can be suppressed while the number of slack instructions is maintained.

2 Slack

The slack is described in detail in the prior art and the first preferred embodiment. As described in the first preferred embodiment, unlike global slack, local slack is easy not only to determine but also to use. Hence, in the present preferred embodiment, hereinafter, discussion proceeds using “local slack” as a target. In addition, “local slack” is simply denoted as “slack”.

3 Slack Prediction Mechanism According to First Preferred Embodiment

A summary and a problem of the slack prediction mechanism (hereinafter, referred to as the “comparable example mechanism”) according to the first preferred embodiment will be described. The comparable example mechanism is described in detail in the first preferred embodiment.

In a mechanism based on a time, slack is calculated from a difference between the time at which a particular instruction defines data and the time at which the data is referred to by another instruction, and slack to be used upon subsequent execution is predicted to be the same as the slack obtained by the calculation. On the other hand, in a mechanism based on a heuristic technique, while behavior exhibited upon execution of an instruction, such as a branch prediction miss or forwarding, is observed, predicted slack is increased and decreased and the predicted slack is brought to approximate actual slack. Both techniques achieve the same degree of prediction accuracy.

In a conventional technique, slack to be used upon subsequent execution is predicted based on slack obtained in the past. When actual slack dynamically changes and drops below predicted slack, an adverse influence is exerted on performance. Therefore, in the conventional technique, some mechanisms for coping with the change in actual slack are provided. However, when the actual slack rapidly repeats increase and decrease, such a change cannot be sufficiently followed. Hence, in the mechanism based on a heuristic technique, an increase of predicted slack is performed carefully and a decrease of predicted slack is performed rapidly so that the predicted slack does not exceed actual slack as much as possible (See the first preferred embodiment).

However, if the increase of predicted slack is made mild to prevent a degradation in performance, there is a problem that the number of instructions (the number of slack instructions) whose slack can be predicted to be 1 or more decreases. The decrease in the number of slack instructions means a decrease in the chance of using slack. Therefore, it is important to create a mechanism for preventing a degradation in performance while maintaining the number of slack instructions.

4 Technique for Improving Slack Prediction Accuracy

There is bias in distribution of slack. Specifically, the distribution of slack has characteristics in that 0 has the largest distribution and the distribution rapidly decreases for values subsequent thereto. The inventors consider that by controlling, based on such properties, the steep and mild increase and decrease of predicted slack, the degradation in performance can be suppressed while the number of slack instructions is maintained as much as possible. In this chapter, first of all, distribution of slack is described and then a slack prediction method using the distribution is proposed.

4.1 Distribution of Slack

In order to examine the distribution of slack, the inventors run the publicly-known SPECint20 benchmark on a processor simulator and calculate slack from a difference between the time at which a particular instruction defines data and the time at which the data is referred to by another instruction. In the following, first of all, the details of an examination environment are provided and then results of examinations are described.

4.1.1 Measurement Environment

An environment used to examine the distribution of slack will be described. As a simulator, a superscalar processor simulator of the publicly-known SimpleScalar Tool is used. For an instruction set, SimpleScalar/PISA which is extended from the publicly-known MIPSR10 is used. Eight benchmark programs, bzip2, gcc, gzip, mcf, parser, per1bmk, vortex, and vpr in the publicly-known SPECint2000 are used. In the gcc program 1 G instructions are skipped and in other programs 2 G instructions are skipped and then 10M instructions are executed. Measurement conditions are shown in Table 7.

TABLE 7
Measurement Conditions

| | |
|---|---|
| Fetch Width | 4 instructions |
| Issue Width | 4 instructions |
| Instruction Window | 32 entries |
| ROB | 64 entries |
| Number of Functional | iALU4, iMULT/DIV 2, fpALU 3, |
| Units | fpMULT/DIV/SQRT 2 |
| instruction Cache | 8 KB, 2-way, 32 B line, |
| Data Cache | 4 ports, 6 cycle miss penalty |
| Secondary Cache | 32 KB, 2-way, 32 B line, |
| | 2 ports, 6 cycle miss penalty |
| | 2 MB, 4-way, 64 B line, |
| | 36 cycle miss penalty |
| Store Set | 8K entry SSIT, 4K entry LFST |
| Branch Prediction | 2048-entry BTB, 4-way, |
| Mechanism | gshare with 6-bit history and 8K-entry PHT, |
| | 16-entry RAS (Return Address Stack), |
| | 5 cycle branch prediction miss penalty |

4.1.2 Examination Results

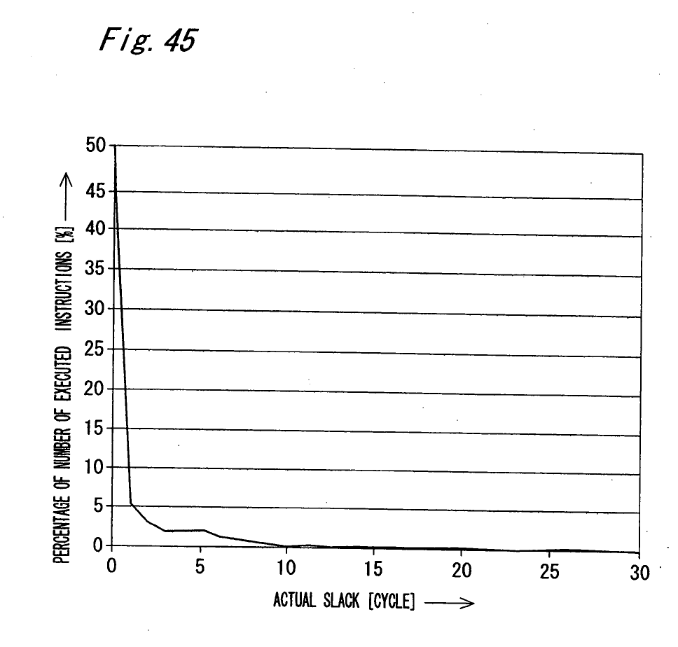

FIG. 45 is a graph showing a percentage of the number of executed instructions relative to actual slack, according to examination results by the inventors. In FIG. 45, the examination results are shown by a benchmark average. The vertical axis in FIG. 45 represents the percentage of all executed instructions and the horizontal axis represents slack. It can be seen from FIG. 45 that instructions whose slack is 0 have the highest percentage and the percentage of instructions rapidly decreases with the increase in slack.

4.2 Technique for Improving Prediction Accuracy using Distribution of Slack

From the examination results, it can be considered that if it is assumed that the value changes randomly, the smaller the value of predicted slack the higher the success rate of slack prediction. That is, it can be considered that the prediction success rate is highest when the predicted slack is 0 and the larger the value of predicted slack the lower the prediction success rate.

Hence, a modification is made to the conventional mechanism based on a heuristic technique so that a predicted slack update method can be changed according to the value of slack. For example, when the predicted slack is increased from 0 to 1 the predicted slack is changed rapidly, and when the predicted slack is increased from a value of 1 or higher the predicted slack is changed carefully. By this, a predicted slack update method can be determined taking into account the probability of success, making it possible to implement both the maintenance of the number of slack instructions and the suppression of a degradation in performance. In addition, a predicted slack update method can be changed only by changing an update parameter according to a slack value, and thus, implementation is easy. For the point at which an update parameter is changed, multiple points can be set; however, the larger the number of points, the more complicated the hardware becomes, and thus, taking it into account, the point needs to be set.

5 Configuration of Proposed Mechanism

FIG. 46 is a block diagram showing the configuration of the processor 10 having the update unit 30 according to the first preferred embodiment. FIG. 46 shows an overview of FIG. 19.

In FIG. 46, the update unit 30 includes two adders 40 and 50, three multiplexers 91, 92, and 110, and four comparators 93, 94, 111, and 112. In this case, parameters to be inputted to the multiplexers 91, 92, and 110 and the comparators 94 and 112 are the same as those described in the first preferred embodiment. Reliability to be outputted from the processor 10 is inputted to a first input terminal of the adder 40 and a reach condition flag Rflag to be outputted from the processor 10 is inputted as a switch control signal of the multiplexer 91. When the reach condition flag Rflag=0, the multiplexer 91 selects an amount of increase Cinc and outputs the amount of increase Cinc to a second input terminal of the adder 40. On the other hand, when the reach condition flag Rflag=1, the multiplexer 91 selects −Cdec which is obtained by adding a minus to an amount of decrease Cdec and outputs −Cdec to the second input terminal of the adder 40. The adder 40 adds two data values to be inputted thereto and outputs a data value of a result of the addition to the slack table 20 as an update value of reliability and outputs the data value to the comparators 93 and 94. Furthermore, predicted slack from the processor 10 is inputted to a second input terminal of the adder 50.

The comparator 93 compares the data value to be inputted thereto with 0 and when the data value is 0 or less, the comparator 93 outputs a data value of 1 to a second control signal input terminal of the multiplexer 92. On the other hand, when the data value is 1 or more, the comparator 93 outputs a data value of 0 to the second control signal input terminal of the multiplexer 92. The comparator 94 compares the data value to be inputted thereto with a threshold value Cth and when the inputted data value≧Cth, the comparator 94 outputs a data value of 1 to a first control signal input terminal of the multiplexer 92. On the other hand, when the inputted data value<Cth, the comparator 94 outputs a data value of 0 to the first control signal input terminal of the multiplexer 92. In this case, control signals to be inputted to the control signal input terminals, respectively, of the multiplexer 92 are represented by CS91 (A, B) and A represents an input value to the first control signal input terminal and B represents an input value to the second control signal input terminal. Control signals to be inputted to control signal input terminals, respectively, of the multiplexer 110 are similarly represented by CS110 (A, B). In the case of a control signal CS92 (0, 0), the multiplexer 92 selects a data value of 0 and outputs the data value of 0 to a first input terminal of the adder 50. In the case of a control signal CS92 (0, 1), the multiplexer 92 selects a data value of −Vdec obtained by adding a minus to an amount of decrease Vdec and outputs the data value of −Vdec to the first input terminal of the adder 50. In the case of a control signal CS92 (0, *) (in this case, “a*” indicates an undefined value; the same applies hereinafter), the multiplexer 92 selects an amount of increase Vinc and outputs the amount of increase Vinc to the first input terminal of the adder 50. The adder 50 adds two data values to be inputted thereto and outputs a data value of a result of the addition to the comparators 111 and 112 and a third input terminal of the multiplexer 110.

The comparator 111 compares the data value to be inputted thereto with 0 and when the inputted data value ≦0, the comparator 111 outputs a data value of 1; otherwise, the comparator 111 outputs a data value of 0. The comparator 112 compares the data value to be inputted thereto with a maximum value Vmax and when the inputted data value≧Vmax, the comparator 112 outputs a data value of 1; otherwise, the comparator 112 outputs a data value of 0. In the case of a control signal CS110 (0, 0), the multiplexer 110 selects a data value of 0 and outputs the data value of 0 to the slack table 20 as an update value of predicted slack. In the case of a control signal CS110 (1, *), the multiplexer 110 selects a maximum value Vmax and outputs the maximum value Vmax to the slack table 20 as an update value of predicted slack. In the case of a control signal CS110 (0, 1), the multiplexer 110 selects the data value from the adder 50 and outputs the data value to the slack table 20 as an update value of predicted slack.

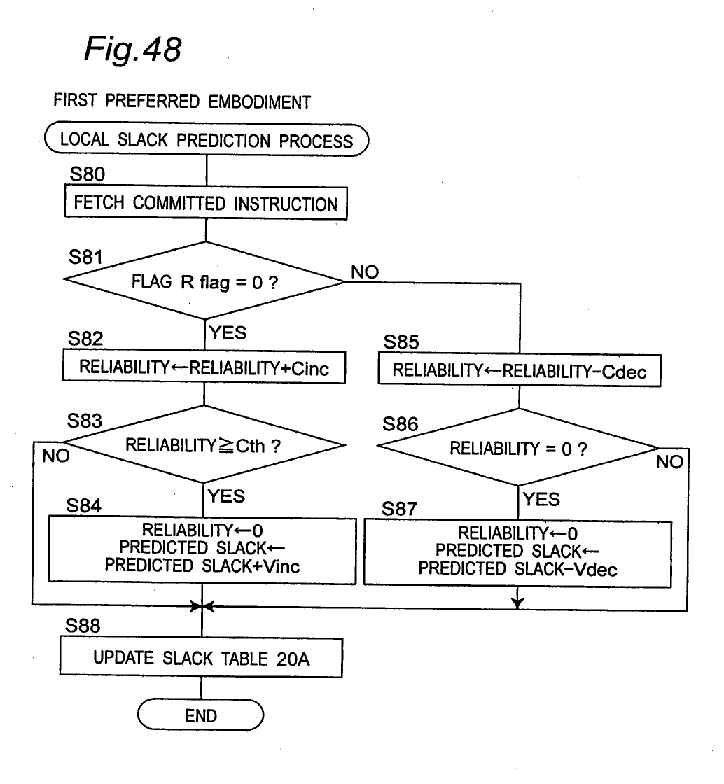

FIG. 48 is a flowchart showing a local slack prediction process according to the first preferred embodiment. In this case, the numerical ranges of predicted slack and reliability are such that 0≦reliability≦Cth and 0≦predicted slack≦Vmax.

In FIG. 48, in step S80, a committed instruction is fetched. In step S81, it is determined whether or not reach condition flag Rflag=0; if YES then the process flow proceeds to step S82, and if NO then the process flow proceeds to step S85. In step S82, an amount of increase Cinc is added to the value of reliability and a result of the addition is inserted as reliability. In step S83, it is determined whether or not reliability≧Cth (threshold value). If, in step S83, YES then the process flow proceeds to step S84, and if NO then the process flow proceeds to step S88. In step S84, the reliability is reset to 0, an amount of increase Vinc is added to the value of predicted slack, and a result of the addition is inserted into the predicted slack, and then, the process flow proceeds to step S88. On the other hand, in step S85, an amount of decrease Cdec is subtracted from the value of reliability and a result of the subtraction is inserted into the reliability. In step S86, it is determined whether or not the reliability=0. If, in step S86, YES then the process flow proceeds to step S87, and if NO then the process flow proceeds to step S88. In step S87, the reliability is reset to 0, an amount of decrease Vdec is subtracted from the value of predicted slack, and a result of the subtraction is inserted into the predicted slack, and then, the process flow proceeds to step S88. Then, in step S88, the slack table 20 is updated based on the above-described computation result and then the local slack prediction process ends.

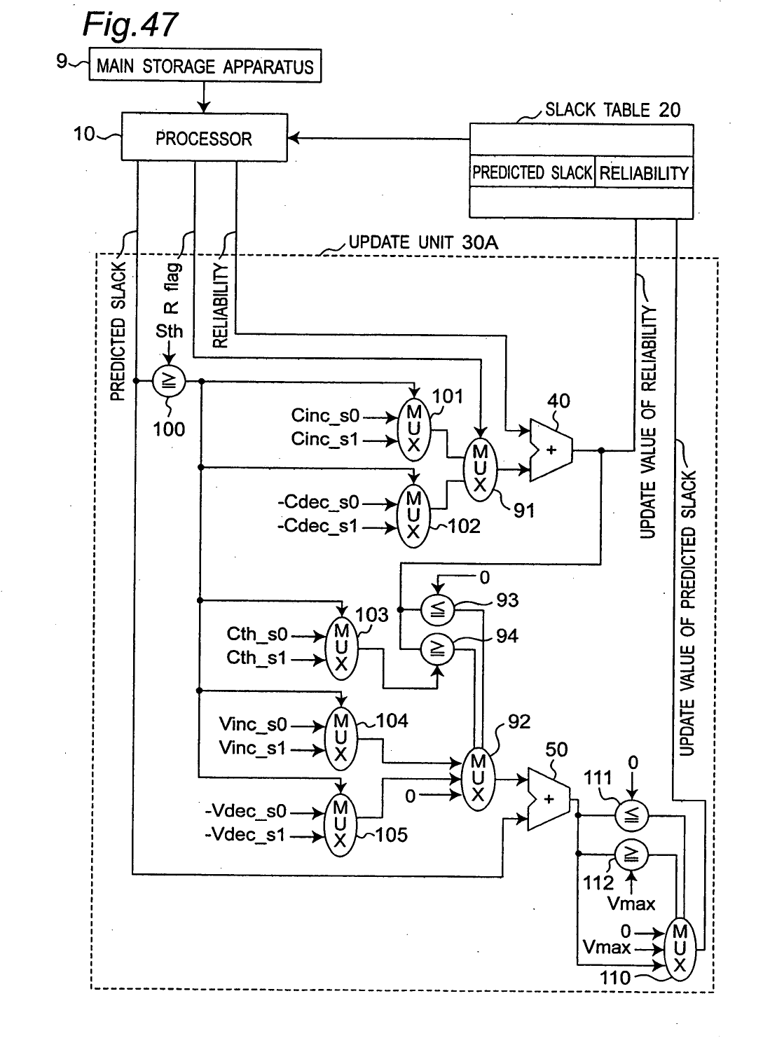

FIG. 47 is a block diagram showing the configuration of a processor 10 having an update unit 30A according to the fourth preferred embodiment of the present invention. A proposed mechanism according to the fourth preferred embodiment is characterized in that a slack table 20 and the update unit 30A are further provided to the processor 10. In this case, the slack table 20 holds predicted slack and reliability for each instruction. The update unit 30A is a logic circuit for updating predicted slack and reliability in the slack table 20. The proposed mechanism of FIG. 47 is characterized in that it differs from a comparable mechanism of FIG. 46 in the configuration of the update unit 30A as follows:

(1) a comparator 100 is further provided;

(2) two multiplexers 101 and 102 are provided between the comparator 100 and a multiplexer 91;

(3) a multiplexer 103 is provided between the comparator 100 and a comparator 94; and

(4) two multiplexers 104 and 105 are provided between the comparator 100 and a multiplexer 92.

The processor 10 accesses the slack table 20 when fetching an instruction from a main storage apparatus 9 and obtains predicted slack and reliability of the instruction. When any of behaviors, including a branch prediction miss, a cache miss, and forwarding, is observed upon execution of the instruction, it is determined that the predicted slack has reached actual slack and thus a reach condition flag Rflag corresponding to the instruction is set to 1. Upon committing an instruction, the predicted slack, reach condition flag Rflag, and reliability of the committed instruction are transmitted to the update unit 30A. The update unit 30A accepts, as input, these values received from the processor 10, calculates new predicted slack and reliability, and updates the slack table 20. The slack table 20 holds, for each instruction, predicted slack and reliability. In the present preferred embodiment, behavior exhibited upon execution of an instruction is observed, and this leads to that it is determined whether or not predicted slack is smaller than actual slack. Reliability indicates how reliable the determination is.

In the present preferred embodiment, in order to simplify the configuration of the update unit 30A as much as possible, a threshold value Sth used to change an update parameter is limited to one location. Accordingly, each update parameter is divided into two types of parameters, namely, a parameter used when slack is less than the threshold value Sth and a parameter used when slack is larger than or equal to the threshold value Sth. In FIG. 47, in the case of the former, s0 is added to each parameter and in the case of the latter, s1 is added to each parameter.

The update unit 30 checks, by using the comparator 100, the magnitude relationship between predicted slack and the threshold value Sth. Then, based on the result, by using the multiplexers 91, 92, and 101 to 105, parameters used for update are selected. By using the selected parameters, reliability and predicted slack are calculated. Specifically, the reliability is increased by an amount of increase Cinc_s0 (Cinc_s1) when the reach condition flag Rflg is 0, and is decreased by an amount of decrease Cdec_s0 (Cdec_s1) when the reach condition flag Rflg is 1. Then, the predicted slack is increased by an amount of increase Vinc_s0 (Vinc_s1) when the reliability is larger than or equal to the threshold value Cth_s0 (Cth_s1), and is decreased by an amount of decrease Vdec_s0 (Vdec_s1) when the reliability is 0. When the reliability does not apply to either of the above cases, the predicted slack keeps the value as it is. It is noted that here the characters in the brackets ( ) show the above-described latter case.

The differences between the configurations shown in FIGS. 47 and 46 will be described in detail below. In FIG. 47, the comparator 100 compares predicted slack inputted from the processor 10 with the predetermined threshold value Sth. When the predicted slack≧Sth, the comparator 100 outputs a data value of 1 to the respective control signal input terminals of the multiplexers 101, 102, 103, and 104; otherwise, the comparator 100 outputs a data value of 0 in the same manner. The multiplexer 101 selects an amount of increase Cinc_s0 when the data value of a control signal is 0 and outputs the amount of increase Cinc_s0 to the first input terminal of the multiplexer 91; on the other hand, the multiplexer 101 selects an amount of increase Cinc_s1 when the data value of a control signal is 1 and outputs the amount of increase Cinc_s1 to the first input terminal of the multiplexer 91. The multiplexer 102 selects a minus value of an amount of decrease −Cdec_s0 when the data value of a control signal is 0 and outputs the amount of decrease −Cdec_s0 to the second input terminal of the multiplexer 91; on the other hand, the multiplexer 102 selects a minus value of an amount of decrease −Cdec_s1 when the data value of a control signal is 1 and outputs the amount of decrease −Cdec_s1 to the second input terminal of the multiplexer 91. The multiplexer 103 selects a threshold value Cth_s0 when the data value of a control signal is 0 and outputs the threshold value Cth_s0 to the control signal input terminal of the comparator 94; on the other hand, the multiplexer 103 selects a threshold value Cth_s1 when the data value of a control signal is 1 and outputs the threshold value Cth_s1 to the control signal input terminal of the comparator 94. The multiplexer 104 selects an amount of increase Vinc_s0 when the data value of a control signal is 0 and outputs the amount of increase Vinc_s0 to the first input terminal of the multiplexer 92; on the other hand, the multiplexer 104 selects an amount of increase Vinc_s1 when the data value of a control signal is 1 and outputs the amount of increase Vinc_s1 to the first input terminal of the multiplexer 92. The multiplexer 105 selects a minus value of an amount of decrease −Vdec_s0 when the data value of a control signal is 0 and outputs the amount of decrease −Vdec_s0 to the second input terminal of the multiplexer 92; on the other hand, the multiplexer 105 selects a minus value of an amount of decrease −Vdec_s1 when the data value of a control signal is 1 and outputs the amount of decrease −Vdec_s1 to the second input terminal of the multiplexer 92.

Update parameters related to adjustment and contents of the update parameters in the fourth preferred embodiment are shown below again:

Vmax: the maximum value of predicted slack;

Vmin: the minimum value (=0) of predicted slack;

Vinc: the amount of increase in predicted slack at a time;

Vdec: the amount of decrease in predicted slack at a time;

Cmax: the maximum value (=Cth) of reliability;

Cmin: the minimum value (=0) of reliability;

Cth: a threshold value of reliability;

Cinc: the amount of increase in reliability at a time; and

Cdec: the amount of decrease in reliability at a time.

It is noted that the maximum value Vmin is always 0 and the minimum value Cmin is always 0. In addition, it is noted that since the reliability is reset to 0 when the reliability is larger than or equal to the threshold value Cth, the maximum value Cmax is always Cth. Therefore, update parameters that can be changed are the following six types of update parameters: Vmax, Vinc, Vdec, Cth, Cinc, and Cdec.

The flowchart of FIG. 48 shows the steps for calculating reliability and predicted slack. As shown in FIG. 48, if a target slack reach condition of a committed instruction is not established (i.e., the reach condition flag Rflag is 0), the reliability is increased by an amount of increase Cinc, and if the target slack reach condition is established (i.e., the reach condition flag Rflag is 1), the reliability is decreased by an amount of decrease Cdec. When the reliability becomes larger than or equal to the threshold value Cth, the predicted slack is increased by an amount of increase Vinc and the reliability is reset to 0. On the other hand, when the reliability becomes 0, the predicted slack is decreased by an amount of decrease Vdec.

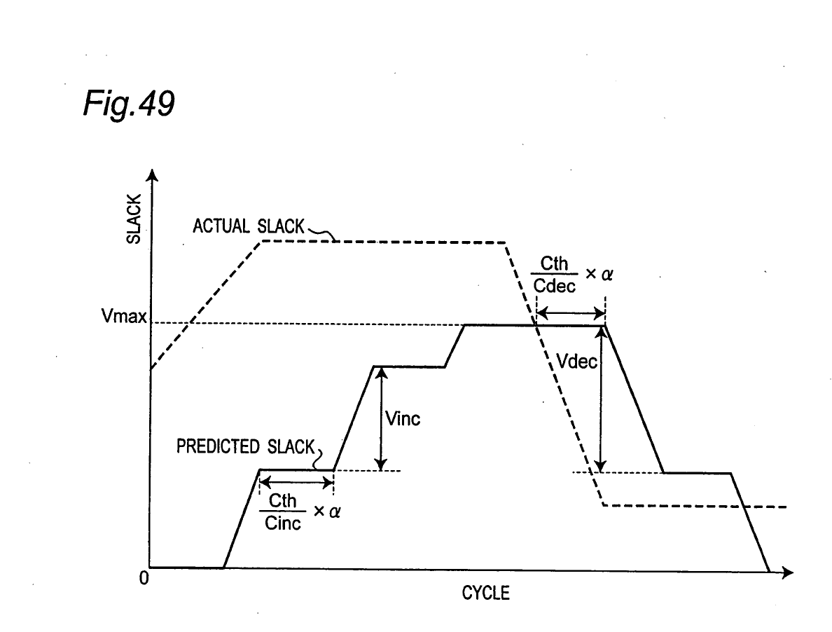

How update parameters influence on an update to reliability and predicted slack will be qualitatively described. FIG. 49 is a diagram showing an advantageous effect provided by a technique according to the fourth preferred embodiment, and is a graph showing the relationship between update parameters and a change in predicted slack. Namely, for easy understanding of description, FIG. 49 shows the relationship between how predicted slack changes and update parameters. For simplicity, a program is assumed in which the same instruction is executed every certain cycle. The cycle is α. In FIG. 49, the horizontal axis represents slack and the horizontal axis represents time. In line graphs, a dashed line shows the case of actual slack and a solid line shows the case of predicted slack.

When the maximum value Vmax of predicted slack is increased, an average of predicted slack (average predicted slack) increases. As a result, the number of slack instructions also increases. However, the probability of occurrence of a prediction miss (in this case, an event that predicted slack exceeds actual slack) increases, degrading performance.

When the amount of increase Vinc is increased, the average predicted slack increases. As a result, the number of slack instructions also increases. However, the occurrence rate of prediction miss increases, degrading performance. In addition, since the amount of increase in predicted slack cannot be minutely controlled, the convergence becomes poor. In this case, it indicates an increase of the case in which values that predicted slack can take do not match actual slack.

When the amount of decrease Vdec is increased, the occurrence rate of prediction miss decreases and performance improves. However, the average predicted slack decreases. As a result, the number of slack instructions also decreases. In addition, since the amount of decrease in predicted slack cannot be minutely controlled, the convergence becomes poor.

The threshold value Cth is strongly related to the amount of increase Cinc and the amount of decrease Cdec and thus will be described in combination with them. When Cth/Cinc which is the ratio of the threshold value Cth to the amount of increase Cinc is increased, a time interval (Cth/Cinc×α in FIG. 49) during which the predicted slack is increased increases. That is, the frequency of an increase in predicted slack is reduced. By this, the occurrence rate of prediction miss decreases and performance improves. However, the average predicted slack decreases. As a result, the number of slack instructions also decreases.

When Cth/Cdec which is the ratio of the threshold value Cth to the amount of decrease Cdec is increased, a time interval (Cth/Cdec×α in FIG. 49) during which the predicted slack is decreased increases. That is, the frequency of a decrease in predicted slack is reduced. By this, the average predicted slack increases. As a result, the number of slack instructions also increases. However, the occurrence rate of prediction miss increases and performance degrades.

As described above, according to the present preferred embodiment, the above-described slack table is referred to upon execution of an instruction to obtain predicted slack of the instruction and the execution latency of the instruction is increased by an amount equivalent to the obtained predicted slack, it is estimated based on behavior exhibited upon execution of the instruction whether or not the predicted slack has reached target slack which is an appropriate value for current local slack of the instruction, and the predicted slack is gradually increased each time the instruction is executed, until it is estimated that the predicted slack has reached the target slack. Accordingly, since a predicted value of local slack (predicted slack) of an instruction is not directly determined by calculation but is determined by gradually increasing the predicted slack until the predicted slack reaches an appropriate value, while behavior exhibited upon execution of an instruction is observed, a complex mechanism required to directly compute predicted slack is not required, making it possible to predict local slack with a simpler configuration.

In addition, since parameters used to update slack are changed according to a value of local slack, a degradation in performance can be suppressed while the number of slack instructions is maintained. Therefore, with a simpler configuration over prior art, a local slack prediction can be made and the execution of program instructions can be performed at higher speed.

### INDUSTRIAL APPLICABILITY

According to the processor apparatus and processing method for use in the processor apparatus of the present invention, a store instruction having predicted slack larger than or equal to a predetermined threshold value is predicted and determined to have no data dependency relationship with load instructions subsequent to the store instruction and even if the memory address of the store instruction is not known, the subsequent load instructions are speculatively executed. Therefore, if prediction is correct, a delay due to the use of slack of a store instruction does not occur in the execution of load instructions having no data dependency relationship with the store instruction and an adverse influence on the performance of the processor apparatus can be suppressed. In addition, since output results of a slack prediction mechanism are used, there is no need to newly prepare hardware for predicting a dependency relationship between a store instruction and a load instruction. Accordingly, with a simpler configuration over prior art, a local slack prediction can be made and the execution of program instructions can be performed at higher speed.

In addition, according to the processor apparatus and processing method for use in the processor apparatus of the present invention, by using a second prediction method which is a slack prediction method based on shared information, based on an instruction having local slack, shared information indicating that there is sharable slack is propagated from a dependent destination to a dependent source between instructions that do not have local slack and the amount of local slack used by each instruction is determined based on the shared information and using a predetermined heuristic technique, and this leads to that control is performed so that the instructions that do not have local slack can use local slack. Accordingly, it becomes possible for instructions that do not have local slack to use local slack, and thus, with a simpler configuration over prior art, a local slack prediction is made by effectively and sufficiently using local slack and the execution of program instructions can be performed at higher speed.

Furthermore, according to the processor apparatus and processing method for use in the processor apparatus of the present invention, the above-described slack table is referred to upon execution of an instruction to obtain predicted slack of the instruction and the execution latency of the instruction is increased by an amount equivalent to the obtained predicted slack, it is estimated based on behavior exhibited upon execution of the instruction whether or not the predicted slack has reached target slack which is an appropriate value for current local slack of the instruction, and the predicted slack is gradually increased each time the instruction is executed, until it is estimated that the predicted slack has reached the target slack. Accordingly, since a predicted value of local slack (predicted slack) of an instruction is not directly determined by calculation but is determined by gradually increasing the predicted slack until the predicted slack reaches an appropriate value, while behavior exhibited upon execution of an instruction is observed, a complex mechanism required to directly compute predicted slack is not required, making it possible to predict local slack with a simpler configuration.

In addition, since parameters used to update slack are changed according to a value of local slack, a degradation in performance can be suppressed while the number of slack instructions is maintained. Therefore, with a simpler configuration over prior art, a local slack prediction can be made and the execution of program instructions can be performed at higher speed.

Although, as described above, the present invention is described in detail by preferred embodiments, the present invention is not limited thereto and it will be apparent to those skilled in the art that many modified preferred embodiments and altered preferred embodiments can be made within the technical scope of the present invention as recited in the appended claims.

What is claimed is:

1. A processor apparatus for predicting predicted slack which is a predicted value of local slack of an instruction to be executed by the processor apparatus and executing the instruction using the predicted slack, the processor apparatus comprising:
a storage unit for storing a slack table including the predicted slack;
a setting unit for referring to the slack table upon execution of an instruction to obtain predicted slack of the instruction and increasing execution latency by an amount equivalent to the obtained predicted slack;
an estimation unit for estimating, based on behavior exhibited upon execution of the instruction, whether or not the predicted slack has reached target slack which is an appropriate value of current local slack of the instruction; and
an update unit for gradually increasing the predicted slack each time the instruction is executed until it is estimated by the estimation unit that the predicted slack has reached the target slack.

2. The processor apparatus as claimed in claim 1,
wherein the update unit changes a parameter to be used to update the slack, according to a value of the predicted slack such that a degradation in performance of the processor apparatus is suppressed while a number of slack instructions is maintained.

3. The processor apparatus as claimed in claim 2,
wherein the update unit changes the parameter to be used to update the slack, according to whether the predicted slack is larger than or equal to a predetermined threshold value.

4. The processor apparatus as claimed in claim 1,
wherein the estimation unit estimates that the predicted slack has reached the target slack, using, as an establishment condition for the estimation, at least one of the following facts:
(A) a branch prediction miss occurs upon execution of the instruction;
(B) a cache miss occurs upon execution of the instruction;
(C) operand forwarding to a subsequent instruction occurs;
(D) store data forwarding to a subsequent instruction occurs;
(E) the instruction is the oldest one of instructions present in an instruction window;
(F) the instruction is the oldest one of instructions present in a reorder buffer;
(G) the instruction is an instruction that passes an execution result to the oldest one of the instructions present in the instruction window;
(H) the instruction is an instruction that passes an execution result to a largest number of subsequent instructions among instructions executed in a same cycle; and
(I) a number of subsequent instructions that are brought into an executable state by passing an execution result of the instruction is larger than or equal to a predetermined determination value.

5. The processor apparatus as claimed in claim 1, further comprising a reliability counter in which when an establishment condition for an estimation that the predicted slack has reached the target slack is established, a counter value of the reliability counter is increased or decreased, and when the establishment condition for the estimation is not established, the counter value is decreased or increased,
wherein the update unit increases the predicted slack on a condition that the counter value of the reliability counter is an increase determination value and decreases the predicted slack on a condition that the counter value of the reliability counter is a decrease determination value.

6. The processor apparatus as claimed in claim 5,
wherein an amount of increase or decrease in the counter value upon establishment of the establishment condition for the estimation in the reliability counter is set to a value larger than that of an amount of decrease or increase in the counter value upon non-establishment of the establishment condition for the estimation.

7. The processor apparatus as claimed in claim 5,
wherein amounts of increase and decrease in the counter value are set to be different for different types of instructions.

8. The processor apparatus as claimed in claim 1,
wherein an amount of update of the predicted slack of each instruction at a time by the update unit is set to be different for different types of each instruction.

9. The processor apparatus as claimed in claim 1,
wherein an upper limit value is set to the predicted slack of each instruction to be updated by the update unit and the upper limit value is set to be different for different types of instructions.

10. The processor apparatus as claimed in claim 1, further comprising a branch history register in which a branch history of a program is kept,
wherein the slack table individually stores the predicted slack of the instruction for different branch patterns obtained by referring to the branch history register.

11. A processing method for use in a processor apparatus that predicts predicted slack which is a predicted value of local slack of an instruction to be executed by the processor apparatus and executes the instruction using the predicted slack, the processing method including:
a control step of executing an instruction to be executed by the processor apparatus such that execution latency of the instruction is increased by an amount equivalent to a value of the predicted slack, estimating, based on behavior exhibited upon execution of the instruction, whether or not the predicted slack has reached target slack which is an appropriate value of current local slack, and updating the predicted slack each time the instruction is executed so as to gradually increase the predicted slack, until it is estimated that the predicted slack has reached the target slack.

12. The processing method for use in the processor apparatus as claimed in claim 11,
wherein in the control step, a parameter to be used to update the slack is changed according to the value of the predicted slack such that a degradation in performance of the processor apparatus is suppressed while a number of slack instructions is maintained.

13. The processing method for use in the processor apparatus as claimed in claim 12,
wherein in the control step, the parameter to be used to update the slack is changed according to whether the predicted slack is larger than or equal to a predetermined threshold value.

14. The processing method for use in the processor apparatus as claimed in claim 11,
wherein an establishment condition for an estimation that the predicted slack has reached the target slack includes at least one of the following facts:
(A) a branch prediction miss occurs upon execution of the instruction;
(B) a cache miss occurs upon execution of the instruction;
(C) operand forwarding to a subsequent instruction occurs;
(D) store data forwarding to a subsequent instruction occurs;
(E) the instruction is the oldest one of instructions present in an instruction window;
(F) the instruction is the oldest one of instructions present in a reorder buffer;
(G) the instruction is an instruction that passes an execution result to the oldest one of the instructions present in the instruction window;
(H) the instruction is an instruction that passes an execution result to a largest number of subsequent instructions among instructions executed in a same cycle; and
(I) a number of subsequent instructions that are brought into an executable state by passing an execution result of the instruction is larger than or equal to a predetermined determination value.

15. The processing method for use in the processor apparatus as claimed in claim 11,
wherein the predicted slack is decreased when it is estimated that the predicted slack has reached the target slack.

16. The processing method for use in the processor apparatus as claimed in claim 15,
wherein an increase of the predicted slack is performed on a condition that a number of non-establishments for an establishment condition for an estimation that the predicted slack has reached the target slack reaches a specified number of times, and a decrease of the predicted slack is performed on a condition that a number of establishments for the establishment condition reaches a specified number of times.

17. The processing method for use in the processor apparatus as claimed in claim 16,
wherein the number of non-establishments for the establishment condition required to increase the predicted slack is set to a value larger than that of the number of establishments for the establishment condition required to decrease the predicted slack.

18. The processing method for use in the processor apparatus as claimed in claim 15,
wherein an increase of the predicted slack is performed on a condition that a number of non-establishments for an establishment condition for an estimation that the predicted slack has reached the target slack reaches a specified number of times, and a decrease of the predicted slack is performed on a condition that the establishment condition is established.

19. The processing method for use in the processor apparatus as claimed in claim 16,
wherein the specified number of times is set to be different for different types of the instructions.

20. The processing method for use in the processor apparatus as claimed in claim 11,
wherein an amount of update of predicted slack at a time is set to be different for different types of the instructions.

21. The processing method for use in the processor apparatus as claimed in claim 11,
wherein an upper limit value of the predicted slack is set to be different for different types of the instructions.

22. A processor apparatus for predicting predicted slack which is a predicted value of local slack of an instruction to be stored at a memory address of a main storage apparatus and executed by the processor apparatus, and executing the instruction using the predicted slack, the processor apparatus comprising:
a control unit for predicting and determining that a store instruction having predicted slack larger than or equal to a predetermined threshold value has no data dependency relationship with a subsequent load instruction to the store instruction and speculatively executing the subsequent load instruction even if a memory address of the store instruction is not known.

23. The processor apparatus as claimed in claim 22,
wherein, when a memory address of a load instruction is known and a preceding store instruction to the load instruction is such one case of the following:
(1) a memory address is known; and
(2) though the memory address is not known, predicted slack of the store instruction is larger than or equal to the threshold value,
the control unit makes an address comparison between the load instruction and a store instruction which is preceding to the load instruction and whose memory address is known, and executes memory access when it is determined that there is no dependency relationship between the load instruction and a store instruction whose memory address is not known and which has predicted slack larger than or equal to the threshold value; otherwise, the control unit obtains data from a dependent store instruction by forwarding, thereby predicting a memory dependency relationship and speculatively executes the load instruction.

24. The processor apparatus as claimed in claim 23,
wherein the control unit compares, after a memory address of a store instruction having predicted slack larger than or equal to the threshold value is found out, the memory address of the store instruction with a memory address of a subsequent load instruction whose execution has been completed and determines, if the memory addresses are not matched, that memory dependence prediction is successful and thus executes memory access; on the other hand, if the memory addresses are matched, the control unit determines that the memory dependence prediction is failed and thus flushes the load instruction having a matched memory address and an instruction subsequent thereto from the processor apparatus and redoes execution of the instructions.

25. A processing method for use in a processor apparatus for predicting predicted slack which is a predicted value of local slack of an instruction to be stored at a memory address of a main storage apparatus and executed by the processor apparatus, and executing the instruction using the predicted slack, the processing method comprising:
a control step of predicting and determining that a store instruction having predicted slack larger than or equal to a predetermined threshold value has no data dependency relationship with a subsequent load instruction to the store instruction and speculatively executing the subsequent load instruction even if a memory address of the store instruction is not known.

26. The processing method for use in the processor apparatus as claimed in claim 25,
wherein when a memory address of a load instruction is known and a preceding store instruction to the load instruction is such one case of the following:
(1) a memory address is known; and
(2) though the memory address is not known, predicted slack of the store instruction is larger than or equal to the threshold value,
in the control step, an address comparison between the load instruction and a store instruction which is preceding to the load instruction and whose memory address is known is made and memory access is executed when it is determined that there is no dependency relationship between the load instruction and a store instruction whose memory address is not known and which has predicted slack larger than or equal to the threshold value; otherwise, by obtaining data from a dependent store instruction by forwarding, a memory dependency relationship is predicted and the load instruction is speculatively executed.

27. The processing method for use in the processor apparatus as claimed in claim 26,
wherein in the control step, after a memory address of a store instruction having predicted slack larger than or equal to the threshold value is found out, the memory address of the store instruction is compared with a memory address of a subsequent load instruction whose execution has been completed and it is determined, if the memory addresses are not matched, that memory dependence prediction is successful and thus memory access is executed; on the other hand, if the memory addresses are matched, it is determined that the memory dependence prediction is failed and thus the load instruction having a matched memory address and an instruction subsequent thereto are flushed from the processor apparatus and execution of the instructions is redone.

28. A processor apparatus for predicting, using a predetermined first prediction method, predicted slack which is a predicted value of local slack of an instruction to be stored at a memory address of a main storage apparatus and executed by the processor apparatus, and executing the instruction using the predicted slack, the processor apparatus comprising:
a control unit for propagating, using a second prediction method which is a slack prediction method based on shared information and based on an instruction having local slack, shared information indicating that there is sharable slack, from a dependent destination to a dependent source between instructions that do not have local slack, and determining an amount of local slack used by each instruction based on the shared information and using a predetermined heuristic technique, thereby performing control to enable the instructions that do not have local slack to use local slack.

29. The processor apparatus as claimed in claim 28,
wherein the control unit propagates the shared information when predicted slack of an instruction is larger than or equal to a predetermined threshold value.

30. The processor apparatus as claimed in claim 29,
wherein the control unit calculates and updates, based on behavior exhibited upon execution of an instruction and the shared information, predicted slack of the instruction and reliability indicating a degree of whether or not the predicted slack can be used.

31. The processor apparatus as claimed in claim 30,
wherein the control unit performs an update such that when the control unit receives shared information upon execution of an instruction, the control unit determines that the predicted slack has not yet reached usable slack and thus increases the reliability; otherwise, the control unit determines that the predicted slack has reached the usable slack and thus decreases the reliability and when the reliability is decreased to a predetermined value, the control unit decreases the predicted slack and when the reliability is larger than or equal to a predetermined threshold value, the control unit increases the predicted slack.

32. The processor apparatus as claimed in claim 30,
wherein the control unit includes:
a first storage unit for storing a slack table;
a second storage unit for storing a slack propagation table; and
an update unit for updating the slack table and the slack propagation table,
wherein the slack table includes for each of all instructions:
(a) a propagation flag (Pflag) indicating whether a local slack prediction is made using the first prediction method or the second prediction method;
(b) the predicted slack; and
(c) reliability indicating a degree of whether or not the predicted slack can be used,
wherein the slack propagation table includes for each of instructions that do not have local slack:
(a) memory addresses of the instructions that do not have the local slack;
(b) a predicted slack of the instructions that do not have the local slack; and
(c) reliability indicating a degree of whether or not the predicted slack of the instructions that do not have the local slack can be used, and
wherein, when a propagation flag of a received instruction indicates that a local slack prediction is made using the second prediction method, the update unit updates the slack table and the slack propagation table based on predicted slack and reliability of the received instruction and using the second prediction method; on the other hand, when the propagation flag of the received instruction indicates that a local slack prediction is made using the first prediction method, the update unit updates the slack table based on the predicted slack and the reliability of the received instruction and using the first prediction method.

33. A processing method for use in a processor apparatus for predicting, using a predetermined first prediction method, predicted slack which is a predicted value of local slack of an instruction to be stored at a memory address of a main storage apparatus and executed by the processor apparatus, and executing the instruction using the predicted slack, the processing method comprising:
a control step of propagating, using a second prediction method which is a slack prediction method based on shared information and based on an instruction having local slack, shared information indicating that there is sharable slack, from a dependent destination to a dependent source between instructions that do not have local slack, and determining an amount of local slack used by each instruction based on the shared information and using a predetermined heuristic technique, thereby performing control to enable the instructions that do not have local slack to use local slack.

34. The processing method for use in the processor apparatus as claimed in claim 33,
wherein in the control step, when predicted slack of an instruction is larger than or equal to a predetermined threshold value, the shared information is propagated.

35. The processing method for use in the processor apparatus as claimed in claim 34,
wherein in the control step, based on behavior exhibited upon execution of an instruction and the shared information, predicted slack of the instruction and reliability indicating a degree of whether or not the predicted slack can be used are calculated and updated.

36. The processing method for use in the processor apparatus as claimed in claim 35,
wherein in the control step, an update is performed such that it is determined, when shared information is received upon execution of an instruction, that the predicted slack has not yet reached usable slack and thus the reliability is increased; otherwise, it is determined that the predicted slack has reached the usable slack and thus the reliability is decreased and when the reliability is decreased to a predetermined value, the predicted slack is decreased and when the reliability is larger than or equal to a predetermined threshold value, the predicted slack is increased.
